(19) United States
(12) Patent Application Publication
(10) Pub. No.: US 2012/0220478 A1
(43) Pub. Date: Aug. 30, 2012

(54) METHODS FOR ASSESSING DISEASE RISK

(75) Inventor: Daniel J. Shaffer, Bar Harbor, ME (US)

(73) Assignee: Bar Harbor Biotechnology, Inc., Trenton, ME (US)

(21) Appl. No.: 13/384,972

(22) PCT Filed: Jul. 20, 2010
(86) PCT No.: PCT/US2010/042623

§ 371 Date: May 9, 2012

Related U.S. Application Data
(60) Provisional application No. 61/227,062, filed on Jul. 20, 2009.

(51) Int. Cl. C40B 30/04; C40B 40/06

(52) U.S. Cl. 506/9; 506/16

(57) ABSTRACT

The invention relates to methods and biomarkers for assessing a subject's risk for a disease, such as cancer, an autoimmune disease or a neurological disease. In particular, the invention provides methods and biomarkers for creating exon copy number variation (ECNV) profiles, and determining disease risk according to the subject's ECNV profiles.

### CROSS REFERENCE TO RELATED APPLICATIONS

This application claims the benefit of U.S. Provisional Application No. 61/227,062, filed Jul. 20, 2009, which is incorporated by reference in its entirety.

### BACKGROUND OF THE INVENTION

Copy number variation (CNV) refers to differences in the number of copies of a segment of DNA in the genomes of different members of a species. Altered DNA copy number is one of the many ways that gene expression and function may be modified. Some variations are found among normal individuals, others occur in the course of normal processes in some species, and still others participate in causing various disease states.

Evidence that copy number alterations can influence human phenotypes came from sporadic diseases, termed “genomic disorders,” caused by de novo structural alterations (McCarroll et al., Nature Genetics 39, S37-S42 (2007)). In addition to such sporadic diseases, inherited CNVs have been found to underlie mendelian diseases in several families (McCarroll, supra).

Copy number variation is hypothesized to cause diseases through several mechanisms. First, copy number variants can directly influence gene dosage, which can result in altered gene expression and potentially cause genetic diseases. Gene dosage describes the number of copies of a gene in a cell, and gene expression can be influenced by higher and lower gene dosages. For example, deletions can result in a lower gene dosage or copy number than what is normally expressed by removing a gene entirely. Deletions can also result in the unmasking of a recessive allele that would normally not be expressed. Structural variants that overlap a gene can reduce or prevent the expression of the gene through inversions, deletions, or translocations. Variants can also affect a gene's expression indirectly by interacting with regulatory elements. For instance, if a regulatory element is deleted, a dosage-sensitive gene might have lower or higher expression than normal. Sometimes, the combination of two or more copy number variants can produce a complex disease, whereas individually the changes produce no effect. Some variants are flanked by homologous repeats, which can make genes within the copy number variant susceptible to nonallelic homologous recombination and can predispose individuals or their descendants to a disease. Additionally, complex diseases might occur when copy number variants are combined with other genetic and environmental factors (Lobo, Copy Number Variation and Genetic Disease, Nature Education 1(1) (2008), available on the world wide web at www.nature.com/scitable/topicpage/copy-number-variation-and-genetic-disease-911).

For example, copy number variations were identified on chromosome 22 in regions involved with spinal muscle atrophy and DiGeorge syndrome, as well as in the imprinted chromosome 15 region associated with Prader-Willi syndrome and Angelman syndrome (Lobo, Nature Education 1(1), (2008)).

Colorectal cancer (CRC) is the number three leading type of cancer, and the second leading cancer for estimated cancer deaths in the United States (Huang et al., Cancer Causes and Control 16:171-188 (2005)).

The course of the morphological development of CRC appears to be associated with a specific sequence of events (Wong, Current concepts in the management of colorectal cancer (2002), available on the world wide web at www.fcmsdocs.org/HealthResources/FCMSConferences/2002/Document/Current %20Concepts %20in %20the %20Management %20of %20Colorectal %20Cancer.pdf). Typically, normal mucosa develops into an adenomatous polyp, which in some cases can progress to an adenoma with low-grade dysplasia. This type of adenoma can then, in turn, progress to a high-grade dysplasia and eventually become an invasive adenocarcinoma. It has been found that a mutation in the gene encoding the APC (Adenomatous Polyposis Coli) protein leads to the disruption of its biological activity and subsequently increases the risk of developing early adenomas with low-grade dysplasia from the normal mucosa of the colon. Subsequently, a mutation in K-ras correlates with the progression of the early adenoma to the intermediate stage characterised by a low-grade dysplasia. This sequence of events is followed by an allelic loss at 18q21, whereby the gene sequences encoding DCC (deleted in colon cancer), SMAD2 and SMAD4 are deleted. A similar allelic loss occurs at 17p13, wherein the gene encoding p53 is also deleted. A loss of both SMAD4 has been shown to promote the progression of the intermediate state adenoma to a late stage adenoma with high-grade dysplasia. Finally, it is the loss of the gene encoding p53 that results in the promotion of colon carcinogenesis in it later stages (Wong, Current concepts in the management of colorectal cancer (2002)).

Copy number variants have been detected in the cancer cells of CRC patients. U.S. Pat. No. 6,326,148 discloses that amplification of the human chromosomal region at 20q (particularly at 20q13.2) is a frequent event in colon adenocarcinomas, occurring in approximately 80% of the cases, but is very rare in premalignant lesions, i.e. adenomas (polyps). U.S. Patent Application Publication No. 20080096205 discloses the detection of copy number changes in twenty-seven “recurrently altered regions” (RARs) in colorectal cancer by high resolution microarray (one Mb-resolution) based on comparative genomic hybridization (array CGH), and the use of certain RARs as a prognostic marker for monitoring colorectal cancer progression.

Despite the availability of several screening methods for the detection of CRC, detecting CRC within its early stages remains challenging. As a result, significant differences exist regarding the survival of patients affected by CRC according to the stages at which the disease is diagnosed (Wong, Current concepts in the management of colorectal cancer (2002)). Most patients exhibit symptoms such as rectal bleeding, pain, abdominal distension or weight loss only after the disease is in its advanced stages, limiting therapeutic options available to patients.

Autoimmune diseases arise from an organism's overactive immune response to autoantigens causing damage to the organism's own tissues. Common autoimmune diseases include type I diabetes mellitus, multiple sclerosis, rheumatoid arthritis, oophoritis, myocarditis, chronic thyroiditis, myasthenia gravis, lupus erythematosus, Graves disease, Sjogren Syndrome, and Uveal Retinitis, etc.

Copy number variants have also been detected in autoimmune diseases, such as systemic lupus, psoriasis, Crohn's disease, rheumatoid arthritis and type 1 diabetes (Schaschl, et al., Clinical & Experimental Immunology, 156, 12-16 (2009)).

Loss of cognition and dementia associated with neurological disease results from damage to neurons and synapses that serve as the anatomical substrata for memory, learning, and information processing. Despite much interest, biochemical pathways responsible for progressive neuronal loss in these disorders have not been elucidated.

Alzheimer's disease (AD) accounts for more than 15 million cases worldwide and is the most frequent cause of dementia in the elderly (Terry, R. D. et al. (eds.), ALZHEIMER'S DISEASE, Raven Press, New York, 1994). AD is thought to involve mechanisms which destroy neurons and synaptic connections. The neuropathology of this disorder includes formation of senile plaques which contain aggregates of Aβ₁₋₄₂ (Selkoe, Neuron, 1991, 6:487-498; Yankner et al., New Eng. J. Med., 1991, 325:1849-1857; Price et al., Neurobiol. Aging, 1992, 13, 623-625; Younkin, Ann. Neurol., 1995, 37:287-288). Senile plaques found within the gray matter of AD patients are in contact with reactive microglia and are associated with neuron damage (Terry et al., Structural Basis of the Cognitive Alterations in Alzheimer's Disease, ALZHEIMER'S DISEASE, NY, Raven Press, 1994, Ch. 11, 179-196; Terry, R. D. et al. (eds.); Perlmutter et al., J. Neurosci. Res., 1992, 33:549-558). Plaque components from microglial interactions with Aβ plaques tested in vitro were found to stimulate microglia to release a potent neurotoxin, thus linking reactive microgliosis with AD neuronal pathology (Giulian et al., Neurochem. Int., 1995, 27:119-137).

Copy number variants have also been detected in genetic regions associated with complex neurological diseases, such as Alzheimer's disease, schizophrenia, autism, schizophrenia, and idiopathic learning disability (Lobo, Nature Education 1(1), (2008); Sebat, et al., Science, vol. 316, 445-449 (2007); St Clair, Schizophrenia Bulletin 2009 35(1):9-12; Knight, et al., The Lancet, 354, 1676-1681 (1999)).

Early assessment of disease risk (such as risks for cancer, autoimmune diseases, or neurological diseases) would greatly benefit patients and physicians and provide an opportunity to take actions that could delay or prevent disease onset. Although certain gene duplications or deletions that result in increased or decreased (e.g., absent) activity of the gene products are known to be associated with certain diseases, CNVs have been implicated in only a few percent of the 2,000 or more mendelian diseases that are understood at a molecular level (Lobo, Nature Education 1(1), (2008)).

A significant challenge in disease-association studies that attempt to associate CNVs with disease risk is that CNVs also exist in healthy individuals, and are in fact wide-spread. Studies using microarray technology have demonstrated that as much as 12% of the human genome and thousands of genes are variable in copy number, and this diversity is likely to be responsible for a significant proportion of normal phenotypic variation (Carter, Nature Genetics 39, S16-S21 (2007)). In one comprehensive survey, 11,700 CNVs greater than about 500 base pairs were detected in the human genome, and the study concluded that common CNVs are “highly unlikely” to account for much of the genetic variation underlying the missing heritability for complex traits that remains unexplained (Conrad et al., Nature, 464, 704-712 (2010)). A companion study of the genetics of common diseases including diabetes, heart disease and bipolar disorder also concluded that common copy number variations are “unlikely to play a major role” in such diseases (The Wellcome Trust Case Control Consortium, Nature, 464, 713-720 (2010)). These studies show that identifying rare sequence and structural variants that are associated with diseases remains challenging.

Therefore, a need exists to identify copy number variations that correlate with disease risk. Identifying copy number variations is also important for disease risk assessment, disease diagnosis, and designing personalized treatment regimen.

Preliminary studies of functional impact of CNVs showed a bias of CNVs away from genes, enhancers, and other ultra-conserved elements (Conrad et al., Nature, 464, 704-712 (2010)). Conrad et al. reports that of the 8,599 validated CNV loci, 1,236 were located in intron regions, and only 183 were located in exons. However, functional impact of exon copy number variations, and correlation between exon CNVs and disease phenotype have not been extensively investigated. Genome re-sequencing studies have shown that most bases that vary among genomes resides in CNVs of at least 1 kilobase (kb), while average exon size in human genes is about 200 basepairs (Conrad et al., Nature, 464, 704-712 (2010); Levy et al., PLoS Biol. 5, e254 (2007); Wheeler at al., Nature 452, 872-876 (2007); Strachan and Read, Human Molecular Genetics, 2 ed., Chapter 7, Organization of the human genome). Therefore, a need exists to identify exon copy number variations that correlate with disease risk.

A significant impediment to early risk assessment of diseases such as cancer is the general requirement that the diseased tissue (such as a tumor) be used for diagnosis. For example, chromosomal aberrations (such as translocations, deletions and amplifications) are often readily detected in cancer cells because genomic instability is a hallmark of many human cancers. As such, diagnostic methods (such as microsatellite instability) generally require obtaining DNA samples from tumor cells and comparing the tumor cell DNA with the DNA from normal cells.

In contrast, efforts to identify genetic abnormalities in normal tissues of patients with cancer or at risk of cancer have been disappointing. Except for rare hereditary cancer syndromes, the impact of molecular genetics on cancer risk assessment and prevention has been minimal. For example, only a small fraction (less than 1%) of patients with colorectal cancer have predisposing mutations in the APC gene that cause adenomatous polyposis coli; an even smaller fraction show mutations in genes responsible for replication error repair that cause hereditary nonpolyposis colorectal cancer (HNPCC or Lynch syndrome) (Markey, L., et al., Curr. Gastroenterol. Rep. 4, 404-413 (2002); Samowitz, W. S., et al., Gastroenterology 121, 830-838 (2001); Percesepe, A., et al., J. Clin. Oncol. 19, 3944-3950 (2001)).

Therefore, a diagnostic approach that assesses an individual's disease risk using normal tissue or normal cells would offer an advantage for disease intervention and treatment.

### SUMMARY OF THE INVENTION

The invention relates to methods and biomarkers for assessing a subject's risk for a disease, such as cancer (e.g., colorectal cancer), an autoimmune disease or a neurological disease. In particular, the invention provides methods and biomarkers for creating exon copy number variation (ECNV) profiles, and determining disease risk according to the subject's ECNV profiles.

The invention is based in part on the discovery that copy number variations of one or more exons of certain marker genes can be statistically significantly correlated to certain clinical diagnosis and disease progression. Detecting the presence of exon copy number variations (ECNVs) in these marker genes in a genomic DNA sample allows for disease risk assessment, disease diagnosis, or disease prognosis in the subject from which the DNA sample is obtained.

In one aspect, the invention provides a method of generating an ECNV profile of a subject that is informative of colorectal cancer risk, comprising: (a) providing a genomic DNA sample obtained from the subject; (b) determining the copy number variations of a set of marker exons in the genomic DNA sample by comparing the copy number of each of the marker exons in the genomic DNA sample with the copy number of the corresponding exon in a control, wherein the set of marker exons comprise at least one exon from each of the marker genes listed in Table 1; (c) creating an ECNV profile based on the copy number variations of the set of marker exons. The ECNV profile is informative of the onset, progression, severity, or treatment outcome of colorectal cancer in the subject.

In another aspect, the invention provides a method of determining colorectal cancer risk in a subject, comprising: (i) creating an ECNV profile of the subject according to the method as described herein, or providing such an ECNV profile; (ii) determining the degree of similarity between the ECNV profile of (i) and one or more reference profiles. The degree of similarity is used to determine risk of CRC in the subject (e.g., the onset, progression, severity, or treatment outcome of CRC).

The reference profile is an ECNV profile comprising ECNV information of one or more exons of the marker genes (e.g., a set of marker exons), and the reference profile has a known correlation with the presence or the absence of CRC, or with the onset, progression, severity, or treatment outcome of CRC (e.g., or a particular classification of CRC).

A profile database having a plurality of reference profiles may be used. Optionally, a reference profile that is most similar to the subject's profile may be identified to further characterize the risk of CRC in the subject.

In certain embodiments, the set of marker exons comprise the following exons: CTNNB1 exon 01.1, SCEL exon 01, SLAIN1 exon 01, MSH2 exon 13.1, SMAD4 exon 09, MTOR exon 15.1, and MUTYH exon 09.1.

In certain embodiments, a decrease in the copy numbers of one or more exons selected from: CTNNB1 exon 01.1, SCEL exon 01, SLAIN1 exon 01, MSH2 exon 13.1, SMAD4 exon 09, MTOR exon 15.1, and MUTYH exon 09.1 is indicative of an increased risk of developing metastatic colorectal cancer, or having an early onset of colorectal cancer in the subject.

In certain embodiments, the set of marker exons comprise the following exons: PPP2R1A exon 06.1, PMS2 exon 13.1, PPP2R1A exon 04.1, CTNNB1 exon 13.1, MSH6 exon 08.1, MTOR exon 10.1, PPP2R1A exon 07.2, PMS2 exon 14.2, MLH1 exon 08.1, DCC exon 09.1, MLH1 exon 01.2, IRG1 exon 05, KRAS exon 04.2, MUTYH exon 03.2, STK11 exon 02, APC exon 04.2, MSH2 exon 12.2, PPP2R1A exon 05.2, APC exon 10.2, MTOR exon 48.2, MTOR exon 50.1, MLH1 exon 15.1, PMS2 exon 04.1, PMS2 exon 06.2, and MTOR exon 06.2.

In certain embodiments, an increase in the copy numbers of one or more exons selected from PPP2R1A exon 06.1, PMS2 exon 13.1, PPP2R1A exon 04.1, CTNNB1 exon 13.1, MSH6 exon 08.1, MTOR exon 10.1, PPP2R1A exon 07.2, PMS2 exon 14.2, MLH1 exon 08.1, DCC exon 09.1, MLH1 exon 01.2, IRG1 exon 05, KRAS exon 04.2, MUTYH exon 03.2, STK11 exon 02, APC exon 04.2, MSH2 exon 12.2, PPP2R1A exon 05.2, APC exon 10.2, MTOR exon 48.2, MTOR exon 50.1, MLH1 exon 15.1, PMS2 exon 04.1, PMS2 exon 06.2, and MTOR exon 06.2 is indicative of an increased risk of developing non-metastatic colorectal cancer in the subject.

In certain embodiments, the set of marker exons comprise the following exons: CTNNB1 exon 01.1, SCEL exon 01, SLAIN1 exon 01, MSH2 exon 13.1, MUTYHexon 10.2, SMAD4 exon 09, MTOR exon 15.1, MUTYH exon 09.1, PPP2R1A exon 06.1, PMS2 exon 13.1, PPP2R1A exon 04.1, CTNNB1 exon 13.1, MSH6 exon 08.1, MTOR exon 10.1, PPP2R1A exon 07.2, PMS2 exon 14.2, MLH1 exon 08.1, DCC exon 09.1, MLH1 exon 01.2, IRG1 exon 05, KRAS exon 04.2, MUTYH exon 03.2, STK11 exon 02, APC exon 04.2, MSH2 exon 12.2, PPP2R1A exon 05.2, APC exon 10.2, MTOR exon 48.2, MTOR exon 50.1, MLH1 exon 15.1, PMS2 exon 04.1, PMS2 exon 06.2, MTOR exon 06.2., PPP2R1A exon 08.2, PIK3CA exon 04, SMAD4 exon 10, FBXL3 exon 02, BMPR1A exon 04, PMS2 exon 15.2, MTOR exon 03.1, TP53 exon 04.2, SMAD4 exon 02, and MYCBP2 exon 84.

In certain embodiments, the set of marker exons comprise the exons listed in Table 2.

In certain embodiments, the genomic DNA is from a normal (i.e. non-cancerous) cell or normal (i.e. non-cancerous) tissue.

In another aspect, the invention provides a kit for generating an ECNV profile of a subject that is informative of colorectal cancer risk, comprising: (a) a set of polynucleotide primers for detecting the copy numbers of a set of marker exons in the genomic DNA of the subject, wherein the set of marker exons comprise at least one exon from each of the genes listed in Table 1, and wherein for each marker exon, at least one primer selectively hybridizes to the exon; and (b) instructions for creating an ECNV profile of the genomic DNA of the subject according to method described herein.

In certain embodiments, the kit comprises polynucleotide primers for detecting the copy numbers of the following marker exons: CTNNB1 exon 01.1, SCEL exon 01, SLAIN1 exon 01, MSH2 exon 13.1, MUTYHexon 10.2, SMAD4 exon 09, MTOR exon 15A, MUTYH exon 09.1, PPP2R1A exon 06.1, PMS2 exon 13.1, PPP2R1A exon 04.1, CTNNB1 exon 13.1, MSH6 exon 08.1, MTOR exon 10.1, PPP2R1A exon 07.2, PMS2 exon 14.2, MLH1 exon 08.1, DCC exon 09.1, MLH1 exon 01.2, IRG1 exon 05, KRAS exon 04.2, MUTYH exon 03.2, STK11 exon 02, APC exon 04.2, MSH2 exon 12.2, PPP2R1A exon 05.2, APC exon 10.2, MTOR exon 48.2, MTOR exon 50.1, MLH1 exon 15.1, PMS2 exon 04.1, PMS2 exon 06.2, MTOR exon 06.2., PPP2R1A exon 08.2, PIK3CA exon 04, SMAD4 exon 10, FBXL3 exon O₂, BMPR1A exon 04, PMS2 exon 15.2, MTOR exon 03.1, TP53 exon 04.2, SMAD4 exon 02, and MYCBP2 exon 84.

In certain embodiments, the kit comprises polynucleotide primers for detecting the copy numbers of the marker exons listed in Table 2.

In another aspect, the invention provides a method of generating an exon copy number variation (ECNV) profile of a subject that is informative of disease risk, comprising: (a) providing a genomic DNA sample obtained from the subject, wherein the genomic DNA is the genomic DNA from a normal cell or normal tissue; (b) determining the copy number variations of a set of marker exons by comparing the copy number of each of the marker exons in the genomic DNA sample with the copy number of the corresponding exon in a control, wherein the set of marker exons comprise at least one exon from each gene of a set of marker genes, and wherein the set of marker genes comprise one or more genes that have been associated with the disease; and (c) creating an ECNV profile based on the copy number variations of marker exons. The ECNV profile is informative of the onset, progression, severity, or treatment outcome of the disease in the subject.

In another aspect, the invention provides a method of determining disease risk in a subject, comprising: (i) creating or providing an ECNV profile of the subject; and (ii) determining the degree of similarity between the ECNV profile of (i) and one or more reference profiles. The degree of similarity is used to determine the disease risk in the subject (e.g., the onset, progression, severity, or treatment outcome of the disease).

The reference profile is an ECNV profile comprising ECNV information of one or more exons of the marker genes (e.g., a set of marker exons), and the reference profile has a known correlation with the presence or the absence of the disease, or with the onset, progression, severity, or treatment outcome of the disease.

In certain embodiments, a profile database having a plurality of reference profiles are used. Optionally, a reference profile that is most similar to the subject's profile may be identified to further characterize the disease risk in the subject.

In another aspect, the invention provides a method of generating an ECNV profile of a subject that is informative of autoimmune disease risk, comprising: (a) providing a genomic DNA sample obtained from the subject; (b) determining the copy number variations of a set of marker exons in the genomic DNA sample by comparing the copy number of each of the marker exons in the genomic DNA sample with the copy number of the corresponding exon in a control, wherein the set of marker exons comprise at least one exon from each of the following marker genes: Mid1, Mid2, and PPP2R1A; (c) creating an ECNV profile based on the copy number variations of the set of marker exons. The ECNV profile is informative of the onset, progression, severity, or treatment outcome of autoimmune disease in the subject.

In another aspect, the invention provides a method of determining autoimmune risk in a subject, comprising: (i) creating or providing an ECNV profile of the subject according to the method as described herein; (ii) determining the degree of similarity between the ECNV profile of (i) and one or more reference profiles. The degree of similarity is used to determine risk of autoimmune disease in the subject (e.g., the onset, progression, severity, or treatment outcome of autoimmune disease).

The reference profile is an ECNV profile comprising ECNV information of one or more exons of the marker genes (e.g., a set of marker exons), and the reference profile has a known correlation with the presence or the absence of the autoimmune disease, or with the onset, progression, severity, or treatment outcome of the autoimmune disease.

In certain embodiments, a profile database having a plurality of reference profiles are used. Optionally, a reference profile that is most similar to the subject's profile may be identified to further characterize autoimmune disease risk in the subject.

In certain embodiments, the genomic DNA is from a normal cell or normal tissue.

In certain embodiments, the autoimmune disease is systemic lupus erythematosus (SLE).

In another aspect, the invention provides a kit for generating an ECNV profile of a subject that is informative of autoimmune disease, comprising: (a) a set of polynucleotide primers for detecting the copy numbers of a set of marker exons in the genomic DNA of the subject, wherein the set of marker exons comprise at least one exon from each of the following marker genes: Mid1, Mid2, and PPP2R1A, and wherein for each marker exon, at least one primer selectively hybridizes to the exon; and (b) instructions for creating an ECNV profile of the genomic DNA of the subject according to method described herein.

In certain embodiments, the kit comprises polynucleotide primers for detecting the copy numbers of the marker exons listed in Table 3.

In another aspect, the invention provides a method of generating an ECNV profile of a subject that is informative of autoimmune disease risk, comprising: (a) providing a genomic DNA sample obtained from the subject; (b) determining the copy number variations of a set of marker exons in the genomic DNA sample by comparing the copy number of each of the marker exons in the genomic DNA sample with the copy number of the corresponding exon in a control, wherein the set of marker exons comprise at least one exon from each of the following marker genes: ATG16L1, CYLD, IL23R, NOD2, and SNX20; (c) creating an ECNV profile based on the copy number variations of the set of marker exons. The ECNV profile is informative of the onset, progression, severity, or treatment outcome of autoimmune disease in the subject.

In another aspect, the invention provides a method of determining autoimmune risk in a subject, comprising: (i) creating or providing an ECNV profile of the subject according to the method as described herein; (ii) determining the degree of similarity between the ECNV profile of (i) and one or more reference profiles. The degree of similarity is used to determine risk of autoimmune disease in the subject (e.g., the onset, progression, severity, or treatment outcome of autoimmune disease).

The reference profile is an ECNV profile comprising ECNV information of one or more exons of the marker genes (e.g., a set of marker exons), and the reference profile has a known correlation with the presence or the absence of the autoimmune disease, or with the onset, progression, severity, or treatment outcome of the autoimmune disease.

In certain embodiments, a profile database having a plurality of reference profiles are used. Optionally, a reference profile that is most similar to the subject's profile may be identified to further characterize autoimmune disease risk in the subject.

In certain embodiments, the genomic DNA is from a normal cell or normal tissue.

In certain embodiments, the autoimmune disease is Crohn's disease.

In certain embodiments, the marker genes further comprise Mid1, Mid2, and PPP2R1A.

In another aspect, the invention provides a kit for generating an ECNV profile of a subject that is informative of autoimmune disease, comprising: (a) a set of polynucleotide primers for detecting the copy numbers of a set of marker exons in the genomic DNA of the subject, wherein the set of marker exons comprise at least one exon from each of the following marker genes: ATG16L1, CYLD, IL23R, NOD2, and SNX20, and wherein for each marker exon, at least one primer selectively hybridizes to the exon; and (b) instructions for creating an ECNV profile of the genomic DNA of the subject according to method described herein.

In certain embodiments, the kit comprises polynucleotide primers for detecting the copy numbers of the marker exons listed in Table 4.

In another aspect, the invention provides a method of generating an ECNV profile of a subject that is informative of neurological disease risk, comprising: (a) providing a genomic DNA sample obtained from the subject; (b) determining the copy number variations of a set of marker exons in the genomic DNA sample by comparing the copy number of each of the marker exons in the genomic DNA sample with the copy number of the corresponding exon in a control, wherein the set of marker exons comprise at least one exon from each of the following marker genes: APOE, APP, PSEN1, PSEN2, and PSENEN; (c) creating an ECNV profile based on the copy number variations of the set of marker exons. The ECNV profile is informative of the onset, progression, severity, or treatment outcome of autoimmune disease in the subject.

In another aspect, the invention provides a method of determining neurological disease risk in a subject, comprising: (i) creating or providing an ECNV profile of the subject according to the method as described herein; (ii) determining the degree of similarity between the ECNV profile of (i) and one or more reference profiles. The degree of similarity is used to determine risk of neurological in the subject.

The reference profile is an ECNV profile comprising ECNV information of one or more exons of the marker genes (e.g., a set of marker exons), and the reference profile has a known correlation with the presence or the absence of the neurological disease, or with the onset, progression, severity, or treatment outcome of the neurological disease.

In certain embodiments, a profile database having a plurality of reference profiles are used. Optionally, a reference profile that is most similar to the subject's profile may be identified to further characterize neurological disease risk in the subject.

In certain embodiments, the genomic DNA is from a normal cell or normal tissue.

In certain embodiments, the autoimmune disease is Alzheimer's disease.

In another aspect, the invention provides a kit for generating an ECNV profile of a subject that is informative of neurological disease, comprising: (a) a set of polynucleotide primers for detecting the copy numbers of a set of marker exons in the genomic DNA of the subject, wherein the set of marker exons comprise at least one exon from each of the following marker genes: APOE, APP, PSEN1, PSEN2, and PSENEN, and wherein for each marker exon, at least one primer selectively hybridizes to the exon; and (b) instructions for creating an ECNV profile of the genomic DNA of the subject according to method described herein.

In certain embodiments, the kit comprises polynucleotide primers for detecting the copy numbers of the marker exons listed in Table 5.

In certain embodiments, the copy number of an exon is detected by a method selected from: quantitative polymerase chain reaction (QPCR), multiplex ligation dependent probe amplification (MLPA), multiplex amplification and probe hybridization (MAPH), quantitative multiplex PCR of short fluorescent fragment (QMPSF), dynamic allele-specific hybridization, or semiquantitative fluorescence in situ hybridization (SQ-FISH).

In certain embodiments, the ECNV is determined by global pattern recognition (GPR™).

In certain embodiments, the statistical significance of the copy number variation of a marker exon is determined. Examples of statistical methods include, e.g., Student's t-test, the Mann-Whitney U-test, ANOVA and the like. In certain embodiments, the copy number variation of a marker exon is statistically significant when P-value is ≦0.05.

### BRIEF DESCRIPTION OF THE DRAWINGS

FIG. 1 is a table summarizing the result of a validation study that demonstrates the utility of StellARays™ and GPR™ technology in determining genomic DNA (gDNA) copy number variations (CNVs). Individual gDNA samples (biological replicates) from five male C57BL/6J and five female C57BL/6J mice were analyzed using the 384-well Lymphoma and Leukemia StellARray™ (Cat # CA0301-MM384). The StellARray™ had a total of 12 targets on the mouse X chromosome, consisting of 11 genes and an intergenic genomic control (genomic3). For these 12 targets, the expected CNV is two-fold due to the females having 2 copies of the X chromosome and males having only one.

FIG. 2 is a schematic representation of the genomic structure of a hypothetical marker gene (referred herein as gene “X”). Ex1 to Ex6 represent exons, which are separated by introns. Arrows represent PCR primers (forward and reverse) that are used to amplify the exon sequences.

FIG. 3 shows the hierarchical cluster analysis (R-Project, on world wide web at www.r-project.org) of GPR™ data (data not shown) after filtering the data to include only those targets with a p-Value ≦0.05 in at least one sample and a fold change value ≧1.5. The chart represents a heatmap for eight individuals from the K5275 family, with patterned boxes representing decreased and increased fold changes.

FIG. 4 summarizes the result of exon copy number variation study in systemic lupus erythematosus (SLE) mouse models.

FIGS. 5A and 5B show two pedigrees of families in which systemic lupus erythematosus (SLE) has occurred. Affected daughters are indicated by black symbols, and unaffected individuals, by unfilled symbols. FIG. 5C shows the pedigree of a family in which Crohn's disease has occurred in the daughter represented with a split-filled symbol.

FIG. 6 summarizes the result of exon copy number variation study in SLE01 (FIG. 5A) and SLE02 (FIG. 5B) families.

FIG. 7 summarizes the result of exon copy number variation study in IBD0101 family.

FIG. 8 summarizes the result of exon copy number variation study in individuals with Alzheimer's Disease.

### DETAILED DESCRIPTION OF THE INVENTION

### 1. Overview

The invention relates to methods and biomarkers for assessing a subject's risk for a disease, such as cancer (e.g., colorectal cancer), an autoimmune disease or a neurological disease. In particular, the invention provides methods and biomarkers for creating exon copy number variation (ECNV) profiles, and determining disease risk using the subject's ECNV profiles.

The invention is based in part on the discovery that copy number variations of one or more exons of certain marker genes can be statistically significantly correlated to certain clinical diagnosis and disease progression. Detecting the presence of exon copy number variations (ECNVs) in these marker genes in a genomic DNA sample allows for disease risk assessment, disease diagnosis, or disease prognosis in the subject from which the DNA sample is obtained.

For example, as described and exemplified herein, the inventor identified a set of 373 exons from 25 marker genes that are thought to be associated with colorectal cancer/tumor risk (CRC risk). These 25 marker genes were selected based on published sequence, structural, or functional studies that indicate a potential link between the genes and CRC risk. Particularly interesting marker genes were those that had been identified as being associated with CRC by genome-wide association studies (GWAS) but with no known mutations that account for the disease phenotype. The copy number variations of these 373 exons were determined using the genomic DNA sample of an individual, and an ECNV profile for the individual was created.

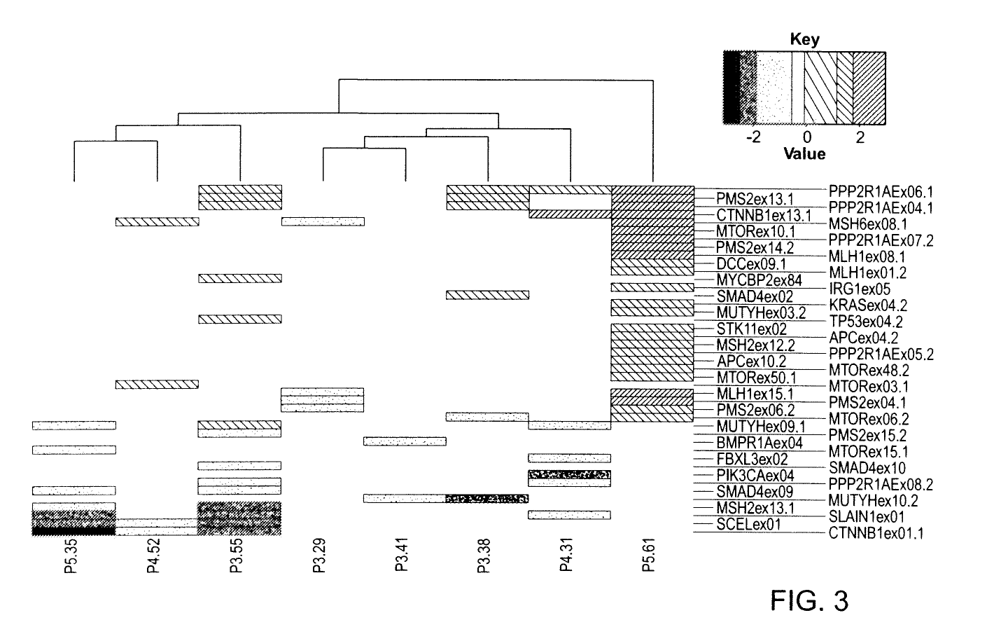

In particular, it was discovered that the two individuals who had been diagnosed with overt CRC has very different ECNV profiles (see FIG. 3). Patient P5.35 has an ECNV profile comprising seven exons (out of 43) that had a statistically significant decrease in copy numbers, as compared to control. Patient P5.61 has an ECNV profile comprising twenty-five exons (out of 43) that had a statistically significant increase in copy numbers, as compared to control. There is no overlap of the ECNV profiles between these two individuals. When the ECNV profiles were correlated with clinical diagnosis, it was discovered that Patient P5.35 was an early onset patient (age 35) with fatal, metastatic CRC, while Patient P5.61 was a late onset patient (age 61) with non-metastatic CRC that was successfully treated, and was clear of CRC/polyps eleven years post-treatment. Thus, these two different ECNV profiles demonstrate that ECNV profiles correlate with the onset, progression, severity, or treatment outcome of CRC.

In addition, as described and exemplified herein, the genomic DNA samples used for ECNV profiling were obtained from “normal” cells or normal tissues (such as peripheral blood) instead of from cancer cells or cancer tissues (diseased tissues). Because chromosomal aberrations (such as translocations, deletions and amplifications) are often readily detected in cancer cells, traditional diagnostic methods (such as microsatellite instability) generally require obtaining DNA samples from cancer cells and comparing the cancer cell DNA with the normal cell DNA from the same patient. In contrast, by using genomic DNA samples from normal cells as described herein, CRC risk can be assessed before disease develops, or at an early stage to improve the outcome of treatment. Moreover, ECNV profiles from a healthy subject may also be created to assess CRC risk (such as the subject's probability of developing CRC in the future), so that appropriate recommendations can be made (such as a treatment regimen, a preventative treatment regimen, an exercise regimen, a dietary regimen, a life style adjustment, etc.) to reduce the risk of developing CRC. Such advantages of using genomic DNA samples from normal cells are also applicable to other diseases.

In one aspect, the invention provides a method of generating an exon copy number variation (ECNV) profile of a subject that is informative of disease risk, comprising: (a) providing a genomic DNA sample obtained from the subject, wherein the genomic DNA is the genomic DNA from a normal cell or normal tissue; (b) determining the copy number variations of a set of marker exons by comparing the copy number of each of the marker exons in the genomic DNA sample with the copy number of the corresponding exon in a control, wherein the set of marker exons comprise at least one exon from each gene of a set of marker genes, and wherein the set of marker genes comprise one or more genes that have been associated with the disease; and (c) creating an ECNV profile based on the copy number variations of marker exons. The ECNV profile is informative of the onset, progression, severity, or treatment outcome of the disease in the subject.

Generally, the method of creating an informative ECNV profile for disease risk assessment includes the following steps.

1. Selecting the Target Disease.

Any disease of interest may be the target disease. However, the availability of genetic, sequence, or functional studies that link certain genes or genetic loci with the disease will facilitate the identification of candidate marker loci, marker genes or marker exons.

2. Selecting Marker Loci, Marker Genes, or Marker Exons.

Candidate marker loci or marker genes may be selected based on available sequence, structural, or functional information that indicates an actual or potential link between the loci or genes and disease risk. Particularly interesting candidate marker loci or marker genes are those that have been identified as being actually or potentially associated with the disease but with no known mutations (e.g., SNPs) that account for the disease phenotype.

3. Obtaining a Genomic DNA Sample.

Obtaining genomic DNA from a subject is conventional in the art, and any suitable method may be used to obtain gDNA from a cell or tissue sample. Preferably, the genomic DNA is obtained from a normal cell or normal tissue.

4. Determining Copy Number Variations of Exons of Marker Genes or Marker Loci.

Any suitable method can be used for determining copy number variations of one or more exons of the marker genes or marker loci in a genomic DNA sample, as compared to a control. Such methods can involve direct or indirect measurement of the actual copy number or of relative copy number. Many suitable methods for determining copy number produce raw data, e.g., fluorescence intensity, PCR cycle threshold (CT) etc., that can reveal copy number or relative copy number following appropriate analysis and/or transformation. Because the method determines disease risk based on relative changes in copy numbers of exons, it is not necessary to determine the absolute copy number of an exon.

5. Creating an ECNV Profile.

The ECNV profile comprises information of CNVs of a set of marker exons. The CNV information of a marker exon includes an increase in copy number, a decrease in copy number, or “no change” in copy number. A statistical analysis may be performed to determine the statistical significance of the copy number variation of a marker exon. A predetermined “fold change” threshold may also be used to filter the ECNV data, such that the profile identifies exons whose copy number variations are above or below a specific fold change value.

In another aspect, the invention provides a method of determining disease risk in a subject, comprising: (i) creating or providing an ECNV profile of the subject according to the method as described herein; and (ii) determining the degree of similarity between the ECNV profile of (i) and one or more reference profiles. The degree of similarity is used to determine the disease risk in the subject (e.g., the onset, progression, severity, or treatment outcome of the disease), and may be expressed e.g., as percent probability of developing a disease. When a subject understands the disease risk, appropriate recommendations can be made to reduce the risk. The recommendations may be a treatment regimen to delay or prevent disease onset or reduce the severity of disease, an exercise regimen, a dietary regimen, or activities that eliminate or reduce environmental risks for the disease.

The reference profile is an ECNV profile comprising ECNV information of one or more exons of the marker genes or marker loci (e.g., a set of marker exons), and the reference profile has a known correlation with the presence or the absence of the disease, or with the onset, progression, severity, or treatment outcome of the disease. A profile database having a plurality of reference profiles may be used.

Using the method as described herein, the inventor has identified marker genes and marker exons that can be used to assess an individual's risk for colorectal cancer, autoimmune diseases (e.g., Systemic lupus erythematosus (SLE or lupus) and Crohn's disease) and neurological diseases (e.g., Alzheimer's disease). This shows that the method described herein can be used to facilitate the risk assessment of a broad spectrum of diseases.

The method as described herein assesses disease risk based on copy number variations of marker loci, marker genes or marker exons, regardless whether the CNVs affect the expression level of a particular gene. While it is possible that the expression level of certain genes, or the activity level of the proteins encoded by the genes might be affected by the CNVs, the method does not require that the expression level of marker genes, or activity level of proteins be altered or determined.

Copy number variation profiles of marker genes or CNV profiles of marker loci may also be created similarly as described herein and used to assess disease risk.

### 2. Definitions

As used herein, the singular forms “a,” “an” and “the” include plural references unless the content clearly dictates otherwise.

The term “about”, as used here, refers to +/−10% of a value.

The term “marker(s)” or “biomarker(s)” as used herein refers to disease-associated genes or portions thereof, e.g., exons or portions thereof, including the genes and exons of genes that are exemplified in the specification and are listed in Tables 1-5. The term also includes disease-associated genetic loci.

The term “assessing” and its synonyms, e.g., “detei mining,” “measuring,” “evaluating,” or “assaying,” as used herein referrers to quantitative and qualitative determinations. Assessing may be relative or absolute. “Assessing the presence of” includes determining the amount of something present, and/or determining whether it is present or absent. The term “assessing risk of disease” is interpreted to mean quantitative or qualitative determination of the presence/absence of the disease, with or without an ability to determine severity, rapidity of onset, resolution of the disease state, e.g. a return to a normal physiological state, or outcomes of a treatment. The probability of an individual that will develop disease can be assessed according to the invention as described herein.

As used herein, the term “exon” refers to a nucleic acid sequence found in genomic DNA that contributes contiguous sequence to a mature mRNA transcript. Exons are intermingled with “introns,” which are non-coding sequences in the DNA. The introns are subsequently eliminated by splicing when the DNA is transcribed into mRNA. The mature RNA molecule can be a messenger RNA or a functional form of a non-coding RNA such as rRNA or tRNA.

The terms genetic “locus,” and its plural form “loci,” refer to a specific position(s) or discrete region(s) on a gene, chromosome, or DNA sequence.

The term “subject” refers to an individual, plant or animal, such as a human, a nonhuman primate (e.g., chimpanzees and other apes and monkey species); farm animals such as birds, fish, cattle, sheep, pigs, goats and horses; domestic mammals such as dogs and cats; laboratory animals including rodents such as mice, rats and guinea pigs, and the like. The term does not denote a particular age or sex. The term “subject” encompasses an embryo and a fetus.

The term “control” as used herein refers to a standard including any control sample, subject, value, etc. appreciated by the skilled artisan to be appropriate for measuring a change or difference. Suitable controls include, for example, samples or subjects having known or predicted characteristics or known or predicted values. Control samples include samples of a like or similar nature to a test agent or sample but having a known or predicted characteristic, e.g., negative or positive control samples. Control subjects include unaffected subjects, unaltered subjects, wild-type subjects, unmanipulated subjects, untreated subjects, and the like. Controls can be physically included in a test or assay in any format. Exemplary controls are positive controls and/or negative controls. For example, control can be to a sample from a subject known to have a disease (positive control) or known not to have a disease (negative control). A control can further be an actual sample from an individual or from a plurality of samples. Control values include known or predicted values for a test, test parameter, test condition, etc., such knowledge being based, for example, on past observation or data, and the like. A control value can be the average or median value of a plurality of samples. A control value can also be a predetermined value (e.g., value according to an electronic database). The term “control” also encompasses a standard curve to which, for example, the results of amplification of one or more genomic sequences (e.g., exons) are compared. The standard curve can be created by amplifying known amounts of (or serial dilutions of) starting materials (e.g., a genomic sequence with known concentration or from lysates of a known number of cells), and plotting the results of the amplification reactions on a graph. Those of skill in the art are well aware of techniques for making standard curves, including those for quantitation of QPCR reactions, and any suitable technique may be used to create the standard curve for use in the present methods.

As used herein, a gene, or a genetic locus is “associated with” a disease when a change in the sequence (e.g., a mutation), a change in the expression level (e.g., mRNA level), or a change in the activity of the protein(s) encoded by the gene or genetic loci, is directly or indirectly, fully or partly responsible for the disease; or alternatively, the gene or genetic loci may not be responsible for the disease, but is associated with a disease in the sense that it is diagnostic or indicative of the disease.

As used herein, a copy number variation (CNV) profile refers to information of the copy number variations of a set of genes or genetic loci in a subject, such as an increase in copy number (amplification), a decrease in copy number (deletion), or “no change” in copy number of a gene or a genetic locus. Preferably, the set of genes or genetic loci comprise at least 3, at least 5, at least 10, at least 15, at least 20, or least 25 genes or genetic loci. The profile may be created according to a set of quantitative or qualitative measurements of CNVs of genes or genomic regions.

An exon copy number variation (ECNV) profile refers to information of the copy number variations of a set of exons of one or more genes. Preferably, the set of exons comprise at least 3, at least 5, at least 10, at least 15, at least 20, at least 25, at least 30, at least 35, at least 40, at least 45, at least 50, at least 60, at least 70, at least 80, at least 90, at least 100, at least 110, at least 120, at least 130, at least 140, at least 150 exons. The CNV information of an exon includes an increase in copy number, a decrease in copy number, or “no change” in copy number of the exon.

As used herein, an ECNV profile “correlates with” a particular disease state when the profile is diagnostic or indicative of the presence, onset, stage, grade, severity, progression, or treatment outcome of a disease. An ECNV profile can be correlated to a particular disease state by identifying certain characteristics that are representative of the disease state, and linking these characteristics to an ECNV profile (e.g., by creating an ECNV from the genomic DNA of a subject who has these characteristics). The ECNV profile may comprise information of CNVs of a set of exons of one or more genes who are associated with the disease.

The terms “tumor” or “cancer” refer to the presence of cells possessing characteristics typical of cancer-causing cells, such as uncontrolled proliferation, immortality, metastatic potential, rapid growth and proliferation rate, and certain characteristic morphological features. Cancer cells are often in the form of a tumor, but such cells may exist alone within an animal, or may be a non-tumorigenic cancer cell, such as a leukemia cell. As used herein, the term “cancer” includes premalignant as well as malignant cancers.

The term “cancer” also refers to neoplasm, which literally means “new growth.” A “neoplastic disorder” is any disorder associated with cell proliferation, specifically with a neoplasm. A “neoplasm” is an abnormal mass of tissue that persists and proliferates after withdrawal of the carcinogenic factor that initiated its appearance. There are two types of neoplasms, benign and malignant. Nearly all benign tumors are encapsulated and are noninvasive; in contrast, malignant tumors are almost never encapsulated but invade adjacent tissue by infiltrative destructive growth. This infiltrative growth can be followed by tumor cells implanting at sites discontinuous with the original tumor. The methods and biomarkers of the invention can be used to assess risk in subjects with neoplastic disorders, including but not limited to: sarcoma, carcinoma, fibroma, glioma, leukemia, lymphoma, melanoma, myeloma, neuroblastoma, retinoblastoma, and rhabdomyosarcoma, as well as each of the other tumors described herein.

Cancers for which risk can be assess by the methods and biomarkers of the invention include, but are not limited to, basal cell carcinoma, biliary tract cancer; bladder cancer; bone cancer; brain and CNS cancer; breast cancer; cervical cancer; choriocarcinoma; colon and rectum cancer; connective tissue cancer; cancer of the digestive system; endometrial cancer; esophageal cancer; eye cancer; cancer of the head and neck; gastric cancer; intra-epithelial neoplasm; kidney cancer; larynx cancer; leukemia; liver cancer; lung cancer (e.g., small cell and non-small cell); lymphoma including Hodgkin's and non-Hodgkin's lymphoma; melanoma; myeloma; neuroblastoma; oral cavity cancer (e.g., lip, tongue, mouth, and pharynx); ovarian cancer; pancreatic cancer; prostate cancer; retinoblastoma; rhabdomyosarcoma; rectal cancer; renal cancer; cancer of the respiratory system; sarcoma; skin cancer; stomach cancer; testicular cancer; thyroid cancer; uterine cancer; cancer of the urinary system, as well as other carcinomas and sarcomas.

In certain embodiments, the methods and biomarkers of the present invention can be used to assess risk of malignant disorders commonly diagnosed in dogs and cats. Such malignant disorders include but are not limited to lymphosarcoma, osteosarcoma, mammary tumors, mastocytoma, brain tumor, melanoma, adenosquamous carcinoma, carcinoid lung tumor, bronchial gland tumor, bronchiolar adenocarcinoma, fibroma, myxochondroma, pulmonary sarcoma, neurosarcoma, osteoma, papilloma, retinoblastoma, Ewing's sarcoma, Wilms' tumor, Burkitt's lymphoma, microglioma, neuroblastoma, osteoclastoma, oral neoplasia, fibrosarcoma, osteosarcoma and rhabdomyosarcoma. Other neoplasias in dogs include genital squamous cell carcinoma, transmissable venereal tumor, testicular tumor, seminoma, Sertoli cell tumor, hemangiopericytoma, histiocytoma, chloroma (granulocytic sarcoma), corneal papilloma, corneal squamous cell carcinoma, hemangiosarcoma, pleural mesothelioma, basal cell tumor, thymoma, stomach tumor, adrenal gland carcinoma, oral papillomatosis, hemangioendothelioma and cystadenoma. Additional malignancies diagnosed in cats include follicular lymphoma, intestinal lymphosarcoma, fibrosarcoma and pulmonary squamous cell carcinoma. The ferret, an ever-more popular house pet, is known to develop insulinoma, lymphoma, sarcoma, neuroma, pancreatic islet cell tumor, gastric MALT lymphoma and gastric adenocarcinoma.

In certain other embodiments, the methods and biomarkers of the present invention can be used to assess risk of neoplasias affecting agricultural livestock. These neoplasias include leukemia, hemangiopericytoma and bovine ocular neoplasia (in cattle); preputial fibrosarcoma, ulcerative squamous cell carcinoma, preputial carcinoma, connective tissue neoplasia and mastocytoma (in horses); hepatocellular carcinoma (in swine); lymphoma and pulmonary adenomatosis (in sheep); pulmonary sarcoma, lymphoma, Rous sarcoma, reticuloendotheliosis, fibrosarcoma, nephroblastoma, B-cell lymphoma and lymphoid leukosis (in avian species); retinoblastoma, hepatic neoplasia, lymphosarcoma (lymphoblastic lymphoma), plasmacytoid leukemia and swimbladder sarcoma (in fish), caseous lymphadenitis (CLA), and contagious lung tumor of sheep caused by the jaagsiekte virus.

The term a “normal cell” as used herein refers to a cell that does not exhibit disease phenotype. For example, in determining the risk of a subject for cancer (e.g., colorectal cancer), a normal cell (or a non-cancerous cell) refers to a cell that is not a cancer cell (non-malignant, non-cancerous, or without DNA damage characteristic of a tumor or cancerous cell). The term a “diseased cell” refers to a cell displaying one or more phenotype of a particular disease or condition.

As used herein, the term “diseased tissue” refers to tissue from vertebrate (in particular mammalian) embryos, fetal or adult sources that are infected, inflamed, or dysplastic. The term “normal tissue” refers to non-diseased tissue from vertebrate (in particular mammalian) embryos, fetal or adult sources.

As used herein, the term “selectively hybridize” refers to hybridization which occurs when two nucleic acid sequences are substantially complementary (e.g., at least about 65% complementary over a stretch of at least 14 to 25 nucleotides, preferably at least about 75% complementary, more preferably at least about 90% complementary) (See Kanehisa, M., 1984, Nucleic acids Res., 12:203). As a result, it is expected that a certain degree of mismatch is tolerated. Such mismatch may be small, such as a mono-, di- or tri-nucleotide. Alternatively, a region of mismatch can encompass loops, which are defined as regions in which there exists a mismatch in an uninterrupted series of four or more nucleotides. Numerous factors influence the efficiency and selectivity of hybridization of two nucleic acids, for example, the hybridization of a nucleic acid member on an array to a target nucleic acid sequence. These factors include nucleic acid member length, nucleotide sequence and/or composition, hybridization temperature, buffer composition and potential for steric hindrance in the region to which the nucleic acid member is required to hybridize. A positive correlation exists between the nucleic acid length and both the efficiency and accuracy with which a nucleic acid will anneal to a target sequence. In particular, longer sequences have a higher melting temperature (Tm) than do shorter ones, and are less likely to be repeated within a given target sequence, thereby minimizing non-specific hybridization. Hybridization temperature varies inversely with nucleic acid member annealing efficiency. Similarly the concentration of organic solvents, e.g., formamide, in a hybridization mixture varies inversely with annealing efficiency, while increases in salt concentration in the hybridization mixture facilitate annealing. Under stringent annealing conditions, longer nucleic acids, hybridize more efficiently than do shorter ones, which are sufficient under more permissive conditions.

### 3. Method of Creating an Exon Copy Number Variation Profile

In one aspect, the invention provides a method of generating an exon copy number variation (ECNV) profile of a subject that is informative of disease risk, comprising: (a) providing a genomic DNA sample obtained from the subject, wherein the genomic DNA is the genomic DNA from a normal cell or normal tissue; (b) determining the copy number variations of a set of marker exons by comparing the copy number of each of the marker exons in the genomic DNA sample with the copy number of the corresponding exon in a control, wherein the set of marker exons comprise at least one exon from each gene of a set of marker genes, and wherein the set of marker genes comprise one or more genes that have been associated with the disease; and (c) creating an ECNV profile based on the copy number variations of marker exons. The ECNV profile is informative of the onset, progression, severity, or treatment outcome of the disease in the subject.

Generally, the method of creating an informative ECNV profile for disease risk assessment includes the following steps: (1) selecting a target disease; (2) selecting marker loci, marker genes, or marker exons; (3) obtaining a genomic DNA sample; (4) determining copy number variations of exons of marker genes or marker loci in the sample; and (5) creating an ECNV profile.

A. Selecting the Target Disease, Marker Loci, Marker Genes and Marker Exons

Any disease of interest may be the target disease. However, the availability of genetic, sequence, or functional studies that link certain genes or genetic loci with the disease will facilitate the identification of candidate marker loci, marker genes or marker exons.

Candidate marker loci or marker genes may be selected based on available sequence, structural, or functional information that indicates an actual or potential link between the genes or genetic loci and disease risk. Particularly interesting candidate marker genes or marker loci are those that have been identified as being actually or potentially associated with disease but with no known mutations (e.g., SNPs) that account for the disease phenotype.

For example, marker genes or loci may be identified based on information from scientific literature and public databases (e.g., NCBI, OMIM, etc.) that indicates an actual or potential link between the genes or genetic loci and disease risk. In addition, if the biological function(s) of the protein(s) encoded by the gene or genetic loci is known, additional genes that encode proteins having similar biological functions, or proteins that are involved in the same biological pathway (e.g., a protein that is either “upstream” or “downstream” of initial candidate) may be selected.

Alternatively, association studies may be conducted within individuals in affected families (linkage studies), or within the general population, to identify marker genes or loci. The association study typically involves determining the frequency of a particular allele (variant) in individuals with the disease, as well as controls of similar age and race. Significant associations between the allele and phenotypic characteristics can be determined by standard statistical methods known in the art.

Preferably, a set of marker genes or marker loci comprising at least 3, at least 5, at least 10, at least 15, at least 20, or least 25 genes or genetic loci are identified.

Once marker genes or marker loci have been selected, a variety of methods can be used to determine the sequences of the exons of the marker genes or marker loci. For example, the exons of many genes are available from scientific literature and public databases (e.g., NCBI, OMIM, etc.). Alternatively, exons can be determined experimentally, e.g., by EST analysis or by hybridizing labeled mRNA to a microarray containing random genomic fragments (Adams et al., 1991, Science 252:1651-6; Stephan et al., 2000, Mol. Genet. Metab. 70:10-18). Computer modeling programs, such as GENSCAN, GRAIL, and ER (Exon Recognizer) may also be used to predict the exons of a gene.

Preferably, a set of marker exons comprising at least 3, at least 5, at least 10, at least 15, at least 20, at least 25, at least 30, at least 35, at least 40, at least 45, at least 50, at least 60, at least 70, at least 80, at least 90, at least 100, at least 110, at least 120, at least 130, at least 140, at least 150 exons are identified.

B. Genomic DNA Sample Isolation and Preparation

Any suitable genomic DNA (gDNA) sample can be used, including, e.g., crude, purified or semipurified genomic DNA obtained from a subject. Any suitable method can be used to obtain the gDNA from a suitable source including one or more cells, bodily fluids or tissues obtained from a subject.

Obtaining genomic DNA from a subject is conventional in the art, and any suitable method may be utilized to obtain gDNA from a sample. Genomic DNA can be isolated from one or more cells, bodily fluids or tissues, or from one or more cell or tissue in primary culture, in a propagated cell line, a fixed archival sample, forensic sample or archeological sample. For example, cell or tissue samples, such as biopsy, mucous, saliva, epithelial cell samples, etc., can be used as a source of gDNA.

For example, genomic DNA can be obtained from any suitable tissue samples, including but not limited to whole blood, serum, plasma, buccal scrape, saliva, cerebrospinal fluid, urine, stool, bronchoalveolar lavage, and lung tissue.

For example, genomic DNA can be obtained from any suitable cell, including but not limited to, a white blood cell such as a B lymphocyte, T lymphocyte, macrophage, or neutrophil; a muscle cell such as a skeletal cell, smooth muscle cell or cardiac muscle cell; germ cell such as a sperm or egg; epithelial cell; connective tissue cell such as an adipocyte, fibroblast or osteoblast; neuron; astrocyte; stromal cell; kidney cell; pancreatic cell; liver cell; a keratinocyte and the like. A cell from which gDNA is obtained can be at a particular developmental level if desired.

Known biopsy methods can be used to obtain cells or tissues such as a buccal swab or scrape, mouthwash, surgical removal, biopsy aspiration or the like. Convenient sources of gDNA include a buccal tissue or cell sample, such as check swab or scrape, or a blood sample. Genomic DNA can be easily prepared using such samples.

A cell from which a gDNA sample is obtained for use in the invention can be a normal cell or a cell displaying one or more phenotype of a particular disease or condition (a “diseased cell”). Thus, a gDNA used in the invention can be obtained from normal cells or tissues from a healthy subject, normal cells or tissues from a subject suffering from a disease, or diseased cells or tissues from a subject suffering from a disease (such as a cancer cell, neoplastic cell, necrotic cell, or the like). Those skilled in the art will know or be able to readily determine methods for isolating gDNA from a cell, fluid or tissue using methods known in the art such as those described in Sambrook et al., Molecular Cloning: A Laboratory Manual, 3rd edition, Cold Spring Harbor Laboratory, New York (2001) or in Ausubel et al., Current Protocols in Molecular-Biology, John Wiley and Sons, Baltimore, Md. (1998).

Preferably, the genomic DNA sample used for ECNV profiling is obtained from normal cells or normal tissues instead of from diseased cells or diseased tissues. By using genomic DNA samples from normal cells, disease risk can be assessed before disease develops to prevent disease onset, or at early stage to improve the outcome of treatment. Moreover, ECNV profiles from a healthy subject may also be created as a screening tool to assess disease risk (such as the subject's probability of developing a disease in the future), so that appropriate recommendations can be made (such as a treatment regimen, a preventative treatment regimen, an exercise regimen, a dietary regimen, a life style adjustment etc.) to reduce the risk of developing the disease.

If desired, the genomic DNA can be obtained from a mixed cell population, or a semipurified or substantially pure cell population. Suitable methods for isolating desired cell types from other types of cells are known in the art, and include, but are not limited to, Fluorescent Activated Cell Sorting (FACS) as described, for example, in Shapiro, Practical Flow Cytometry, 3rd edition Wiley-Liss; (1995), density gradient centrifugation, or manual separation using micromanipulation methods with microscope assistance. Exemplary cell separation devices that are useful in the invention include, without limitation, a Beckman JE-6® centrifugal elutriation system, Beckman Coulter EPICS ALTRA® computer-controlled Flow Cytometer-cell sorter, Modular Flow Cytometer® from Cytomation, Inc., Coulter counter and channelyzer system, density gradient apparatus, cytocentrifuge, Beckman J-6 centrifuge, EPICS V® dual laser cell sorter, or EPICS PROFILE® flow cytometer. A tissue or population of cells can also be removed by surgical techniques.

Genomic DNA can be obtained using any suitable method, including, for example, liquid phase extraction, precipitation, solid phase extraction, chromatography and the like. Such methods are described for example in Sambrook et al., supra, (2001) or in Ausubel et al., supra, (1998) or available from various commercial vendors including, for example, Qiagen (Valencia, Calif.) or Promega (Madison, Wis.). In one example, a cell containing gDNA is lysed under conditions that substantially preserve the integrity of the cell's gDNA. Exposure of a cell to alkaline pH can be used to lyse a cell in a method of the invention while causing relatively little damage to gDNA. Any of a variety of basic compounds can be used for lysis including, for example, potassium hydroxide, sodium hydroxide, and the like. Additionally, relatively undamaged gDNA can be obtained from a cell lysed by an enzyme that degrades the cell wall. Cells lacking a cell wall either naturally or due to enzymatic removal can also be lysed by exposure to osmotic stress. Other conditions that can be used to lyse a cell include exposure to detergents, mechanical disruption, sonication heat, pressure differential such as in a French press device, or Dounce homogenization. Agents that stabilize gDNA can be included in a cell lysate or isolated gDNA sample including, for example, nuclease inhibitors, chelating agents, salts buffers and the like. Methods for lysing a cell to obtain gDNA can be carried out under conditions known in the art as described, for example, in Sambrook et al., supra (2001) or in Ausubel et al., supra, (1998).

The gDNA sample used in the method of the invention can be, a crude cell lysate, semipurified or substantially purified gDNA.

If desired, the gDNA can first be amplified. Amplified gDNA refers to a preparation of gDNA that contains copies of original template gDNA in which the proportion of each sequence relative to all other sequences in the amplified preparation is substantially the same as the proportions in the original template gDNA. When used in reference to a population of genomic DNA fragments, for example, the term is intended to mean a population of genome fragments in which the proportion of each genome fragment to all other genome fragments in the population is substantially the same as the proportion of its sequence to the other genome fragment sequences in the genome. Substantial similarity between the proportion of sequences in an amplified preparation and an original template genomic DNA means that at least 60%, or at least 70%, or at least 80% or at least 90% or at lest 95% or substantially all of the loci in the amplified preparation are no more than 5 fold over-represented or under-represented relative to the template gDNA. In such preparations at least 70%, 80%, 90%, 95% or 99% of the loci can be, for example, no more than 5, 4, 3 or 2 fold over-represented or under-represented.

An advantage of amplifying the gDNA sample is that only a small amount of genomic DNA needs to be obtained from an individual. Thus, amplified gDNA preparations can facilitate disease risk assessment using the methods of the invention when only a relatively small gDNA sample is available (e.g., an archived sample or forensic sample). In some embodiments, a genomic DNA sample can be obtained from a single cell, amplified, and analyzed using the methods as described herein.

Methods that amplify only a portion of the genomic DNA that contains a locus, gene or exon of interested, or methods of whole genome amplification can be used as desired. Amplification can reduce the complexity of the original template gDNA, or the complexity of the original gDNA can be substantially preserved, as desired. Suitable genomic DNA amplification methods include PCR-based or isothermal-based amplification methods, such as, Wole-Genome Amplification by Adaptor-Ligation PCR of Randomly Sheared Genomic. DNA (PRSG); Whole-Genome Amplification by Single-Cell Comparative Genomic Hybridization PCR (SCOMP); Nested Patch PCR for Highly Multiplexed Amplification of Genomic Loci; Whole Genome Amplification by T7-Based Linear Amplification of DNA (TLAD); GenomePlex Whole-Genome Amplification; Whole-Genome Amplification by Degenerate Oligonucleotide Primed PCR (DOP-PCR); Exon Trapping and Amplification; 3′-End cDNA Amplification Using Classic RACE; 5′-End cDNA Amplification Using New RACE; Multiple Displacement Amplification (MDA) and Rapid Amplification of DNA Using Phi29 DNA Polymerase and Multiply-Primed Rolling Circle Amplification. These and other suitable methods for genomic DNA amplification are conventional in the art and details about each can be found for example at Cold Spring Harbor Protocols website at cshprotocols.cshlp.org.

C. Determining Copy Number Variations of Marker Exons

Any suitable method can be used for determining copy number variations of marker loci, marker genes, or marker exons in a gDNA sample. Such methods can involve direct or indirect measurement of the actual copy number or of relative copy number. Many suitable methods for determining gene copy number produce raw data, e.g., fluorescence intensity, PCR cycle threshold (CT) etc., that can reveal copy number or relative copy number following appropriate analysis and/or transformation. Accordingly, determining gene, genetic loci, or exon copy number can include, for example, a DNA amplification process, a DNA signal detection process, a DNA signal amplification process, and steps for processing and analyzing the raw data, and combinations thereof. Generally, the method includes processing and analyzing the raw data to provide a user readable output that shows exon copy number or relative copy number and or changes therein.

Although the method determines disease risks based on changes in copy numbers of exons, genes, or genetic loci, it is not necessary to determine the absolute copy number of an exon, gene, or genetic locus. Any analytical methods that produce a signal that is related to the copy number of an exon, gene, or genetic locus, such as quantitative polymerase chain reaction (QPCR), can be used in the method of the invention.

The method of the invention can include determining the magnitude of change in a desired exon as compared to a control. However, the data analysis aspects of the method focus on the statistical significance of the change in the copy number of the exon, rather than the magnitude of change. A small magnitude of change that is statistically significant can show a close correlation between altered copy number of a particular exon and a particular disease state.

1. Techniques for Determining Copy Number Variations

Suitable methods for detecting copy number variations in genetic loci, genes or exons in gDNA include, but are not limited to, oligonucleotide genotyping, sequencing, southern blotting, array-base comparative genomic hybridization, dynamic allele-specific hybridization (DASH), paralogue ratio test (PRT), multiple amplicon quantification (MAQ), quantitative polymerase chain reaction (QPCR), multiplex ligation dependent probe amplification (MLPA), multiplex amplification and probe hybridization (MAPH), quantitative multiplex PCR of short fluorescent fragment (QMPSF), dynamic allele-specific hybridization, fluorescence in situ hybridization (FISH), semiquantitative fluorescence in situ hybridization (SQ-FISH) and the like. For more detail description of some of the older methods in this list, see, e.g. Sambrook, Molecular Cloning—A Laboratory Manual, Cold Spring Harbor Laboratory, Cold Spring Harbor, N.Y., (1989), Kallioniemi et al., Proc. Natl. Acad Sci USA, 89:5321-5325 (1992), and PCR Protocols, A Guide to Methods and Applications, Innis et al., Academic Press, Inc. N.Y., (1990).

In one embodiment, Comparative Genomic Hybridization (CGH) can be used to detect copy number variations. In a typical array CGH experiment, genomic DNA from a test sample is compared to that of a control sample. Typically, a glass slide or other array substrate is spotted with small DNA fragments from mapped genomic targets (i.e., DNA fragments of known identity and genomic position). A first collection of (sample) nucleic acids (e.g., gDNA from the test subject) is labeled with a first label, while a second collection of (control) nucleic acids (e.g. gDNA from a control subject) is labeled with a second label. The ratio of hybridization of the nucleic acids is determined by the ratio of the two (first and second) labels binding to each spot in the array. Where there are chromosomal deletions or multiplications, differences in the ratio of the signals from the two labels will be detected and the ratio will provide a measure of the copy number. CGH method is particularly well suited to array-based platform. For a description of one preferred array-based CGH and hybridization systems see Pinkel et al. Nature Genetics, 20:207-211 (1998), U.S. Pat. Nos. 6,066,453; 6,210,878; 6,326,148; and 6,465,182, which are incorporated herein by reference in their entirety.

In one embodiment, Dynamic Allele-Specific Hybridization (DASH) can be used to detect copy number variations. This technique involves dynamic heating and coincident monitoring of DNA denaturation, as disclosed by Howell et al. (Nat. Biotech. 17:87-88, (1999)). Briefly, in this method, a target sequence is amplified by PCR in which one primer is biotinylated. The biotinylated product strand is bound to a streptavidin-coated well of a microtiter plate and the non-biotinylated strand is rinsed away with alkali wash solution. An oligonucleotide probe, specific for a gene or an exon, is hybridized to the target at low temperature. This probe forms a duplex DNA region that interacts with a double strand-specific intercalating dye. When subsequently excited, the dye emits fluorescence proportional to the amount of double-stranded DNA (probe-target duplex) present. The sample is then steadily heated while fluorescence is continually monitored. A rapid fall in fluorescence indicates the denaturing temperature of the probe-target duplex. Using this technique, because a single-base mismatch between the probe and target results in a significant lowering of melting temperature (Tm), the copy number of target sequences with perfect match with the probes can be quantified.

In one embodiment, Paralogue Ratio Test (PRT) can be used to detect copy number variations. PRT has been described in more detail in U.S. Pub. No. 20050037388, the entire content of which is incorporated herein by reference. Briefly, the method utilizes PCR to amplify a target sequence and its paralogue sequence located on a different chromosome in the subject. Any variation in the ratio of the amplified target sequence and paralogue sequence indicates an abnormal copy number distribution and suggests risk of a genetic disorder.

In one embodiment, Multiple Amplicon Quantification (MAQ) can be used to detect copy number variations. MAQ is a method for the analysis of specific copy number variations (CNVs). Briefly, the method consists of fluorescently labeled multiplex PCR with amplicons in the CNV (target amplicons) and amplicons with a stable copy number (control amplicons). After PCR, the fragments are size separated on a capillary sequencer. The ratios of target amplicons over control amplicons are calculated for the test sample and a reference sample. Comparison of these relative intensities results in a dosage quotient, indicating the copy number of the CNV in the test sample.

In one embodiment, Quantitative Polymerase Chain Reaction (QPCR) can be used to detect copy number variations. Briefly, qPCR is used for simultaneously amplifying and quantifying a single or multiple target sequences in sample. For example, quantitative real time PCR detects increases in fluorescence at each cycle of PCR through (for example, probes that hybridize to a portion of one of the amplification probes) the release of fluorescence from a quencher sequence while the uniprimer (universal primer) binds to the DNA sequence. Fluorescence in real time quantitative PCR is produced using a suitable fluorescent reporter dye such as SYBR green, FAM, fluorescein, HEX, TET, TAMRA, etc. and a quencher such as DABSYL, Black Hole, etc. When the quencher is separated from the probe during the extension phase of PCR, the fluorescence of the reporter can be measured. Systems like Molecular Beacons, Taqman Probes, Scorpion Primers or Sunrise Primers and the like use this approach to perform real-time quantitative PCR. Examples of methods and reagents related to real time PCR can be found in U.S. Pat. Nos. 5,925,517, 6,103,476, 6,150,097, and 6,037,130, which are incorporated by reference herein at least for material related to detection methods for nucleic acids and PCR methods.

In one embodiment, Multiplex Amplification and Probe Hybridization (MAPH) can be used to detect copy number variations. This technique which is also called multiplex amplifiable probe hybridization is for detection of nucleic acid targets and is described in Armour et al., Nucleic Acids Res., 28(2):605-609, (2000) and U.S. Pat. No. 6,706,480, which are incorporated herein by reference in their entirety. In MAPH, the probes are hybridized to a sample, excess probe is washed away, and the hybridized probe is recovered and amplified by PCR. The different probes are flanked by common primer binding sites so the whole collection of probes can be amplified together by PCR.

In one embodiment, Multiplex Ligation Dependent Probe Amplification (MLPA) can be used to detect copy number variations. MLPA is a method to establish the copy number of up to 45 nucleic acid sequences in one single PCR amplification reaction. It can be used for both copy number detection and to quantify methylation in gDNA. It is a method for multiplex detection of copy number changes of genomic DNA sequences using DNA samples derived from blood (Gille et al. Br. J. Cancer, 87:892-897 (2002); Hogervorst et al. Cancer Res., 63:1449-1453 (2003)). With MLPA, it is possible to perform a multiplex PCR reaction in which up to 45 specific sequences are simultaneously quantified. Amplification products are separated by sequence type electrophoresis. The peaks obtained in the sequence type electrophoresis, when compared with a control sample peak, allows one to determine the gene copy number of a probed gene or nucleic acid sequence in the test sample. Comparison of the gel pattern to that obtained with a control sample indicates which sequences show an altered copy number.

The general outline of MLPA is fully described in Schouten et al. Nucl. Acid Res. 30:e57 (2002) and also can be found U.S. Pat. No. 6,955,901, these references are incorporated herein by reference in their entirety. MLPA probes are designed that hybridizes to the gene of interest or region of genomic DNA that have variable copies or polymorphism. Each probe is actually in two parts, both of which will hybridize to the target DNA in close proximity to each other. Each part of the probe carries the sequence for one of the PCR primers. Only when the two parts of the MLPA probe are hybridized to the target DNA in close proximity to each other will the two parts be ligated together, and thus form a complete DNA template for the one pair of PCR primers used. When there are microdeletions, the provided MLPA probes that targets the deletion region will not form complete DNA template for the one pair of PCR primers used and so no or lower amount of PCR products will be formed. When there are microduplications, the provided MLPA probes that targets the duplicated region will form many complete DNA templates for the one pair of PCR primers used compared to a normal copy number sample of genomic DNA. The amount of PCR products formed will be more than in a control sample having a normal copy number of the region of interest.

In one embodiment, Quantitative Multiplex PCR of Short Fluorescent Fragment (QMPSF) can be used to detect copy number variations. Briefly, in this method real-time PCR is multiplexed with probe color and melting temperature (Tm). Simple hybridization probes with only a single fluorescent dye can be used for quantification and allele typing. Different probes are labeled with dyes that have unique emission spectra. Spectral data are collected with discrete optics or dispersed onto an array for detection. Multiplexing by color and T(m) creates a “virtual” two-dimensional multiplexing array without the need for an immobilized matrix of probes. Instead of physical separation along the X and Y axes, amplification products are identified and quantified by different fluorescence spectra and melting characteristics.

In one embodiment, Fluorescence In Situ Hybridization (FISH) can be used to detect copy number variations. Fluorescence in situ hybridization refers to a nucleic acid hybridization technique which employs a fluorophor-labeled probe to specifically hybridize to and thereby, facilitate visualization of or copy number detection of a target nucleic acid. Such methods are well known to those of ordinary skill in the art and are disclosed, for example, in U.S. Pat. Nos. 5,225,326; 5,707,801, the entire contents of which are incorporated herein by reference.

Briefly, fluorescence in situ hybridization involves fixing the sample to a solid support and preserving the structural integrity of the components contained therein by contacting the sample with a medium containing at least a precipitating agent and/or a cross-linking agent. Alternative fixatives are well known to those of ordinary skill in the art and are described, for example, in the above-noted patents.

In situ hybridization is performed by denaturing the target nucleic acid so that it is capable of hybridizing to a complementary probe contained in a hybridization solution. The fixed sample may be concurrently or sequentially contacted with the denaturant and the hybridization solution. Thus, in a particularly preferred embodiment, the fixed sample is contacted with a hybridization solution which contains the denaturant and at least one oligonucleotide probe. The probe has a nucleotide sequence at least substantially complementary to the nucleotide sequence of the target nucleic acid. According to standard practice for performing fluorescence in situ hybridization, the hybridization solution optionally contains one or more of a hybrid stabilizing agent, a buffering agent and a selective membrane pore-forming agent. Optimization of the hybridization conditions for achieving hybridization of a particular probe to a particular target nucleic acid is well within the level of the person of ordinary skill in the art.

In one embodiment, Semiquantitative Fluorescence In Situ Hybridization (SQ-FISH) can be used to detect copy number variations. SQ-FISH is a variant methodology based on FISH. Briefly, this method adopts a multicolor fluorescence in situ hybridization, which allows investigation of different genes at the same time in the same cell. The digital imaging capabilities of a charge-coupled device camera can quantify the hybridization signals for multiple genes, and by comparing them to control genes, obtain relative signal quantities and/or copy numbers.

2. Raw Data Processing and Analysis

Generally, the method described herein includes processing and analyzing the raw data to provide a user readable output that shows the copy number or relative copy number or changes therein of a marker exon, marker gene, or marker loci. Any suitable method or methods can be used in the analysis copy number data from subjects (and suitable controls, if needed). In some instances, vendors who provide tools for DNA copy number detection also provide tools for processing and quantifying raw data or signals. For instance, Affymetrix® offers copy number analysis software that can be use for Affymetrix® arrays. Applied Biosystems® offers ABI PRISM® 7700 Sequence Detection System for quantification of the real-time PCR data. Thus although GPR™ is a preferred method for analysis of gene copy number data, other suitable methods can be used to analyze gene copy data.

In certain embodiments, the statistical significance of the copy number variation of a marker exon, marker gene, or marker loci is determined. Examples of statistical methods include, e.g., Student's t-test, the Mann-Whitney test, ANOVA and the like. In certain embodiments, the copy number variation of a marker exon is statistically significant when P-value is ≦0.05.

Examples of suitable controls that can be used in the methods of the present invention include gDNA samples from a healthy subject, or a pool of healthy subjects (e.g., unaffected individuals, age-matched health individuals, sex-matched health individuals, and combinations thereof). In addition, suitable controls can be commercially available genomic DNA samples, Suitable controls further include samples of a like or similar nature to a test agent or sample but having a known characteristic, e.g., DNA sequences with known concentration or amplification efficiencies.

Suitable controls can also be a pre-determined threshold value for copy number variation of one or more of the genes or exons (e.g., value according to an electronic database), and deviation from the threshold is indicative of disease risk. Data can be normalized to such controls in certain tests or assays.

A suitable control can also be a defined DNA (e.g., a synthetic DNA) with known composition (e.g., copy number of the gene of interest) that can be used as a standard for copy number assessment. In one example, a standard curve, such as a standard curve produced using a defined DNA, is produced and copy number is quantified in test samples by reference to the standard curve. Thus a suitable control can also be a value or a standard curve based on which the relative gene copy number of a disease-related gene or portion thereof can be determined. In an exemplary embodiment where QPCR is used for copy number detection, the relative copy number of a biomarker in a test sample can be estimated by generating a standard curve of known copy number of a template that has an amplification efficiency similar to that of the biomarker in the test sample. In this embodiment, the CT values for serial dilutions of the template are obtained and a standard curve based on concentration or copy number and CT values is plotted. Subsequently, the CT value of the biomarker is compared to the standard curve to determine the relative copy number of the biomarker.

In some embodiments, the methods are realized as software processes. For example, the methods may be realized as server/web based applications (see, http://www.bhbio.com/apps/; http://array.lonza.com/gpr/), or Microsoft Excel-based software programs (see, http://research.jax.org/faculty/roopenian/gene_expression.pdf), that output a ranked list of statistically changed DNA sequences using raw input data (such as cycle threshold (CT) values) from 48 to 384 target DNA sequences in up to five control replicates and five experimental replicates. The input data can be collected by making use of, for example, a 384-well array. The method compares the datasets from both groups using Student's T-test after multiple DNA sequence normalization processes. The invention thus enables the recognition of a change in DNA sequence copy number. In one aspect, the invention uses the power of biological replicates and the sensitivity of real-time PCR techniques to extract the most statistically changed DNA sequences, even if the fold change is small.

In one embodiment, the present invention uses the methods described in U.S. Pub. No. 20060129331, the entire contents of which are incorporated herein by reference, also known as global pattern recognition (GPR™) for analysis of exon copy number variations. In certain embodiments, the control for GPR™ analysis is gDNA from a healthy individual, such as an individual not affected with the disease of interest (e.g., an unaffected family member), or a pool of healthy individuals.

In general, the method disclosed in U.S. Pub, No. 20060129331 includes a DNA sequence filtering step to identify and discard non-informative data while retaining informative DNA (also referred to as data DNA) data, and a qualifier filtering step to identify qualifier DNA sequences which will serve as a baseline for comparison and normalization in subsequent statistical analysis. The next step is to perform global pattern recognition (GPR™) to output a ranked list of DNA sequences based on their copy number variation in experimental samples when compared to control samples.

Additionally, the method includes performing a normalization factor computation step which uses the qualifier DNA data set, mentioned above, as an input. The normalization factor computation produces as an output a normalization factor, which is used in fold change computation step to quantify the copy number change of certain DNA sequences in the reaction product data set in the experimental samples compared to the control samples. Finally, the method includes the step of performing an evaluation. Other steps may optionally provide for a graphical output to a user.

In the DNA sequence filtering step, the DNA sequence filter separates the DNA sequences in the reaction product data set into a set of data DNA sequences whose data is identified for further analysis, and a set of non-informative or “discard” DNA sequences whose data is to be discarded. The non-informative DNA sequences include sequences whose portion of the array data (if, for example, an array, such a microarray, has been used for copy number detection) seems to lack integrity and therefore may interfere with obtaining proper results. This may happen when, for example, a PCR or other amplification/detection process fails to take hold, and does not properly amplify or accurately detect the material. This may also happen due to human or computer errors.

The qualifier filtering step processes data to identify DNA sequences that may be suitable for use as qualifiers based, at least in part, on their respective amplification activities. Data from DNA sequences identified as qualifiers will serve in later steps as a baseline for comparison/noititalization for statistical analysis; data from undiscarded data DNA sequences will be statistically compared and normalized against data from each of the qualifier DNA sequences. Thus, the set of qualifier DNA sequences generally refers to a subset of the target DNA sequences whose data will be used in comparison and normalization of the target DNA sequences. In this step, a DNA sequence is considered as a candidate qualifier on the conditions that it is well represented in both control and experimental groups, but will disregard a DNA sequence if it is not well represented in either group.

In the global pattern recognition step, data associated with the DNA sequences, including data associated with the qualifier DNA sequences, is passed to the “GPR™” pattern recognition process which performs a statistical analysis of the reaction product dataset and identifies those DNA sequences in the array whose copy numbers have varied in a statistically significant manner in the experimental samples when compared to the control samples.

In one practice, for example, where a dataset is generated by QPCR using a 384-well plate, for each dataset (i.e. column of 384 cycle threshold (CT) values), GPR™ takes data from each data DNA sequence in the set and compares/normalizes it to data from each eligible qualifier in the set in succession to generate a sequence of ΔCT values. An exemplary normalization method involves subtraction, as follows: ΔCT_{Data DNA sequence}=CT_{Data DNA sequence}−CT_{Qualifier}.

Once the ΔCT values for each DNA sequence of interest is generated. For each DNA sequence/qualifier combination, the ΔCT values generated for the control and experimental groups are compared by a two-tailed heteroscedastic (unpaired) Student's T-test and a ‘hit’ is recorded if the p-value from the T-test is below a user-defined threshold alpha (α) value. In one embodiment, alpha is set to 0.05. Other values can be used, and a lower alpha results in a more stringent criterion for marking a “hit.”

The process for implementing the pattern recognition analysis further includes a comparison between the ΔCT values of each data DNA sequence/qualifier combination generated for the control and experimental groups. In one embodiment, each of these combinations is compared by the T-test. The T-test allows the researcher to make a hypothesis as to whether a statistically significant variation occurred between the control data and the experimental data. In this way, the comparisons being made may determine which of the DNA sequence/qualifier combinations appear to have varied in a statistically significant manner. While this exemplary embodiment is described in the context of a Student's T-test using a threshold for the p-values, other statistical hypothesis testing methods known in the art, namely, methods which choose one hypothesis from among a set of hypotheses based on observed sample data and a probabilistic model, can be used. Typically, a binary hypothesis testing method is used. The T-test has at least the benefit of being well known, especially suited to small sample numbers of samples (i.e., fewer than 25), and can be incorporated as a function in Excel® (Microsoft) spread sheet software, or server/web based software (see, http://array.lonza.com/gprl).

GPR™ provides an experiment-independent score for each DNA sequence related to the significance of its statistical change. To this end, each time a significant variation is detected, a hit is recorded for that data DNA sequence. For each data DNA sequence/qualifier combination an indication is recorded as to whether the T-test indicated a statistically significant variation between experimental data and control data (based on the user defined alpha threshold). For each data DNA sequence, the number of hits identified is added and recorded. In this case, for example, the DNA sequence may have only one significant hit. That hit may have occurred at only one DNA sequence qualifier combination. In contrast, for example, another DNA sequence may have three significant hits recorded for it, which occurred at three DNA sequence qualifier combinations.

After recording the hits, GPR™, in one practice, tallies the hits for each DNA sequence with data in the set against all eligible qualifiers with data in the set and ranks the DNA sequences in descending order of number of hits. The experiment-independent DNA sequence score is obtained by dividing the number of hits for a DNA sequence by the total number of eligible qualifiers. For example, a gene having 370 hits as “total hits” out of the 372 qualifier genes, will have a score of about 0.995.

The DNA sequences with the highest scores have changed most significantly in the dataset. DNA sequences whose data failed to pass through the DNA sequence filter are, in one embodiment, assigned −1 hits and a “N.S.” (not significant) in the score column and are ranked alphabetically at the bottom of the output.

The multiple DNA sequence normalization described above makes no pre-supposition about the constant level of a particular qualifier. After filtering the data, GPR™ normalizes data from each eligible DNA sequence against data from every other DNA sequence that is eligible as a qualifier. Since GPR™ considers each DNA sequence individually, it is not as adversely affected by PCR dropouts. Because it employs replicate sampling, GPR™ determines significance based on replicate consistency rather than by the magnitude of fold changes. Thus small fold changes can be detected.

Based on the number of hits assigned to each DNA sequence, one or more “normalizer” can be identified and copy number variations can be determined (e.g. as “fold change”). For example, the GPR™ step typically produces a ranked list of DNA sequences identified as having statistically significant copy number changes. The rankings are based on the score from the GPR™ step. This ranked list is then mapped to a measure of the relative abundance of the DNA sequences identified as having statistically significant copy number changes. The fold change is related to the multiple of increase or decrease of a particular DNA sequence in the experimental samples compared to the control samples.

The fold change may be computed with respect to a “normalizer,” which is selected from the “qualifiers” described above. For example, DNA sequences that are in the “10 best” set based on a measure of their reproducibility of detection across samples can be selected as normalizers. Reproducibility of detection across samples for a given DNA sequence generally refers to a level of uniformity/reproducibility of detection results for that DNA sequence when amplification/detection processes are performed for the DNA sequence for multiple samples.

In particular, the method may compare data from each candidate normalizer DNA sequence with data from each other candidate normalizer DNA sequence to determine a numerical measure for each candidate normalizer DNA sequence. The numerical measure is representative of its reproducibility of detection across samples.

Once one or more normalizers have been identified, the CNVs (e.g., as fold change) can be calculated with respect to one or more normalizers.

D. Creating a CNV Profile

Once the copy number variations of the marker exons have been determined, an ECNV profile can be created accordingly. The ECNV profile comprises information of CNVs of the marker exons. The CNV information of a marker exon includes an increase in copy number, a decrease in copy number, or “no change” in copy number. A statistical analysis may be performed to determine the statistical significance of the copy number variation of a marker exon. A statistical analysis may be performed to determine the statistical significance of the copy number variation of a marker exon.

Preferably, the ECNV profile comprises CNV information of a set of marker exons, wherein the set comprise at least 3, at least 5, at least 10, at least 15, at least 20, at least 25, at least 30, at least 35, at least 40, at least 45, at least 50, at least 60, at least 70, at least 80, at least 90, at least 100, at least 110, at least 120, at least 130, at least 140, at least 150 exons.

Alternatively or in addition, a predetermined “fold change” threshold may also be used to filter the ECNV data, such that the profile identifies exons whose copy number variations are above or below a specific fold change value (e.g., at least about 1.2 fold, at least about 1.3 fold, at least about 1.4 fold, at least about 1.5 fold, at least about 1.6 fold, at least about 1.7 fold, at least about 1.8 fold, at least about 1.9 fold, at least about 2 fold, at least about 2.5 fold, at least about 3 fold, at least about 4 fold, or at least about 5 fold increase or decrease in copy number as compared to a control).

CNV profiles of marker genes or marker loci can be similarly created and used to determine disease risk of a subject.

### 4. Method of Determining Disease Risk Using CNV Profiles

In another aspect, the invention provides a method of determining disease risk in a subject, comprising: (i) creating or providing an ECNV profile of the subject using the method as described herein; and (ii) determining the degree of similarity between the ECNV profile of (i) and one or more reference profiles. The degree of similarity is used to determine the disease risk in the subject (e.g., the onset, progression, severity, or treatment outcome of the disease), and may be expressed e.g., as percent probability of developing a disease. When a subject understands the disease risk, appropriate recommendations can be made to reduce the risk. The recommendations may be a treatment regimen to delay or prevent disease onset or reduce the severity of disease, an exercise regimen, a dietary regimen, or activities that eliminate or reduce environmental risks for the disease.

The reference profile is an ECNV profile comprising ECNV information of one or more exons of the marker genes (e.g., a set of marker exons), and the reference profile has a known correlation with the presence or the absence of the disease, or with the onset, progression, severity, or treatment outcome of the disease. Preferably, the reference profile comprises CNV information of a set of marker exons, wherein the set comprise at least 3, at least 5, at least 10, at least 15, at least 20, at least 25, at least 30, at least 35, at least 40, at least 45, at least 50, at least 60, at least 70, at least 80, at least 90, at least 100, at least 110, at least 120, at least 130, at least 140, at least 150 exons. The set of marker exons of the reference profile do not need to be identical to the set of marker exons that are used to create ECNV profile of the subject whose disease risk is being assessed.

In certain embodiments, a profile database having a plurality of reference profiles are used. For example, the database may have ECNV profiles of healthy subjects, as well as ECNV profiles from subjects who have been diagnosed with the disease. In addition, the disease may be further classified according to the onset, severity, stage, phenotype, treatment outcome, etc. of the disease. Certain characteristics that are representative of a particular disease state may be identified and linked to a representative ECNV profile (e.g., by creating an ECNV from the genomic DNA of a subject who has these characteristics). Optionally, a reference profile that is most similar to the subject's profile may be identified to further characterize the disease risk in the subject.

For example, classification of colorectal cancer typically includes parameters such as type, stage, location, severity, and onset. Several classification systems have been devised to stage the extent of colorectal cancer, including the Dukes' system and the more detailed International Union against Cancer-American Joint Committee on Cancer TNM staging system, which is considered by many in the field to be a more useful staging system (Walter J. Burdette, Cancer: Etiology, Diagnosis, and Treatment (1998)).

The TNM system, which is used for either clinical or pathological staging, is divided into four stages, each of which evaluates the extent of cancer growth with respect to primary tumor (T), regional lymph nodes (N), and distant metastasis (M) (Ajcc Cancer Staging Manual, Irvin D. Fleming et al. eds., 5th ed. 1998). The system focuses on the extent of tumor invasion into the intestinal wall, invasion of adjacent structures, the number of regional lymph nodes that have been affected, and whether distant metastasis has occurred.

T categories describe the extent of spread through the layers that form the wall of the colon and rectum. Tx means no description of the tumor's extent is possible because of incomplete information. Tis means the cancer is in the earliest stage (in situ). It involves only the mucosa, and has not grown beyond the muscularis mucosa (inner muscle layer). T1 means the cancer has grown through the muscularis mucosa and extends into the submucosa. T2 means the cancer has grown through the submucosa and extends into the muscularis propria (thick outer muscle layer). T3 means the cancer has grown through the muscularis propria and into the outermost layers of the colon or rectum but not through them, but has not reached any nearby organs or tissues. T4a means the cancer has grown through the serosa (also known as the visceral peritoneum), the outermost lining of the intestines. T4b means the cancer has grown through the wall of the colon or rectum and is attached to or invades into nearby tissues or organs.

N categories indicate whether or not the cancer has spread to nearby lymph nodes and, if so, how many lymph nodes are involved. Nx means no description of lymph node involvement is possible because of incomplete information. N0 means no cancer in nearby lymph nodes. N1a means cancer cells are found in 1 nearby lymph node. N1b means cancer cells are found in 2 to 3 nearby lymph nodes. N1c means small deposits of cancer cells are found in areas of fat near lymph nodes, but not in the lymph nodes themselves. N2a means cancer cells are found in 4 to 6 nearby lymph nodes. N2b means cancer cells are found in 7 or more nearby lymph nodes.

M categories indicate whether or not the cancer has spread (metastasized) to distant organs, such as the liver, lungs, or distant lymph nodes. M0 means no distant spread is seen. M1a means the cancer has spread to 1 distant organ or set of distant lymph nodes. M1b means the cancer has spread to more than 1 distant organ or set of distant lymph nodes, or it has spread to distant parts of the peritoneum (the lining of the abdominal cavity).

Once a person's T, N, and M categories have been determined, this information is combined in a process called “stage grouping.” Stage 0 (T is, N0, M0) means the cancer is in the earliest stage. It has not grown beyond the inner layer (mucosa) of the colon or rectum. This stage is also known as carcinoma in situ or intramucosal carcinoma. Stage I (T1-T2, N0, M0) means the cancer has grown through the muscularis mucosa into the submucosa (T1) or it may also have grown into the muscularis propria (T2); it has not spread to nearby lymph nodes or distant sites. Stage IIA (T3, N0, M0) means the cancer has grown into the outermost layers of the colon or rectum but has not gone through them. It has not reached nearby organs; it has not yet spread to the nearby lymph nodes or distant sites. Stage IIB (T4a, N0, M0) means the cancer has grown through the wall of the colon or rectum but has not grown into other nearby tissues or organs. It has not yet spread to the nearby lymph nodes or distant sites. Stage IIC (T4b, N0, M0) means the cancer has grown through the wall of the colon or rectum and is attached to or has grown into other nearby tissues or organs; it has not yet spread to the nearby lymph nodes or distant sites. Stage IIIA (T1-T2, N1, M0) means the cancer has grown through the mucosa into the submucosa (T1) or it may also have grown into the muscularis propria (T2). It has spread to 1 to 3 nearby lymph nodes (N1a/N1b) or into areas of fat near the lymph nodes but not the nodes themselves (N1c). It has not spread to distant sites. Stage IIIA (T1, N2a, M0) means the cancer has grown through the mucosa into the submucosa. It has spread to 4 to 6 nearby lymph nodes. It has not spread to distant sites. Stage IIIB (T3-T4a, N1, M0) means the cancer has grown into the outermost layers of the colon or rectum (T3) or through the visceral peritoneum (T4a) but has not reached nearby organs. It has spread to 1 to 3 nearby lymph nodes (N1a/N1b) or into areas of fat near the lymph nodes but not the nodes themselves (Nic). It has not spread to distant sites. Stage IIIB (T2-T3, N2a, M0) means the cancer has grown into the muscularis propria (T2) or into the outermost layers of the colon or rectum (T3). It has spread to 4 to 6 nearby lymph nodes. It has not spread to distant sites. Stage IIIB (T1-T2, N2b, M0) means the cancer has grown through the mucosa into the submucosa (T1) or it may also have grown into the muscularis propria (T2). It has spread to 7 or more nearby lymph nodes. It has not spread to distant sites. Stage IIIC (T4a, N2a, M0) means the cancer has grown through the wall of the colon or rectum (including the visceral peritoneum) but has not reached nearby organs. It has spread to 4 to 6 nearby lymph nodes. It has not spread to distant sites. Stage IIIC (T3-T4a, N2b, M0) means the cancer has grown into the outermost layers of the colon or rectum (T3) or through the visceral peritoneum (T4a) but has not reached nearby organs. It has spread to 7 or more nearby lymph nodes. It has not spread to distant sites. Stage IIIC (T4b, N1-N2, M0) means the cancer has grown through the wall of the colon or rectum and is attached to or has grown into other nearby tissues or organs. It has spread to 1 or more nearby lymph nodes or into areas of fat near the lymph nodes. It has not spread to distant sites. Stage IVA (any T, Any N, M1a) means the cancer may or may not have grown through the wall of the colon or rectum, and it may or may not have spread to nearby lymph nodes. It has spread to 1 distant organ (such as the liver or lung) or set of lymph nodes. Stage IVB (any T, Any N, M1b) means the cancer may or may not have grown through the wall of the colon or rectum, and it may or may not have spread to nearby lymph nodes. It has spread to more than 1 distant organ (such as the liver or lung) or set of lymph nodes, or it has spread to distant parts of the peritoneum (the lining of the abdominal cavity).

The Dukes staging system provides four CRC classifications: Dukes A (invasion into but not through the bowel wall); Dukes B (invasion through the bowel wall but not involving lymph nodes); Dukes C (involvement of lymph nodes); and Dukes D (widespread metastases).

The Astler and Coller staging system provides the following CRC classifications: Stage A (limited to mucosa); Stage B1 (extending into muscularis propria but not penetrating through it; nodes not involved); Stage B2 (penetrating through muscularis propria; nodes not involved); Stage C1 (extending into muscularis propria but not penetrating through it; nodes involved); Stage C2 (penetrating through muscularis propria, nodes involved) and Stage D (distant metastatic spread).

Accordingly, reference ECNV profiles may be created using genomic DNA samples of CRC patients in which the onset, progression, or severity of CRC has been classified, for example, using one of the staging system described above.

Reference ECNV profiles of other diseases (such as autoimmune diseases and neurological diseases) can be similarly created according to ECNV profiles of subject whose disease stage/disease classification is known. For example, Alzheimer's Disease can be classified as follows: Stage 1 (no impairment); Stage 2 (very mild decline); Stage 3 (mild decline); Stage 4: (moderate decline; mild or early stage); Stage 5: moderately severe decline; moderate or mid-stage); Stage 6: severe decline; moderately severe or mid-stage); and Stage 7: very severe decline; severe or late stage).

In addition, it is possible that the ECNV profiles from different patients are different even though the patients have the same classification. In that case, “landmark” reference profiles that are particularly representative of a particular stage or classification may be created from a pool of ECNV profiles. The landmark reference profiles may comprise, e.g., exons that appear with high frequencies across different individual profiles. The landmark reference profiles may also combine exons from two or more individual profiles.

The disease risk in a subject (e.g., the onset, progression, severity, or treatment outcome of the disease) is assessed according to the degree of similarity between the subject and one or more reference profiles. The disease risk may be expressed e.g., as percent probability of developing a disease based on similarity score.

Once the assessment of disease risk is made, appropriate recommendations can be made according to the assessment. For example, in the case of a strong correlation between an ECNV profile and a high risk for a particular disease, detection of the ECNV profile may justify a suitable treatment regimen (e.g., therapeutic treatment or preventative treatment), or at least the institution of regular monitoring. In the case of a weaker, but still statistically significant correlation between an ECNV profile and a high risk for a particular disease, immediate therapeutic intervention or monitoring may not be justified. Nevertheless, the subject can be motivated to begin simple life-style changes (e.g., a diet regimen, an exercise regimen, or activities that eliminate or reduce environmental risks for the disease) that can be accomplished at little cost to the subject but confer potential benefits in reducing the risk of conditions to which the subject may have increased susceptibility.

Reference profiles comprising CNV information of marker genes or marker loci can be similarly created and used to determine disease risk of a subject.

### 5. Kits

In another aspect, the invention provides kits for disease risk assessment as described herein. The kits generally include reagents and instructions and optionally controls for performing the method as described herein. For example, the kits can include polynucleotide primers that selectively hybridize to marker exons, marker genes, or marker loci (such as primer pairs to perform the amplification reactions to determine copy number variations in comparison to a control). For example, a kit can contain any one or more primer sets forth in Tables 2-5, and optionally ancillary reagents. The kit can include suitable controls to be used as standards and/or instruction for preparing standard curves for the same purpose.

### 6. Colorectal Cancer Risk Assessment

In another aspect, the invention provides a method of generating an ECNV profile of a subject that is informative of colorectal cancer risk, comprising: (a) providing a genomic DNA sample obtained from the subject; (b) determining the copy number variations of a set of marker exons in the genomic DNA sample by comparing the copy number of each of the marker exons in the genomic DNA sample with the copy number of the corresponding exon in a control, wherein the set of marker exons comprise at least one exon from each of the marker genes listed in Table 1; (c) creating an ECNV profile based on the copy number variations of the set of marker exons. The ECNV profile is informative of the onset, progression, severity, or treatment outcome of colorectal cancer in the subject.

Using the method as described herein, the inventor has identified marker genes and marker exons that can be used to assess an individual's risk for colorectal cancer. In particular, Table 1 provides 25 marker genes (the sequences of which are incorporated by reference) that are believed to be associated with CRC. These 25 marker genes were selected based on published sequence, structural, or functional studies that indicate a potential link between the genes and CRC risk. Particularly interesting marker genes were those that had been identified as being associated with CRC by genome-wide association studies (GWAS) but with no known mutations that account for the CRC risk.

TABLE 1
Colorectal Cancer Marker Genes

| No. | Gene Name | NCBI Entrez GeneID |
|---|---|---|
| 1 | BMPR1A | 657 |
| 2 | CLN5 | 1203 |
| 3 | EDNRB | 1910 |
| 4 | FBXL3 | 26224 |
| 5 | IRG1 | 730249 |
| 6 | KCTD12 | 115207 |
| 7 | MYCBP2 | 23077 |
| 8 | PIK3CA | 5290 |
| 9 | PTEN | 5728 |
| 10 | PTGS2 | 5743 |
| 11 | SLAIN1 | 122060 |
| 12 | SMAD4 | 4089 |
| 13 | STK11 | 6794 |
| 14 | SCEL | 8796 |
| 15 | APC | 324 |
| 16 | CTNNB1 | 1499 |
| 17 | DCC | 1630 |
| 18 | KRAS | 3845 |
| 19 | MLH1 | 4292 |
| 20 | MSH2 | 4436 |
| 21 | MTOR | 2475 |
| 22 | MUTYH | 4595 |
| 23 | PMS2 | 5395 |
| 24 | PPP2R1A | 5518 |
| 25 | TP53 | 7157 |

In another aspect, the invention provides a method of determining colorectal cancer risk in a subject, comprising: (i) creating or providing an ECNV profile of the subject according to the method as described herein; (ii) determining the degree of similarity between the ECNV profile of (i) and one or more reference profiles. The degree of similarity is used to determine risk of CRC in the subject (e.g., the onset, progression, severity, or treatment outcome of CRC), and may be expressed e.g., as percent probability of developing CRC.

In certain embodiments, the set of marker exons used to create a subject's ECNV profile comprise at least one exon from each of the marker genes listed in Table 1.

In certain embodiments, the set of marker exons comprise the following exons: CTNNB1 exon 01.1, SCEL exon 01, SLAIN1 exon 01, MSH2 exon 13.1, SMAD4 exon 09, MTOR exon 15.1, and MUTYH exon 09.1.

In certain embodiments, a decrease of the copy numbers of one or more exons selected from: CTNNB1 exon 01.1, SCEL exon 01, SLAIN1 exon 01, MSH2 exon 13.1, SMAD4 exon 09, MTOR exon 15.1, or MUTYH exon 09.1 is indicative of an increased risk of developing metastatic colorectal cancer, or having an early onset of colorectal cancer in the subject.

In certain embodiments, the set of marker exons comprise the following exons: PPP2R1A exon 06.1, PMS2 exon 13.1, PPP2R1A exon 04.1, CTNNB1 exon 13.1, MSH6 exon 08.1, MTOR exon 10.1, PPP2R1A exon 07.2, PMS2 exon 14.2, MLH1 exon 08.1, DCC exon 09.1, MLH1 exon 01.2, IRG1 exon 05, KRAS exon 04.2, MUTYH exon 03.2, STK11 exon 02, APC exon 04.2, MSH2 exon 12.2, PPP2R1A exon 05.2, APC exon 10.2, MTOR exon 48.2, MTOR exon 50.1, MLH1 exon 15.1, PMS2 exon 04.1, PMS2 exon 06.2, and MTOR exon 06.2.

In certain embodiments, an increase of the copy numbers of one or more exons selected from PPP2R1A exon 06.1, PMS2 exon 13.1, PPP2R1A exon 04.1, CTNNB1 exon 13.1, MSH6 exon 08.1, MTOR exon 10.1, PPP2R1A exon 07.2, PMS2 exon 14.2, MLH1 exon 08.1, DCC exon 09.1, MLH1 exon 01.2, IRG1 exon 05, KRAS exon 04.2, MUTYH exon 03.2, STK11 exon 02, APC exon 04.2, MSH2 exon 12.2, PPP2R1A exon 05.2, APC exon 10.2, MTOR exon 48.2, MTOR exon 50.1, MLH1 exon 15.1, PMS2 exon 04.1, PMS2 exon 06.2, or MTOR exon 06.2 is indicative of an increased risk of developing non-metastatic colorectal cancer in the subject.

In certain embodiments, the set of marker exons comprise the following exons: CTNNB1 exon 01.1, SCEL exon 01, SLAIN1 exon 01, MSH2 exon 13.1, MUTYHexon 10.2, SMAD4 exon 09, MTOR exon 15.1, MUTYH exon 09.1, PPP2R1A exon 06.1, PMS2 exon 13.1, PPP2R1A exon 04.1, CTNNB1 exon 13.1, MSH6 exon 08.1, MTOR exon 10.1, PPP2R1A exon 07.2, PMS2 exon 14.2, MLH1 exon 08.1, DCC exon 09.1, MLH1 exon 01.2, IRG1 exon 05, KRAS exon 04.2, MUTYH exon 03.2, STK11 exon 02, APC exon 04.2, MSH2 exon 12.2, PPP2R1A exon 05.2, APC exon 10.2, MTOR exon 48.2, MTOR exon 50.1, MLH1 exon 15.1, PMS2 exon 04.1, PMS2 exon 06.2, MTOR exon 06.2., PPP2R1A exon 08.2, PIK3CA exon 04, SMAD4 exon 10, FBXL3 exon 02, BMPR1A exon 04, PMS2 exon 15.2, MTOR exon 03.1, TP53 exon 04.2, SMAD4 exon 02, and MYCBP2 exon 84.

In certain embodiments, the set of marker exons comprise the exons listed in Table 2.

The reference profile is an ECNV profile comprising ECNV information of one or more exons of the marker genes (e.g., a set of marker exons), and the reference profile has a known correlation with the presence or the absence of CRC, or with the onset, progression, severity, or treatment outcome of CRC (e.g., or a particular classification of CRC). The classification of CRC stages is described above. Preferably, the reference profile comprises CNV information of a set of marker exons, wherein the set comprise at least 3, at least 5, at least 10, at least 15, at least 20, at least 25, at least 30, at least 35, at least 40, at least 45, at least 50, at least 60, at least 70, at least 80, at least 90, at least 100, at least 110, at least 120, at least 130, at least 140, at least 150 exons.

A profile database having a plurality of reference profiles may be used. The database may have a collection of ECNV profiles that are representative of the presence or absence of CRC, or a particular stage of CRC, as well as ECNV profiles that correlate with other characteristics of CRC, such as onset, progression, severity, or treatment outcome of CRC. Optionally, a reference profile that is most similar to the subject's profile may be identified to further characterize the risk of CRC in the subject.

In another aspect, the invention provides a kit for generating an ECNV profile of a subject that is informative of colorectal cancer risk, comprising: (a) a set of polynucleotide primers for detecting the copy numbers of a set of marker exons in the genomic DNA of the subject, wherein the set of marker exons comprise at least one exon from each of the genes listed in Table 1, and wherein for each marker exon, at least one primer selectively hybridizes to the exon; and (b) instructions for creating an ECNV profile of the genomic DNA of the subject according to method described herein.

In certain embodiments, the kit comprises polynucleotide primers for detecting the copy numbers of the following marker exons: CTNNB1 exon 01.1, SCEL exon 01, SLAIN1 exon 01, MSH2 exon 13.1, MUTYHexon 10.2, SMAD4 exon 09, MTOR exon 15.1, MUTYH exon 09.1, PPP2R1A exon 06.1, PMS2 exon 13.1, PPP2R1A exon 04.1, CTNNB1 exon 13.1, MSH6 exon 08.1, MTOR exon 10.1, PPP2R1A exon 07.2, PMS2 exon 14.2, MLH1 exon 08.1, DCC exon 09.1, MLH1 exon 01.2, IRG1 exon 05, KRAS exon 04.2, MUTYH exon 03.2, STK11 exon 02, APC exon 04.2, MSH2 exon 12.2, PPP2R1A exon 05.2, APC exon 10.2, MTOR exon 48.2, MTOR exon 50.1, MLH1 exon 15.1, PMS2 exon 04.1, PMS2 exon 06.2, MTOR exon 06.2., PPP2R1A exon 08.2, PIK3CA exon 04, SMAD4 exon 10, FBXL3 exon O₂, BMPR1A exon 04, PMS2 exon 15.2, MTOR exon 03.1, TP53 exon 04.2, SMAD4 exon 02, and MYCBP2 exon 84.

In certain embodiments, the kit comprises polynucleotide primers for detecting the copy numbers of the marker exons listed in Table 2. In certain embodiments, the kit comprises polynucleotide primers listed in Table 2.

### 7. Autoimmune Diseases Risk Assessment

In another aspect, the invention provides a method of generating an ECNV profile of a subject that is informative of autoimmune disease risk, comprising: (a) providing a genomic DNA sample obtained from the subject; (b) determining the copy number variations of a set of marker exons in the genomic DNA sample by comparing the copy number of each of the marker exons in the genomic DNA sample with the copy number of the corresponding exon in a control, wherein the set of marker exons comprise at least one exon from each of the following marker genes: Mid1, Mid2, and PPP2R1A; (c) creating an ECNV profile based on the copy number variations of the set of marker exons. The ECNV profile is informative of the onset, progression, severity, or treatment outcome of autoimmune disease in the subject.

Using the method as described herein, the inventor has identified marker genes and marker exons that can be used to assess an individual's risk for autoimmune disease. In particular, Mid1 (NCBI Entrez Gene ID 17318), Mid2 (NCBI Entrez Gene ID 23947), and PPP2R1A (NCBI Entrez Gene ID 5518), the sequences of which are incorporated by reference, are identified as marker genes that are associated with Systemic lupus erythematosus (SLE or lupus).

In another aspect, the invention provides a method of determining autoimmune risk in a subject, comprising: (i) creating or providing an ECNV profile of the subject according to the method as described herein; (ii) determining the degree of similarity between the ECNV profile of (i) and one or more reference profiles. The degree of similarity is used to determine risk of autoimmune disease in the subject (e.g., the onset, progression, severity, or treatment outcome of autoimmune disease), and may be expressed e.g., as percent probability of developing autoimmune disease.

In certain embodiments, the set of marker exons used to create subject's ECNV profile comprise at least one exon from each of the following marker genes: Mid 1, Mid2, and PPP2R1A.

In certain embodiments, the set of marker exons comprise the following exons: Mid1 exon 2, Mid1 exon 4, Mid1 exon 8, and Mid1 exon 9.

In certain embodiments, the set of marker exons comprise the following exons: PPP2R1A exon 15.1, PPP2R1A exon 10.1, PPP2R1A exon 06.1, PPP2R1A exon 01.2, PPP2R1A exon 09.2, PPP2R1A exon 11.1, PPP2R1A exon 07.2, MID2 exon 05.2, MID1 exon 07.1, MID1 01.2, and MID2 exon 02.1.

In certain embodiments, the set of marker exons comprise the following exons: PPP2R1A exon 01.2, PPP2R1A exon 08.R, PPP2R1A exon 09.2, PPP2R1A exon 10.1, PPP2R1A exon 11.1, PPP2R1A exon 07.2, MID1 exon 03.1, MID1 exon 02A.1, MID2 exon 03.1, MID2 exon 02.1, and MID2 exon 07.2.

In certain embodiments, the set of marker exons comprise the following exons: PPP2R1A exon 01.2, PPP2R1A exon 05.2, PPP2R1A exon 10.1, PPP2R1A exon 15.1, PPP2R1A exon 03.2, PPP2R1A exon 06.1, PPP2R1A exon 08.R, PPP2R1A exon 11.1, PPP2R1A exon 07.2, PPP2R1A exon 09.2, MID1 exon 09.2, MID1 exon 03.1, MID1 exon 04.1, and MID1 exon 02A.1.

In certain embodiments, the set of marker exons comprise the following exons: PPP2R1A exon 12.2, PPP2R1A exon 01.2, PPP2R1A exon 06.1, MID1 exon 06.2, MID1 exon 02A.1 MID2 exon 02.1, and MID2 exon 07.2.

In certain embodiments, the set of marker exons comprise the exons listed in Table 3.

In another aspect, the invention provides a kit for generating an ECNV profile of a subject that is informative of autoimmune disease, comprising: (a) a set of polynucleotide primers for detecting the copy numbers of a set of marker exons in the genomic DNA of said subject, wherein said set of marker exons comprise at least one exon from each of the following marker genes: Mid1, Mid2, and PPP2R1A, and wherein for each marker exon, at least one primer selectively hybridizes to said exon; and (b) instructions for creating an ECNV profile of the genomic DNA of the subject according to method described herein.

In certain embodiments, the kit comprises polynucleotide primers for detecting the copy numbers of the marker exons listed in Table 3. In certain embodiments, the kit comprises polynucleotide primers listed in Table 3.

In another aspect, the invention provides a method of generating an ECNV profile of a subject that is informative of autoimmune disease risk, comprising: (a) providing a genomic DNA sample obtained from the subject; (b) determining the copy number variations of a set of marker exons in the genomic DNA sample by comparing the copy number of each of the marker exons in the genomic DNA sample with the copy number of the corresponding exon in a control, wherein the set of marker exons comprise at least one exon from each of the following marker genes: ATG16L1, CYLD, IL23R, NOD2, and SNX20; (c) creating an ECNV profile based on the copy number variations of the set of marker exons. The ECNV profile is informative of the onset, progression, severity, or treatment outcome of autoimmune disease in the subject.

Using the method as described herein, the inventor has identified marker genes and marker exons that can be used to assess an individual's risk for autoimmune disease. In particular, ATG16L1 (NCBI Entrez Gene ID 55054), CYLD (NCBI Entrez Gene ID 1540), IL23R(NCBI Entrez Gene ID 149233), NOD2 (NCBI Entrez Gene ID 64127), and SNX20 (NCBI Entrez Gene ID 124460), the sequences of which are incorporated by reference, are identified as marker genes that are associated with Crohn's disease.

In another aspect, the invention provides a method of determining autoimmune risk in a subject, comprising: (i) creating or providing an ECNV profile of the subject according to the method as described herein; (ii) determining the degree of similarity between the ECNV profile of (i) and one or more reference profiles. The degree of similarity is used to determine risk of autoimmune disease in the subject (e.g., the onset, progression, severity, or treatment outcome of autoimmune disease), and may be expressed e.g., as percent probability of developing autoimmune disease.

In certain embodiments, the marker gene also comprises Mid1, Mid2, and PPP2R1A.

In certain embodiments, the set of marker exons used to create subject's ECNV profile comprise at least one exon from each of the following marker genes: ATG16L1, CYLD, IL23R, NOD2, and SNX20.

In certain embodiments, the set of marker exons comprise the following exons: ATG16L1 exon 02.1, SNX20 exon 02.1, CYLD exon 03.2, SNX20 exon 03.1, SNX20 exon 04.2, and CYLD exon 02.1.

In certain embodiments, the set of marker exons comprise the following exons: PPP2R1A exon 12.2, PPP2R1A exon 04.1, SNX20 exon 02.1, ATG16L1 exon 02.1, MID1 exon 02A.1, NOD2 exon 01.1, SNX20 exon 03.1, CYLD exon 03.2, and SNX20 exon 04.2.

In certain embodiments, the set of marker exons comprise the following exons: ATG16L1 exon 02.1, SNX20 exon 02.1, CYLD exon 03.2, NOD2 exon 01.1, SNX20 exon 03.1, SNX20 exon 04.2, and CYLD exon 02.1.

In certain embodiments, the set of marker exons comprise the following exons: PPP2R1A exon 01.2, PPP2R1A exon 06.1, PPP2R1A exon 09.2, PPP2R1A exon 08.R, PPP2R1A exon 07.2, NOD2 exon 11.1, MID1 exon O₂A.1, MID2 exon 02.1, ATG16L1 exon 02.1, SNX20 exon 02.1, MID2 exon 07.2, CYLD exon 03.2, SNX20 exon 04.2, NOD2 exon 01.1, SNX20 exon 03.1, and CYLD exon 02.1.

In certain embodiments, the set of marker exons comprise the following exons: CYLD exon 03.2, SNX20 exon 02.1, SNX20 exon 04.2, SNX20 exon 03.1, and CYLD exon 02.1.

In certain embodiments, the set of marker exons comprise the following exons: SNX20 exon 03.1, CYLD exon 02.1, and SNX20 exon 04.2.

In another aspect, the invention provides a kit for generating an ECNV profile of a subject that is informative of autoimmune disease, comprising: (a) a set of polynucleotide primers for detecting the copy numbers of a set of marker exons in the genomic DNA of said subject, wherein said set of marker exons comprise at least one exon from each of the following marker genes: ATG16L1, CYLD, IL23R, NOD2, and SNX20, and wherein for each marker exon, at least one primer selectively hybridizes to said exon; and (b) instructions for creating an ECNV profile of the genomic DNA of the subject according to method described herein. In certain embodiments, the marker gene also comprises Mid1, Mid2, and PPP2R1A.

In certain embodiments, the kit comprises polynucleotide primers for detecting the copy numbers of the marker exons listed in Table 4. In certain embodiments, the kit comprises polynucleotide primers listed in Table 4.

The reference profile is an ECNV profile comprising ECNV information of one or more exons of the marker genes (e.g., a set of marker exons), and the reference profile has a known correlation with the presence or the absence of the autoimmune disease (such as SLE or Crohn's disease), or with the onset, progression, severity, or treatment outcome of the autoimmune disease. Preferably, the reference profile comprises CNV information of a set of marker exons, wherein the set comprise at least 3, at least 5, at least 10, at least 15, at least 20, at least 25, at least 30, at least 35, at least 40, at least 45, at least 50, at least 60, at least 70, at least 80, at least 90, at least 100, at least 110, at least 120, at least 130, at least 140, at least 150 exons.

A profile database having a plurality of reference profiles may be used. Optionally, a reference profile that is most similar to the subject's profile may be identified to further characterize the risk of autoimmune disease in the subject.

The methods and kits described herein can be used to assessing risk for an autoimmune disease. The autoimmune disease can be, for example, a B-cell mediated disease or a T-cell mediated disease. Autoimmune disease, and the pathological mechanisms underlying many such diseases, are known in the art and include, skin diseases such as psoriasis and dermatitis (e.g., atopic dermatitis); systemic scleroderma and sclerosis; inflammatory bowel disease (e.g., Crohn's disease and ulcerative colitis); respiratory distress syndrome (including adult respiratory distress syndrome; ARDS); dermatitis; meningitis; encephalitis; uveitis; colitis; glomerulonephritis; allergic conditions such as eczema and asthma and other conditions involving infiltration of T cells and chronic inflammatory responses; atherosclerosis; leukocyte adhesion deficiency; rheumatoid arthritis; systemic lupus erythematosus (SLE); diabetes mellitus (e.g. Type I diabetes mellitus or insulin dependent diabetes mellitis); multiple sclerosis; Reynaud's syndrome; autoimmune thyroiditis; allergic encephalomyelitis; Sjorgen's syndrome; juvenile onset diabetes; and immune responses associated with acute and delayed hypersensitivity mediated by cytokines and T-lymphocytes typically found in tuberculosis, sarcoidosis, polymyositis, granulomatosis and vasculitis; pernicious anemia (Addison's disease); diseases involving leukocyte diapedesis; central nervous system (CNS) inflammatory disorder; multiple organ injury syndrome; hemolytic anemia (including, but not limited to cryoglobinemia or Coombs positive anemia); myasthenia gravis; antigen-antibody complex mediated diseases; anti-glomerular basement membrane disease; antiphospholipid syndrome; allergic neuritis; Graves' disease; Lambert-Eaton myasthenic syndrome; pemphigoid bullous; pemphigus; autoimmune polyendocrinopathies; Reiter's disease; stiff-man syndrome; Behcet disease; giant cell arteritis; immune complex nephritis; IgA nephropathy; IgM polyneuropathies; immune thrombocytopenic purpura (ITP) or autoimmune thrombocytopenia etc.

### 8. Neurological Diseases Risk Assessment

In another aspect, the invention provides a method of generating an ECNV profile of a subject that is informative of neurological disease risk, comprising: (a) providing a genomic DNA sample obtained from the subject; (b) determining the copy number variations of a set of marker exons in the genomic DNA sample by comparing the copy number of each of the marker exons in the genomic DNA sample with the copy number of the corresponding exon in a control, wherein the set of marker exons comprise at least one exon from each of the following marker genes: APOE, APP, PSEN1, PSEN2, and PSENEN; (c) creating an ECNV profile based on the copy number variations of the set of marker exons. The ECNV profile is informative of the onset, progression, severity, or treatment outcome of neurological disease in the subject.

Using the method as described herein, the inventor has identified marker genes and marker exons that can be used to assess an individual's risk for neurological disease. In particular, APOE (NCBI Entrez Gene ID 348), APP (NCBI Entrez Gene ID 351), PSEN1 (NCBI Entrez Gene ID 5663), PSEN2 (NCBI Entrez Gene ID 5664), and PSENEN (NCBI Entrez Gene ID 55851), the sequences of which are incorporated by reference, are identified as marker genes that are associated with Alzheimer's disease.

In another aspect, the invention provides a method of determining autoimmune risk in a subject, comprising: (i) creating or providing an ECNV profile of the subject according to the method as described herein; (ii) determining the degree of similarity between the ECNV profile of (i) and one or more reference profiles. The degree of similarity is used to determine risk of neurological disease in the subject (e.g., the onset, progression, severity, or treatment outcome of neurological disease), and may be expressed e.g., as percent probability of developing neurological disease.

In certain embodiments, the set of marker exons used to create subject's ECNV profile comprise at least one exon from each of the following marker genes: APOE, APP, PSEN1, PSEN2, and PSENEN.

In certain embodiments, the set of marker exons comprise the following exons: APOE exon 02.1, PSEN exon 06.1, and PSEN exon 03.2.

The reference profile is an ECNV profile comprising ECNV information of one or more exons of the marker genes (e.g., a set of marker exons), and the reference profile has a known correlation with the presence or the absence of the neurological disease (such as Alzheimer's disease), or with the onset, progression, severity, or treatment outcome of the neurological disease. Preferably, the reference profile comprises CNV information of a set of marker exons, wherein the set comprise at least 3, at least 5, at least 10, at least 15, at least 20, at least 25, at least 30, at least 35, at least 40, at least 45, at least 50, at least 60, at least 70, at least 80, at least 90, at least 100, at least 110, at least 120, at least 130, at least 140, at least 150 exons.

A profile database having a plurality of reference profiles may be used. Optionally, a reference profile that is most similar to the subject's profile may be identified to further characterize the risk of neurological disease in the subject.

In another aspect, the invention provides a kit for generating an ECNV profile of a subject that is informative of neurological disease, comprising: (a) a set of polynucleotide primers for detecting the copy numbers of a set of marker exons in the genomic DNA of said subject, wherein said set of marker exons comprise at least one exon from each of the following marker genes: APOE, APP, PSEN1, PSEN2, and PSENEN, and wherein for each marker exon, at least one primer selectively hybridizes to said exon; and (b) instructions for creating an ECNV profile of the genomic DNA of the subject according to method described herein.

In certain embodiments, the kit comprises polynucleotide primers for detecting the copy numbers of the marker exons listed in Table 5. In certain embodiments, the kit comprises polynucleotide primers listed in Table 5.

The methods described herein can be used to assess the risk of a neurological disease (e.g., a neurodegenerative disorder or disturbance) in a subject.

Neurological diseases are a large group of diseases characterized by changes in normal neuronal function, leading in the majority of cases to neuronal dysfunction and even cell death. Generally, neurological diseases affect the central nervous system (e.g., brain, brainstem and cerebellum), the peripheral nervous system (peripheral nerves including cranial nerves) and/or the autonomic nervous system (parts of which are located in both central and peripheral nervous system). Neurological diseases include, for example, neurodegenerative disorders (e.g., Parkinson's disease or Alzheimer's disease), behavioral disorders or neuro-psychiatric disorders (e.g., bipolar affective disorder or unipolar affective disorder or schizophrenia) and myelin-related disorders (e,g., multiple sclerosis).

Neurological diseases for which disease risk can be determined using the method of the invention include, for example, Alzheimer's disease; Parkinson's disease; motor neuron diseases such as amyotrophic lateral sclerosis (ALS), Huntington's disease and syringomyelia; ataxias, dementias; chorea; dystonia; dyslinesia; encephalomyelopathy; parenchymatous cerebellar degeneration; Kennedy disease; Down syndrome; progressive supernuclear palsy; DRPLA, stroke or other ischemic injuries; thoracic outlet syndrome, trauma; electrical brain injuries; decompression brain injuries; AIDS dementia; multiple sclerosis; epilepsy; concussive or penetrating injuries of the brain or spinal cord; peripheral neuropathy; brain injuries due to exposure of military hazards such as blast over-pressure, ionizing radiation, and genetic neurological conditions. A “genetic neurological condition” refers to a neurological condition, or a predisposition to it, that is caused at least in part by or correlated with a specific gene or mutation within that gene; for example, a genetic neurological condition can be caused by or correlated with more than one specific gene. Examples of genetic neurological conditions include, but are not limited to, Alzheimer's disease, Huntington's disease, spinal and bulbar muscular atrophy, fragile X syndrome, FRAXE mental retardation, myotonic dystrophy, spinocerebellar ataxia type 1, dentatorubral-pallidoluysian atrophy, and Machado-Joseph disease. Additional neurological diseases are provided below.

The cellular events observed in a neurological disease often manifest as a behavioral change (e.g., deterioration of thinking and/or memory) and/or a movement change (e.g., tremor, ataxia, postural change and/or rigidity). Examples of neurological diseases include, for example, Alzheimer's disease, amyotrophic lateral sclerosis, ataxia (e.g., spinocerebellar ataxia or Friedreich's Ataxia), Creutzfeldt-Jakob Disease, a polyglutamine disease (e.g., Huntington's disease or spinal bulbar muscular atrophy), Hallervorden-Spatz disease, idiopathic torsion disease, Lewy body disease, multiple system atrophy, neuroanthocytosis syndrome, olivopontocerebellar atrophy, Parkinson's disease, Pelizaeus-Merzbacher disease, Pick's disease, progressive supranuclear palsy, syringomyelia, torticollis, spinal muscular atrophy or a trinucleotide repeat disease (e.g., Fragile X Syndrome).

Alternatively, the neurological disease can be associated with aberrant deposition or tau and/or hyperphosphorylation of tau. For example, the neurological disease is selected from the group consisting of frontotemporal dementia, corticobasal degeneration, progressive supranuclear palsy, a Parkinson's disease or an Alzheimer's disease. In one embodiment, the methods and biomarkers of the invention are useful for assessing risk of a neurological disorder selected from the group consisting of Parkinson's disease and Alzheimer's disease.

Alternatively, a neurological disease can be a dementing neurological disorder. A “dementing neurological disorder” refers to a disease that is characterized by chronic loss of mental capacity, particularly progressive deterioration of thinking, memory, behavior, personality and motor function, and may also be associated with psychological symptoms such as depression and apathy. Preferably, a dementing neurological disorder is not caused by, for example, a stroke, an infection or a head trauma. Examples of a dementing neurological disorder include, for example, an Alzheimer's disease, vascular dementia, dementia with Lewy bodies, frontotemporal dementia and prion disease, amongst others.

Preferably, the dementing neurological disorder is Alzheimer's disease. Alzheimer's disease refers to a neurological disorder characterized by progressive impairments in memory, behavior, language and/or visuo-spatial skills. Pathologically, an Alzheimer's disease is characterized by neuronal loss, gliosis, neurofibrillary tangles, senile plaques, Hirano bodies, granulovacuolar degeneration of neurons, amyloid angiopathy and/or acetylcholine deficiency. The term “an Alzheimer's disease” shall be taken to include early onset Alzheimer's disease (e.g., with an onset earlier than the sixth decade of life), a late onset Alzheimer's disease (e.g., with an onset later then, or in, the sixth decade of life) and a juvenile onset Alzheimer's disease.

In certain embodiments, the behavioral disorder or psychiatric disorder for which risk is assessed according to the methods of the invention is a bipolar affective disorder. The term “a bipolar affective disorder” shall be taken to include all forms of bipolar affective disorder, including bipolar I disorder (severe bipolar affective (mood) disorder), schizoaffective disorder, bipolar II disorder or unipolar disorder.

In certain other embodiments, the behavioral disorder or psychiatric disorder is schizophrenia. In a further embodiment, the neurological disorder is a myelin-associated disorder. In other embodiments, myelin-associated disorders are those disorders characterized by a reduction in the amount of or the production of scars or scleroses associated with myelin associated with or surrounding neuronal fibers. In yet other embodiments, the myelin-associated disorder is multiple sclerosis.

### EXEMPLIFICATION

The invention now being generally described, it will be more readily understood by reference to the following examples, which are included merely for purposes of illustration of certain aspects and embodiments of the present invention, and are not intended to limit the invention.

### Example 1

### Exon Copy Number Variation (ECNV) Profiling for Colorectal Cancer Risk Assessment

In this example, ECNV profiles for colorectal cancer risk assessment were created using genomic DNA samples from non-cancerous cells. The creation of ECNV profiles facilitates the detection of genomic aberrations and results in an improvement in disease association studies.

1. Introduction

Genome-wide association studies (GWAS) enable the evaluation of many genetic markers across multiple genomes to discover variations associated with a disease. Once identified, these markers may serve as useful indicators to help develop and/or direct the course of medical treatments and may have the potential to predict the risk of disease onset in humans. Additionally, physical quantitative traits (phenotypes) can be used as genetic markers in a similar manner helping to define genetic regions (Quantitative Trait Loci—QTL) associated with disease.

One such large GWAS was conducted by the International HapMap Project (http://hapmap.ncbi.nlm.nih.gov/), initiated in 2005, which generated analytical tools and data to accelerate the discovery of genetic regions that contribute to the onset of disease. The basic method involves the determination of genetic variations called Single Nucleotide Polymorphisms (SNP's) for each participant's DNA. If a SNP or set of SNP's occurs significantly more frequently in individuals with the disease being studied, compared to those without the disease, then the SNP(s) is said to be associated with the disease. Since the genetic location of the SNP's is known, the region of the DNA near the SNP is likely to contain a gene(s) related to the disease. Thus, GWAS provide a means to sift through thousands of genes (as genetic regions) to home-in on regions most likely to yield insight into the cause of the disease.

In addition to SNP's, researchers have recently identified differences in the genome characterized by copy number variations (CNV's). A CNV defines a segment of DNA in which there are differences in the absolute numbers of genetic regions when comparing the genomes of individuals. CNV's can result in a change in the numbers of a particular gene or set of genes and may positively correlate with expression, commonly referred to as a dosage affect. These gene dosage changes may be the cause of a large amount of variability in phenotypic traits, disease susceptibility, and behavioral traits. CNV's may be inherited or caused by a mutational event. Like SNP's, CNV's can be related to the onset and severity of disease. Of particular interest is the fact that CNV's are often found in cancerous tissues. However, CNV's are relatively common and widespread in the human genome contributing to the challenge of defining CNV-based mutations that are associated with disease.

Detection of SNP's and CNV's include techniques such as Fluorescent In Situ Hybridization (FISH), comparative genomic hybridization (CGH), array comparative genomic hybridization (aCGH), hybridization to oligonucleotide-based SNP arrays, and direct DNA sequencing. These commonly used techniques empower researchers to detect many genetic markers per DNA sample. Computational analyses further enhance the information content derived from these data sets. But, even though these methods are frequently employed on very large sample sets, there is a realization that the data is incomplete in that the frequency of successful association studies (i.e. the delineation of genetic regions associated with a disease) and the concomitant mutation discovery, is lower than expected (David G Nathan and Stuart H Orkin, 2009, Genome Medicine Volume I, Issue 1, Article 3; Jonathan Sebat, 2007, Nature Genetics Supplement Volume 39, S3-S5). With that said, these methods are valuable in identifying genomic regions likely containing gene/disease associations. This implies that there is missing genetic information that could augment the discovery of disease-associated mutations and suggests a technical limitation that is common among these methods. Some of the technical limitations include: a lack of quantification, compressed dynamic range, biased analytical algorithms, and “noisy” background signal thus limiting the ability to detect CNV's with statistical reliability.

Compounding the technical limitations are assumptions that the expected CNV magnitudes are quantized values (restricted as regional duplications or deletions—reported as two-fold changes) creating a biased data set which places lower significance on small fold-changes. For example, published reports describe the replication of genes or gene segments (exon blocks) in unequal steps creating genetic structures whose variation could be quantified as less than two-fold depending on the complexity of the structural changes and the location of the query target (Brown et al., Oncogene. 1996 Jun. 20; 12(12):2507-13; Ruperta et al., The Journal of Experimental Medicine, Volume 191, Number 12, Jun. 19, 2000, 2183-2196; Herbert Auer. Cytogenet Genome Res, 2008, 123:278-282). These events could yield gene substructure changes representing a change from 2 copies to 3, 3 copies to 4, etc., with the inverse also possible. Depending on the physical location of the query target it would thus be possible to miss detection of changes in closely neighboring gene segments as well as a tendency to disregard small fold-changes.

Combining the analysis of exon-specific, qPCR targets with GPR™ provides informative exon-by-exon CNV profiles (ECNV's). The detection of ECNV's may contribute to the expansion of detectable genetic variability and result in an improvement in current disease association studies. Leveraging the concept of the StellARray™ qPCR System and Global Pattern Recognition™ (GPR™), commonly used for gene expression analysis, we applied this approach to assess a classical copy-number experiment (Akilesh et al., Genome Research, 2003, 13:1719-1727).

2. ECNV qPCR Target Selection, Primer Design, and Validation

The process used to generate an informative ECNV profile includes the following steps.

1. Identification of the target disease. This is based on the likelihood of success due to the existence of extensive genetic studies and publications but without specific mutation definitions.

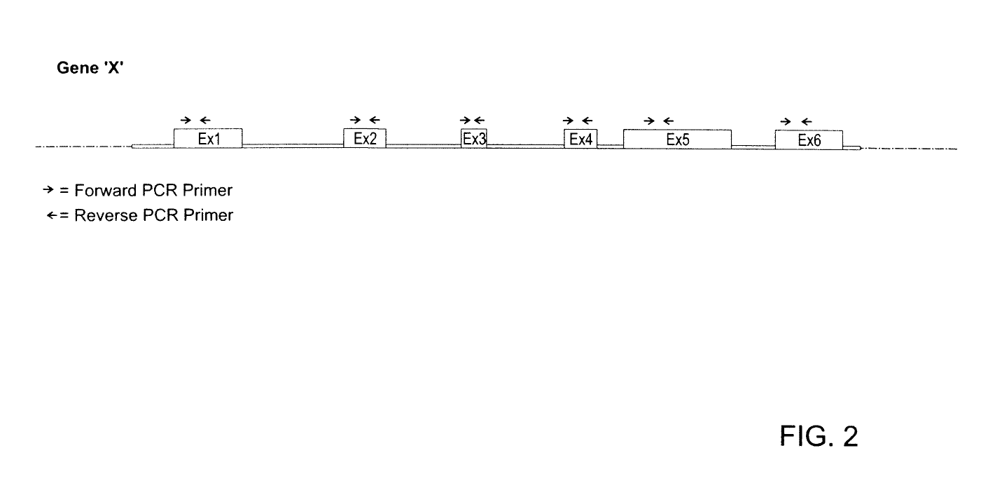

2. Gene selection. This is based on public information derived from NCBI, OMIM, etc., and shown to be associated with the disease of interest. Primary information focuses on identifying quantitative trait loci (QTL) defined in the public domain, retrieving gene candidates from within the QTL(s), accessing the DNA sequence from NCBI, and downloading the exon-by-exon sequences per gene candidate from NCBI for subsequent PCR primer designs (FIG. 2). Additionally, candidate genes may be chosen based on public information (publications) stating that a gene (not necessarily a QTL) has been identified as being associated with a disease by GWAS but with no known mutation. Both QTL and GWAS-associated genes provide biological context information leading to their association with biological pathways. These pathways provide additional choices for associated genes either ‘upstream’ or ‘downstream’ of initial candidate genes. The candidate genes sequences are retrieved as described above.

3. qF'CR Primer Design. Primer design was carried out using the Primer Express Software version 2.0.0 (Applied Biosystems, Inc.) using specific parameters to achieve small amplicons (˜75 base pairs), matched primer Tm's (58-60° C.), with primers ≧19 but ≦40 bases. Primers were purchased from (Integrated DNA Technologies, Inc.) and used in validation assays to determine specificity and sensitivity.

4. qPCR Primer Validation. Primer validation included the collection of real-time PCR data using a SYBR-Green master mix and a standard target nucleic acid. Both Cq's and dissociation curve data were collected in quadruplicate for each primer pair using 1.34 ng genomic DNA per 10 ul reaction in a 384-well plate using the Applied Biosystems 7900HT instrument or Roche LightCycler 480. Acceptable primer sets are those with a Cq 30 and a single peak dissociation curve at or near the expected temperature as predicted by Primer Express software. The sequences of the primers used in this Example are shown in Table 2.

5. StellARay™ Manufacture. Validated primer sets were used to build ‘mother’ plates from which multiple ‘daughter’ plates were manufactured. Mother plates consist of 96-well deep-well plates with each well containing both forward and reverse primers diluted in a stabilization solution at an appropriate concentration for subsequent daughter plate manufacture. Daughter plates were manufactured and processed for future use in collection of real-time PCR data.

Sample Preparation. Genomic DNA samples were provided through collaboration with the Huntsman Cancer Institute, Salt Lake City, Utah, USA (PI—Dr. Deb Neklason). Polyp scores were provided with P0 being no detectable polyps (by colonoscopy) and detectable polyps scored as P1 (less severe) to P4 (more severe), and overt CRC as P5, depending on parameters such as size, location, histology, etc. (personal communication, Dr. Deb Neklason).

7. qPCR Data Collection and Analysis. Real-time PCR data was collected by loading 10 ul reactions per well with a SYBR-Green master mix containing individual gDNA's and run in quadruplicate. The PCR plates were sealed and data collected in the ABI 7900HT instrument or the Roche LightCycler 480 under default cycling parameters (http://array.lonza.com/protocol/). Cq data was exported to a text document and data was collated into an Excel file for analysis using Global Pattern Recognition™ (GPR™) software. GPR™ analysis provides a ranked list of those genes that are statistically different between a control and an experimental data set (see http://array.lonza.com/gpr/).

TABLE 2
List of the primer pairs used in ECNV profiling for CRC

| | | | SEQ | | SEQ |
|---|---|---|---|---|---|
| Exon | | | ID | | ID |
| No. | Target Exon | Primer 1 Sequence | No. | Primer 2 Sequence | No. |
| 1 | BMPR1Aex02 | GAAAATATGCATCAGTTT | 1 | CTTCTGATTTTCTCCAAACA | 2 |
| | | AATACTGTCTTG | | GCTTT | |
| 2 | BMPR1Aex03 | GCAAGACCAATTATTAAA | 3 | AAATGTATAGCTGAGGCATT | 4 |
| | | GGTGACAGT | | GTTCAA | |
| 3 | BMPR1Aex04 | CTTCATGGCACTGGGATG | 5 | TCTGGTGCTAAGGTTACTCC | 6 |
| | | AA | | ATTTT | |
| 4 | BMPR1Aex05 | ATGGACATTGCTTTGCCA | 7 | TTTCATACACCCTGAAGCTA | 8 |
| | | TCA | | ATGTG | |
| 5 | BMPR1Aex06 | GATTCTCCAAAAGCCCAG | 9 | GGTTGCAAATACTGGTTACA | 10 |
| | | CTAC | | TAAATTG | |
| 6 | BMPR1Aex07 | CGTTTTTTGATGGCAGCA | 11 | TGATCATAGCAATTATGCAG | 12 |
| | | TT C | | ACAGC | |
| 7 | BMPR1Aex08 | TATTGCAAGAGCATCTCA | 13 | ACTGGAATAAATGCTTCATC | 14 |
| | | AGCAG | | CTGTT | |
| 8 | BMPR1Aex09 | TTGCCAAACAGATTCAGA | 15 | CCATTTGCCCATCCATACTT | 16 |
| | | TGGT | | CT | |
| 9 | BMPR1Aex10 | TTGCTCATCGAGACCTAA | 17 | CAGGTCAGCAATGCAGCAAC | 18 |
| | | AGAGC | | | |
| 10 | BMPR1Aex11 | GTTGATGTGCCCTTGAAT | 19 | AGGCTTTCGTCCAGCACTTC | 20 |
| | | ACCA | | | |
| 11 | BMPR1Aexl2 | CATATTACAACATGGTAC | 21 | AACGTTTGACACACACAACC | 22 |
| | | CGAGTGATC | | TCA | |
| 12 | BMPR1Aex13 | GGGATTCCTCTGCTGCCA | 23 | CGGCCACCAATATCTTCCTG | 24 |
| | | TT | | T | |
| 13 | CLN5ex02 | CGCTTTGACTTCCGTCCA | 25 | GGTGAGCCAGTTGGACAGAA | 26 |
| | | AA | | A | |
| 14 | CLN5ex03 | GGATGCCCCTTTCTGGTG | 27 | CCTTCCAGTGAACATCATCA | 28 |
| | | TA | | ATTC | |
| 15 | CLN5ex04 | TGGGTAAACAGGCACCTT | 29 | GCTGACAGCTTTGTGGGAAG | 30 |
| | | CTG | | A | |
| 16 | EDNRBex01 | CTTTCAAATACATCAACA | 31 | AAGTGTGGAGTTCCCGATGA | 32 |
| | | CGGTTGT | | TC | |
| 17 | EDNRBex03 | GCTGTCCCTGAAGCCATA | 33 | AAGCAGATTCGCAGATAACT | 34 |
| | | GGT | | TCCT | |
| 18 | EDNRBex04 | GTTTCTATTTCTGCTTGC | 35 | TCTCAACATTTCACAGGTCA | 36 |
| | | CATTGG | | TTAGTG | |
| 19 | EDNRBex05 | CGTCTTTTGCCTGGTCCT | 37 | TGAGCTTCAGAATCCTGCTG | 38 |
| | | TG | | AG | |
| 20 | EDNRBex06 | TTGGTATCAACATGGCTT | 39 | GAATCTTTTGCTcACCAAAT | 40 |
| | | CACTG | | ACAGAG | |
| 21 | EDNRBex07 | GCTTGGGATGAGATGTGT | 41 | CCAACCCCACCTCATTTCCT | 42 |
| | | GTGA | | | |
| 22 | FBXL3ex02 | AGGAACTGCAGAGAAATC | 43 | GATTACCCCAATCACAAGTC | 44 |
| | | CAAGA | | TGAGA | |
| 23 | FBXL3ex03 | GTGATATACTATCGCAAC | 45 | GCTTGGTCGAGCAGTTGAAA | 46 |
| | | TTGTGAATTG | | TAA | |
| 24 | FBXL3ex04 | CCAAATCCCTGTCTTCGC | 47 | GGCCACTAGTACTTTGAGAG | 48 |
| | | TTAA | | ATGGA | |
| 25 | FBXL3ex05 | CGGCCACTTGATGAAGAG | 49 | TCCCCTAGTCCAATAGCTGA | 50 |
| | | TTAAT | | CAA | |
| 26 | IRG1ex01 | ATGAAGGCATTTTCCCAA | 51 | CCAGTTGCTATCAGGGAGTA | 52 |
| | | GAAG | | ATGA | |
| 27 | IRG1ex02 | TGTCTATAAGGAGTCTGC | 53 | CGAGTGAACATTGATAACTT | 54 |
| | | TATTAGACCGT | | GCCTT | |
| 28 | IRG1ex03 | CACAGCAATCCATGGCTT | 55 | GAATCATCCTCTTGCTCCTC | 56 |
| | | GA | | TGA | |
| 29 | IRG1ex04 | GCTGTCCTTCCTGTCCTC | 57 | AGGTCAAGGCCAGAAAACTT | 58 |
| | | ACA | | TG | |
| 30 | IRG1ex05 | TCCAAAGTTTTCTGGCCT | 59 | GCAGTAATCGGCCTTGCACT | 60 |
| | | TGA | | | |
| 31 | IRG1ex06 | GCTGCCAAGCATGGGATA | 61 | TCCAAGACCTGCTTGTTTCC | 62 |
| | | GA | | TT | |
| 32 | KCTD12ex01 | CATAGTGCACGTCGTGGG | 63 | AGCTAAAGGAAGGTCCTACT | 64 |
| | | TATT | | GACATTC | |
| 33 | MYCBP2ex02 | CACTACCAGCTGCTGCTG | 65 | GAGCGCAGCGGTATAAATCC | 66 |
| | | TCA | | T | |
| 34 | MYCBP2ex04 | TAGCAATCCTTCTGCTTT | 67 | TTTCCTTTTTCTGCCATTCC | 68 |
| | | CAATATTTAC | | AG | |
| 35 | MYCBP2ex05 | TGAGGTTGGCCTTTGTGA | 69 | TGAGACACAGGGATGGATGA | 70 |
| | | AGT | | GA | |
| 36 | MYCBP2ex07 | ATTCAAATTCAGGACTGG | 71 | TCTTTTAATGGCCACTTGTG | 72 |
| | | TTTAGTAATG | | CAT | |
| 37 | MYCBP2ex08 | GGCCATATATACAATTCT | 73 | CTGAGCATACCCTAACCAAG | 74 |
| | | ACATCCCG | | ACTTT | |
| 38 | MYCBP2ex09 | ATAACCACAGCATGACAG | 75 | CTGGTAACATCACAGTACCA | 76 |
| | | CCATAA | | TCTTGC | |
| 39 | MYCBP2ex10 | ATTGCCACACTGAAGGTC | 77 | ATCTCTTGAAGCAGCTATCT | 78 |
| | | AAAATATT | | GATTAATATATTC | |
| 40 | MYCBP2ex11 | TTTGCCACAAGCACTGAA | 79 | GCATGTAAGCATTTTCTAGC | 80 |
| | | CCT | | CAGTT | |
| 41 | MYCBP2ex12 | GGATTTGATGAGGAGTCA | 81 | ATTTGCTGTTTTCATTAGCG | 82 |
| | | GCAATT | | CAA | |
| 42 | MYCBP2ex13 | AATGGGTTGAGCTACCAA | 83 | GTGAGAGCCATCGTGTCCAA | 84 |
| | | TTACAAA | | | |
| 43 | MYCBP2ex14 | TATACAGCCTGCAATAAT | 85 | TCTTTTCCAAACATGTAGAG | 86 |
| | | GGAAGTAGTT | | TTCTCC | |
| 44 | MYCBP2ex15 | TTGAAGGGCCATTTTGTA | 87 | TCTCCATTCTTCATTAAAAC | 88 |
| | | ACTCA | | ACAAGTG | |
| 45 | MYCBP2ex16 | AAGCTGGAGCAGTGCATG | 89 | CTACTGACACAGCTGGCTCC | 90 |
| | | GT | | ATA | |
| 46 | MYCBP2ex17 | CTGGTTGTGCTGTGTGTG | 91 | TCTTTGTCTTGCCTCTTGAC | 92 |
| | | GAT | | CAT | |
| 47 | MYCBP2ex18 | TTTGCTGGTCCTATTTTT | 93 | AGCTGTGCTGGATGGGATCT | 94 |
| | | ATGAACC | | | |
| 48 | MYCBP2ex19 | CCCCTTGTATTTGCTGGT | 95 | GGATGGGATCTGAGTCTGGC | 96 |
| | | CCTAT | | TA | |
| 49 | MYCBP2ex20 | AGAGGCGAAAAGGATGCA | 97 | CGGAGCTCACAGTCAAATCG | 98 |
| | | AG | | | |
| 50 | MYCBP2ex21 | GAAAATGGAGATGTCTAT | 99 | GAGTTGACATCTCCATGTCC | 100 |
| | | ACATTTGGTTA | | TAGCT | |
| 51 | MYCBP2ex22 | AGGCCCTAGCACACAAGT | 101 | TGAAGACCTGTCCATCCATT | 102 |
| | | CACT | | AAAAG | |
| 52 | MYCBP2ex23 | CCAGCTCCCATGCCTAAC | 103 | TGGTCCCCACTTGCACCTAT | 104 |
| | | AT | | | |
| 53 | MYCBP2ex24 | GCCTTCTGATAAATAAAG | 105 | TCCTTGCAGATCCTCTTGTT | 106 |
| | | TGGATGG | | CTG | |
| 54 | MYCBP2ex25 | TTCCCTCTGCAGCAGACA | 107 | TGATCCTGTTGGTAAGGCAA | 108 |
| | | TG | | GTT | |
| 55 | MYCBP2ex26 | GTTGTCTTGATACCTTGG | 109 | TTGAGTCTCTTCCTCTGTAC | 110 |
| | | CAGCTA | | TTGCA | |
| 56 | MYCBP2ex27 | TGCCCATTCAGTAGAAGC | 111 | CAAACAGACCAAGACCACCA | 112 |
| | | TATACG | | AG | |
| 57 | MYCBP2ex28 | TTTGAATTGGGTCCTGAT | 113 | AGCCAATACATCAGTCTCTG | 114 |
| | | GGAG | | CAAG | |
| 58 | MYCBP2ex29 | GATGAGCCTGTTCTCCTG | 115 | GTCACTGCTGGGTCCTGACA | 116 |
| | | CAA | | | |
| 59 | MYCBP2ex30 | AGAGTTCAAAGAAATCAA | 117 | TAACTGAGGTATCTGACCCG | 118 |
| | | ATAATGGTACAG | | CATT | |
| 60 | MYCBP2ex31 | CCAGTGATGGCAGTGCTT | 119 | TCTTTAAAATGTGTACAGGT | 120 |
| | | CA | | TCACTGG | |
| 61 | MYCBP2ex32 | CACTGGAGCTGGACCACC | 121 | GCTGTGAACTGGAATCCTTT | 122 |
| | | TT | | TAATC | |
| 62 | MYCBP2ex33 | TCATAATACTTTCACTGC | 123 | CACAAAGGCAAGCCCACTGT | 124 |
| | | CTGCTTTC | | A | |
| 63 | MYCBP2ex34 | CCGACTCCTTGCAGCTGT | 125 | CAATCGGGAAGATGGAAGTC | 126 |
| | | TAT | | AG | |
| 64 | MYCBP2ex35 | GGTCATTGTTGTGCTACC | 127 | AGACGAGGTGGGAGGAGAAG | 128 |
| | | AGTCA | | A | |
| 65 | MYCBP2ex36 | GGGTCCCCTGATGCAATC | 129 | CCATAGACAGAGAAACCAAC | 130 |
| | | T | | CACA | |
| 66 | MYCBP2ex37 | ACATGCAGGAGATTCAAC | 131 | CCGTTGTGTACGTTCCTTTC | 132 |
| | | TCATTC | | AC | |
| 67 | MYCBP2ex38 | GCTGTGCGCTTGAGGAAC | 133 | 1GGGCACTGAACTGTGGTCAT | 134 |
| | | TAT | | T | |
| 68 | MYCBP2ex39 | TCCCAACTTCTGAGTAAA | 135 | ACAGTGCTTACAACAGACAA | 136 |
| | | GCCAA | | TGCTC | |
| 69 | MYCBP2ex40 | AACTGCTGAGTTCTTCCA | 137 | CTTGGGAATAGCAGCAGCTA | 138 |
| | | GTCTGTTT | | CTG | |
| 70 | MYCBP2ex41 | CCTGCCTTCAACCCTAAT | 139 | CAAGCAGAGAGGCCCTGTTC | 140 |
| | | CAGT | | | |
| 71 | MYCBP2ex42 | TGGATGACAATCGAATTT | 141 | GGAATCAACAAACGAAGGAC | 142 |
| | | GACC | | ATCT | |
| 72 | MYCBP2ex43 | TTTCATTGGAGACTGCAT | 143 | TGCAAAACACTTAAAACCAT | 144 |
| | | CAGATTA | | AGAAAGAA | |
| 73 | MYCBP2ex44 | TAGCCAATCTTGGTGGGG | 145 | AGGAAGTGCTAGGTCCTTCT | 146 |
| | | TTT | | TCATC | |
| 74 | MYCBP2ex45 | GTAATGAATTAGAAGAAG | 147 | CTGCAATGCAGCCTCCTCA | 148 |
| | | ACCTTGAAATTCT | | | |
| 75 | MYCBP2ex46 | TTGGAAAGGGTCTAGCTC | 149 | TTGGAGTGGTAAATTTCCCT | 150 |
| | | TTTCTC | | CAA | |
| 76 | MYCBP2ex47 | ATTCATATGCGGATCCTC | 151 | GGTAGGCCAACCACAACGAA | 152 |
| | | AGAAA | | | |
| 77 | MYCBP2ex48 | CTTATGGAGGGCTGGCAT | 153 | ATATCGAGCTTCCTTCACTA | 154 |
| | | CA | | TCATTG | |
| 78 | MYCBP2ex49 | GTTTATGAAAATTATTCA | 155 | CTCTTAGGAGTTGGTGATGC | 156 |
| | | TTTGAAGAACTACG | | AAAA | |
| 79 | MYCBP2ex50 | CAATAATGATGGGACTTA | 157 | TGGTAACATGAAGAGTGTAG | 158 |
| | | TTGTGCAA | | AGTCCAA | |
| 80 | MYCBP2ex51 | ATGCTGGTCTGGAAGTAA | 159 | TCAGACTTTGGTTTGACCAA | 160 |
| | | AAGTAAAAG | | CTGA | |
| 81 | MYCBP2ex52 | AAAATTTGTGGCCAAGGA | 161 | CCTATCTGCTCACTCTGAAG | 162 |
| | | CAGT | | GGAA | |
| 82 | MYCBP2ex53 | GTGTGGCTGAGGCTGAAT | 163 | CAGGCTTCAGTGTAACCATT | 164 |
| | | GAT | | CATG | |
| 83 | MYCBP2ex54 | GAGGGCCAGGCATGTACA | 165 | AAGGTTAGGGCAGCTTCTGA | 166 |
| | | AG | | TG | |
| 84 | MYCBP2ex55 | AAGGGACATGGGTGCAAC | 167 | CCATGCCTCTCCTTCATCAC | 168 |
| | | TG | | TC | |
| 85 | MYCBP2ex56 | TCCTCCAAGCCCTTTCTC | 169 | CATAATCAAATCCTTGGGCA | 170 |
| | | AG | | CTG | |
| 86 | MYCBP2ex57 | ACAGCAGATCGCTTAAAC | 171 | TGTGCCCCTTGGCTTCTTC | 172 |
| | | CTGAT | | | |
| 87 | MYCBP2ex58 | GGTTACAATAGCATTGGG | 173 | CTTCCTCCTATGCCACCATC | 174 |
| | | CATTT | | A | |
| 88 | MYCBP2ex59 | GCAGAACCGAGCATTCTG | 175 | CCTTCTTTTACACTGGGCAA | 176 |
| | | TG | | CTG | |
| 89 | MYCBP2ex60 | ATCTGTACCTGCCCCGTA | 177 | TGCTCTCTGGCTCTTCAAAT | 178 |
| | | TATATCA | | ACAT | |
| 90 | MYCBP2ex61 | CTGTCTTCCAAAGATCAT | 179 | TCGTGCAGGTAAAATGGAGT | 180 |
| | | ACTCAGTTG | | GTT | |
| 91 | MYCBP2ex62 | GTTGGTTCTTCCCTTTTG | 181 | GAAAGAGAGCTGTGGGCTGA | 182 |
| | | AGACA | | GA | |
| 92 | MYCBP2ex63 | TCATCCAAACCACTTCTC | 183 | TTCCACTGGTGCAGGAGTCA | 184 |
| | | TCCAT | | | |
| 93 | MYCBP2ex64 | GTGAACATCCACTCTCAG | 185 | GCGGTGAAAGGTGTGTGGTA | 186 |
| | | ACATAGTGA | | A | |
| 94 | MYCBP2ex65 | CAGTTCCTTCATCAGAGC | 187 | CTATCGCCATCATCTGACTT | 188 |
| | | AACGT | | TGAC | |
| 95 | MYCBP2ex66 | TCCACAGAAACCTTTTGG | 189 | ACACAGTTGATGGTGATGTT | 190 |
| | | GAAT | | CTTAGTT | |
| 96 | MYCBP2ex67 | AATAAAGTTACCTCAATG | 191 | CTGCTTTATTCTGCACAAAT | 192 |
| | | ACCTTCTTAACTG | | CTTCTACT | |
| 97 | MYCBP2ex68 | AGTCAAAGTCCTGGGCTG | 193 | GGGCCACACTGGCTGAAAT | 194 |
| | | GAA | | | |
| 98 | MYC BP2ex69 | GTATTTGGAAAGCTCATC | 195 | GATGACAATAGTGCTTTTTC | 196 |
| | | TCTGGAG | | CTCTTGT | |
| 99 | MYCBP2ex70 | CAACATCAGATGCTGACC | 197 | TTGTAAGTTAGTCAGCTTAC | 198 |
| | | TGAAA | | TCCTGCTG | |
| 100 | MYCBP2ex71 | GGAAGCTACCAGAGTCCG | 199 | TTGGCTGAGAATTGGCATTT | 200 |
| | | TGAA | | T | |
| 101 | MYCBP2ex72 | TAGGATGCATTGCCAAAG | 201 | ACCAGCTGTTCCAGTGATGG | 202 |
| | | CA | | T | |
| 102 | MYCBP2ex73 | GAGGTGAAAGTCATTGGT | 203 | TGATAAGTTTAATGATGATC | 204 |
| | | GGATG | | TCTGAGATCTG | |
| 103 | MYCBP2ex74 | GGTCATCTGTCAGAAGCT | 205 | TTGGTCAAGGCAATGATGGT | 206 |
| | | TGGTC | | T | |
| 104 | MYCBP2ex75 | CTCTGGCTTGCTCTCGCA | 207 | CGAGGAGAGACGATCTACGT | 208 |
| | | TC | | GG | |
| 105 | MYCBP2ex76 | GGTGAAACTGCAGCAATC | 209 | TGAAGGAATCTGTCACAGTC | 210 |
| | | ATTTTA | | TGTACA | |
| 106 | MYCBP2ex77 | AAGGTTGTGGTAGAACCA | 211 | CACCATTGCCTTCATTGTTT | 212 |
| | | AATTGTT | | TAGA | |
| 107 | MYCBP2ex79 | AGCACTGTCTGCCCTGTC | 213 | CATGTCATCGGCGTCTTGC | 214 |
| | | TACAC | | | |
| 108 | MYCBP2ex80 | GTAGTCACATATTCCACT | 215 | AATGTTATCCTTGGGCCAAG | 216 |
| | | TACAGTGCTG | | C | |
| 109 | MYCBP2ex81 | CAGAAGAAAAGCCTTAAT | 217 | CACCAGGAGTTGTGATAGCT | 218 |
| | | GAGATTGG | | TCA | |
| 110 | MYCBP2ex82 | ATTTTGGTGGTGAAGCTC | 219 | AATGAGCTCTCTGGGATCAT | 220 |
| | | GCT | | AATCA | |
| 111 | MYCBP2ex84 | GAAGGAACTGAATGTCCA | 221 | ACTCCACATCCCAGAGCAAA | 222 |
| | | CTCCAT | | CT | |
| 112 | PIK3CAex02 | GAAACAAGACGACTTTGT | 223 | CGGTTGCCTACTGGTTCAAT | 224 |
| | | GACCTTC | | TACT | |
| 113 | PIK3CAex03 | ATCCAGAAGTACAGGACT | 225 | GAGGTCCCTAAGATCCACAG | 226 |
| | | TCCGAA | | CTT | |
| 114 | PIK3CAex04 | AATAGTTTCTCCAAATAA | 227 | CTTGTTCTGGTACACAGTCA | 228 |
| | | TGACAAGCAG | | TGGTT | |
| 115 | PIK3CAex05 | GGAGGATGCCCAATTTGA | 229 | TGTAAAACAGTCCATTGGCA | 230 |
| | | TG | | GTTG | |
| 116 | PIK3CAex06 | AT CTATGTT CGAACAGGT | 231 | AACAAGGTACTCTTTGAGTG | 232 |
| | | ATCTACCATG | | TTCACATT | |
| 117 | PIK3CAex07 | TGGAATGAATGGCTGAAT | 233 | CAAATGGAAAGGCAAAGTCG | 234 |
| | | TATGA | | A | |
| 118 | PIK3CAex08 | GAATCTTTGGCCAGTACC | 235 | TTGGATTTGATCCAGTAACA | 236 |
| | | TCATG | | CCAAT | |
| 119 | PIK3CAex09 | GTGTGGTAAAGTTCCCAG | 237 | TCCTGCTTCTCGGGATACAG | 238 |
| | | ATATGTCA | | AC | |
| 120 | PIK3CAex10 | TGACAAAGAACAGCTCAA | 239 | AATCTTTCTCCTGCTCAGTG | 240 |
| | | AGCAA | | ATTTC | |
| 121 | PIK3CAex11 | ACACTATTGTGTAACTAT | 241 | CTACTTCATCTCTAGAATTC | 242 |
| | | CCCCGAAAT | | CATTTAACAGA | |
| 122 | PIK3CAex12 | TTGGCCTCCAATCAAACC | 243 | CTCGAACCATAGGATCTGGG | 244 |
| | | TG | | TAAT | |
| 123 | P/K3CAex13 | CTAAAATATGAACAATAT | 245 | GTGCCCAATCCTTTGATTAG | 246 |
| | | TTGGATAACTTGCTT | | TCA | |
| 124 | PIK3CAex14 | GCCTGCTTTTGGAGTCCT | 247 | TGCCTCGACTTGCCTATTCA | 248 |
| | | ATTG | | G | |
| 125 | PIK3CAex15 | GTTGAGCAAATGAGGCGA | 249 | TGAGCAGGGTTTAGAGGAGA | 250 |
| | | CC | | CAG | |
| 126 | PIK3CAex16 | AGTGTCGAATTATGTCCT | 251 | CTCTGACATGATGTCTGGGT | 252 |
| | | CTGCAA | | TCTC | |
| 127 | PIK3CAex17 | ATTTACGGCAAGATATGC | 253 | AGACCTTGATTTTGCCAGAT | 254 |
| | | TAACACTTC | | ATTTTC | |
| 128 | PIK3CAex18 | TCGGTGACTGTGTGGGAC | 255 | GCCTTTGCACTGAATTTGCA | 256 |
| | | TTAT | | | |
| 129 | PIK3CAex19 | ACGTTCATGTGCTGGATA | 257 | TGATGTTACTATTGTGACGA | 258 |
| | | CTGTG | | TCTCCAA | |
| 130 | PIK3CAex20 | CGAGAACGTGTGCCATTT | 259 | GTGCATTCTTGGGCTCCTTT | 260 |
| | | GT | | AC | |
| 131 | PTENex01 | GCAGCCATGATGGAAGTT | 261 | CTCTCATCTCCCTCGCCTGA | 262 |
| | | TGA | | | |
| 132 | PTENex02 | ATATTTATCCAAACATTA | 263 | AATATTGTTCCTGTATACGC | 264 |
| | | TTGCTATGGGA | | CTTCAAG | |
| 133 | PTENex05 | CCAATGGCTAAGTGAAGA | 265 | CACCAGTTCGTCCCTTTCCA | 266 |
| | | TGACAA | | | |
| 134 | PTENex06 | CCAGTCAGAGGCGCTATG | 267 | AACAGTGCCACTGGTCTATA | 268 |
| | | TGT | | ATCCA | |
| 135 | PTENex07 | TGTGGTCTGCCAGCTAAA | 269 | TGAACTTGTCTTCCCGTCGT | 270 |
| | | GGT | | G | |
| 136 | PTENex08 | CATACCAGGACCAGAGGA | 271 | TGCTATCGATTTCTTGATCA | 272 |
| | | AACCT | | CATAGA | |
| 137 | PTENex09 | AATGGAGGGAATGCTCAG | 273 | AAATAGCTGGAGATGGTATA | 274 |
| | | AAAG | | TGGTCC | |
| 138 | PTGS2ex01 | GACCAATTGTCATACGAC | 275 | GGGGTAGGCTTTGCTGTCTG | 276 |
| | | TTGCAG | | A | |
| 139 | PTGS2ex02 | CCACCCATGTCAAAACCG | 277 | GTCCGGGTACAATCGCACTT | 278 |
| | | AG | | | |
| 140 | PTGS2ex03 | GTGCACTACATACTTACC | 279 | TGCATTTCGAAGGAAGGGAA | 280 |
| | | CACTTCAAG | | T | |
| 141 | PTGS2ex04 | CTACAAAAGCTGGGAAGC | 281 | AATCATCAGGCACAGGAGGA | 282 |
| | | CTTCT | | A | |
| 142 | PTGS2ex05 | ACATGATGTTTGCATTCT | 283 | TGGCCCTCGCTTATGATCTG | 284 |
| | | TTGCC | | | |
| 143 | PTGS2ex06 | GTGGACTTAAATCATATT | 285 | ATCCTTGAAAAGGCGCAGTT | 286 |
| | | TACGGTGAAA | | T | |
| 144 | PTGS2ex07 | GGTCTGGTGCCTGGTCTG | 287 | AGCACATCGCATACTCTGTT | 288 |
| | | AT | | GTG | |
| 145 | PTGS2ex08 | AGTGGCTATCACTTCAAA | 289 | CGATTTTGGTACTGGAATTG | 290 |
| | | CTGAAATTT | | TTTGT | |
| 146 | PTGS2ex09 | TATCACAGGCTTCCATTG | 291 | AAAGCGTTTGCGGTACTCAT | 292 |
| | | ACCA | | TAA | |
| 147 | PTGS2ex10 | GTTGGAAGCACTCTATGG | 293 | GCCGAGGCTTTTCTACCAGA | 294 |
| | | TGACAT | | A | |
| 148 | SLAIN1ex01 | ATTGCTGGATCTGGAGAG | 295 | CAGGTGTAGTCGTCCTCGTC | 296 |
| | | CGTA | | C | |
| 149 | SLAINlex02 | CCCTGACTCCTTTGCAGT | 297 | ACGTCTCGCTGCTTCCATCT | 298 |
| | | GG | | | |
| 150 | SLAIN1ex03 | AATTTGCCTGGCAAGTGA | 299 | TCTTTGTGACTGCTATCTTG | 300 |
| | | TCA | | CCTAAC | |
| 151 | SLAIN1ex04 | CCCACTCAGTCCCCAGTC | 301 | TGGAGATAGAATCATCcTCC | 302 |
| | | AT | | AATTCT | |
| 152 | SLAIN1ex05 | TTCCAAGATGTTCCCCTT | 303 | CCTACACTCCCGAATGCTGG | 304 |
| | | TCC | | | |
| 153 | SLAIN1ex06 | CTAGCCCGGATGCCAAGT | 305 | TGACTATTTCGCACGGTGAC | 306 |
| | | AC | | C | |
| 154 | SLAIN1ex07 | CAGTGTCTATCCGACAGC | 307 | CATGTTACTGCTGCCTTGAA | 308 |
| | | CTCTTA | | CG | |
| 155 | SLAIN1ex08 | CACATCATGCAATTTGAG | 309 | CTCCTTGCAATGCTTCAAAT | 310 |
| | | ACACA | | TATG | |
| 156 | SMAD4ex01 | ATTGCTGGATCTGGAGAG | 311 | CAGGTGTAGTCGTCCTCGTC | 312 |
| | | CGTA | | C | |
| 157 | SMAD4ex02 | CCAACAAGTAATGATGCC | 313 | TCACTCTCTCCACCTTGTCT | 314 |
| | | TGTCTG | | ATGG | |
| 158 | SMAD4ex03 | AGGTGGCCTGATCTTCAC | 315 | CATTTTAAGTCAAACGCATA | 316 |
| | | AAA | | CTGACA | |
| 159 | SMAD4ex05 | AGCCATCGTTGTCCACTG | 317 | TGTCGATGCACGATTACTTG | 318 |
| | | AAG | | GT | |
| 160 | SMAD4ex06 | AGCCATAGTGAAGGACTG | 319 | CCAGTAAATCCATTCTGCTG | 320 |
| | | TTGCA | | CTG | |
| 161 | SMAD4ex07 | CCACCTGGACTGGAAGTA | 321 | CTGAAGATGGCCGTTTTGGT | 322 |
| | | GGACT | | | |
| 162 | SMAD4ex08 | GGCCTGTTCACAATGAGC | 323 | AGGATGATTGGAAATGGGAG | 324 |
| | | TTG | | G | |
| 163 | SMAD4ex09 | GGTGTTCCATTGCTTACT | 325 | AGGGCAGCTTGAAGGAACCT | 326 |
| | | TTGAAA | | | |
| 164 | SMAD4ex10 | TTGGGTCAGGTGCCTTAG | 327 | CACGCCCAGCTTCTCTGTCT | 328 |
| | | TGA | | A | |
| 165 | SMAD4ex11 | TCTTTGATTTGCGTCAGT | 329 | CTGCAGCTTGTGCAGTAGCC | 330 |
| | | GTCAT | | | |
| 166 | SMAD4ex12 | AGCTGGAGAGGAAGGGAT | 331 | CCCGTGAGTCCTTCTATCAA | 332 |
| | | GAA | | TGAC | |
| 167 | STK11ex01 | AGCTCATCGGCAAGTACC | 333 | TCCAGCACCTCCTTCACCTT | 334 |
| | | TGA | | | |
| 168 | STK1lex02 | TTCAACTACTGAGGAGGT | 335 | ATTTTCTGCTTCTCTTCGTT | 336 |
| | | TACGGC | | GTATAACAC | |
| 169 | STK11ex03 | GTGTGTGGCATGCAGGAA | 337 | GCACACTGGGAAACGCTTCT | 338 |
| | | AT | | | |
| 170 | STK11ex04 | TCAGCTGATTGACGGCCT | 339 | CCCGGCTTGATGTCCTTGT | 340 |
| | | G | | | |
| 171 | STK11ex05 | GGACACCTTCTCCGGCTT | 341 | TGACCCCAGCCGACCAGAT | 342 |
| | | CAA | | | |
| 172 | STK11ex06 | AACATCACCACGGGTCTG | 343 | CCCTTCCCGATGTTCTCAAA | 344 |
| | | TACC | | C | |
| 173 | STK11ex08 | AAGAAACATCCTCCGGCT | 345 | TACGGCACCACAGTCATGCT | 346 |
| | | GAA | | | |
| 174 | SCELex01 | CACTGAATAAACTCTAGG | 347 | TGGCTAACCAGCCTGTAGTG | 348 |
| | | TTCCCATTT | | ATT | |
| 175 | SCELex02 | GTCCTTACTGGAAGGCAG | 349 | CATTTCCTGTGGGAGACATT | 350 |
| | | CATG | | TTTC | |
| 176 | SCELex03 | CACACGGAAGCAGCAGGA | 351 | TTATCCAACTGTTATCCTGT | 352 |
| | | TT | | AAGAAAGTTC | |
| 177 | SCELex04 | AGATGAAAATTACGGTAG | 353 | GTCCAATGCATCATGGGAAT | 354 |
| | | GGTGGT | | TA | |
| 178 | SCELex05 | GAAAGTAAATGAGAGAGA | 355 | CTGTCCAAAGTGTCATCAGA | 356 |
| | | TGTGCCAA | | ACTGTA | |
| 179 | SCELex06 | GATCTCAGACAGAAATGA | 357 | CTATTGGTTAGTTGGTTATC | 358 |
| | | TGCTGC | | CAAGGTATT | |
| 180 | SCELex08 | ATTGAATGCCAACACCTC | 359 | TTCTTCTTTACAGGAGTAGT | 360 |
| | | CAA | | AGCAGAAGTG | |
| 181 | SCELex10 | ACCAGGTGTTCACCCTCC | 361 | TCTCAGCTGGTTAGGAGAAG | 362 |
| | | AATA | | AAACA | |
| 182 | APCex04.2 | AGCAGTAATTTCCCTGGA | 363 | GATCCTTCCCGGCTTCCAT | 364 |
| | | GTAAAACT | | | |
| 183 | APCex05.1 | TCATTGCTTCTTGCTGAT | 365 | AGATTCTGAAGTTGAGCGTA | 366 |
| | | CTTGAC | | ATACCA | |
| 184 | APCex06.1 | ACAGATATGACCAGAAGG | 367 | CCTAGTTGTTCTTCCATCGC | 368 |
| | | CAATTG | | AACT | |
| 185 | APCex08.2 | GAACAAGCATGAAACCGG | 369 | TGTTGATTTCTCCCACTCCT | 370 |
| | | CT | | TGA | |
| 186 | APCex09.1 | GTTCAACTACACGAATGG | 371 | TCGAGGTGCAGAGTGTGTGC | 372 |
| | | ACCATG | | | |
| 187 | APCex10.2 | CATTCACTCACAGCCTGA | 373 | GCGCGTATCTGTTCCAAAAG | 374 |
| | | TGACA | | A | |
| 188 | APCex12.2 | ATTATTGCAAGTGGACTG | 375 | CCATTCCAGCATATCGTCTT | 376 |
| | | TGAAATGT | | AGTGTA | |
| 189 | APCex13.1 | GCTCTATGAAAGGCTGCA | 377 | TGTAAGTCTTCACTTTCAGA | 378 |
| | | TGAGA | | TTTTAGTTGG | |
| 190 | APCex14.1 | TGCGAGTGTTTTGAGGAA | 379 | TTCCAACTTCTCGCAACGTC | 380 |
| | | TTTG | | T | |
| 191 | APCex15.1 | TGAGTGCCTTATGGAATT | 381 | TGCACCATCTACAGCACATA | 382 |
| | | TGTCAG | | TATCAG | |
| 192 | CTNNB1ex01.1 | CGGCTTCTGCGCGACTTA | 383 | GCCACAGACCGAGAGGCTTA | 384 |
| | | TA | | A | |
| 193 | CTNNB1ex02a.1 | ATGGCCATGGAACCAGAC | 385 | CCAGGTAAGACTGTTGCTGC | 386 |
| | | A | | C | |
| 194 | CTNNB1ex03.2 | CAGATGCTGAAACATGCA | 387 | TGGCAAGTTCTGCATCATCT | 388 |
| | | GTTG | | TG | |
| 195 | CTNNB1ex04.2 | TAAGGCTGCAGTTATGGT | 389 | CATGATAGCGTGTCTGGAAG | 390 |
| | | CCATC | | CTT | |
| 196 | CTNNB1ex05.1 | GAAGGAGCTAAAATGGCA | 391 | TGAGCAAGGCAACCATTTTC | 392 |
| | | GTGC | | T | |
| 197 | CTNNB1ex06.2 | CTACTGTGGACCACAAGC | 393 | CCGGCTTATTACTAGAGCAG | 394 |
| | | AGAGTG | | ACAGATA | |
| 198 | CTNNB1ex07.1 | CCAAAGACAGTTCTGAAC | 395 | GCAAGCTTTAGGACTTCACC | 396 |
| | | AAGACGT | | TGA | |
| 199 | CTNNB1ex08.2 | TCCTTGGGACTCTTGTTC | 397 | GCTGCACAGGTGACCACATT | 398 |
| | | AGCT | | | |
| 200 | CTNNB1ex09.1 | ATGCACCTTTGCGTGAGC | 399 | TGTGCACGAACAAGCAACTG | 400 |
| | | A | | | |
| 201 | CTNNB1ex10.2 | AGTCCTCTGATAACAATT | 401 | GTACCGGAGCCCTTCACATC | 402 |
| | | CGGTTGT | | | |
| 202 | CTNNB1ex11.2 | CTTGTCCTGAGCAAGTTC | 403 | TCCCATTGAAAACATCCAAA | 404 |
| | | ACAGA | | GA | |
| 203 | CTNNB1ex12.2 | GTTTTGTTCCGAATGTCT | 405 | CAGCTCAACTGAAAGCCGTT | 406 |
| | | GAGGA | | T | |
| 204 | CTNNB1ex13.1 | CTGCTGATCTTGGACTTG | 407 | TGGCGATATCCAAGGGGTTC | 408 |
| | | ATATTGG | | | |
| 205 | CTNNB1ex14.2 | ATGCCCAGGACCTCATGG | 409 | TCAAACCAGGCCAGCTGATT | 410 |
| | | A | | | |
| 206 | CTNNB1ex15.1 | ACTTGCATTGTGATTGGC | 411 | GAGATACCAGCCCACCCCTC | 412 |
| | | CTG | | | |
| 207 | DCCex01.2 | CGCGGAATTGTCTCTTCA | 413 | CGGGCTGTGCATTAAAAGGT | 414 |
| | | ACT | | T | |
| 208 | DCCex02.2 | GAGTTCCAGTGATCAAGT | 415 | TTGCTGCTTCCTTTCATCCA | 416 |
| | | GGAAGA | | T | |
| 209 | DCCex03.2 | TCTTGCCCTCTGGAGCAT | 417 | GAGCTGAGCATCGGTAAATT | 418 |
| | | TG | | CC | |
| 210 | DCCex04.2 | CAGCTGTATTTTCTGCAA | 419 | AACACAACATTCCAGGACAG | 420 |
| | | AGACCAT | | CA | |
| 211 | DCCex05.1 | TGACAGATGATGACAGTG | 421 | TGCAGAGGCACTAATATTCT | 422 |
| | | GAATGT | | CATTTT | |
| 212 | DCCex06.2 | TGAGTTTGAATGTACAGT | 423 | CACTAGGAATGACCACATCT | 424 |
| | | CTCTGGAA | | COAT | |
| 213 | DCCex07.2 | AGGAAGCAACTTACGGAT | 425 | CAGCCTCATTTTCAGCCACA | 426 |
| | | ACTTGG | | C | |
| 214 | DCCex09.1 | TCACTGTGGGAAACCTGA | 427 | CCGGTCCCCATTCATTGTAA | 428 |
| | | AGC | | | |
| 215 | DCCex11.1 | GACTATCTTATAAACTGG | 429 | GCCCGGACCATAGCGATTA | 430 |
| | | AAGGCCTGAA | | | |
| 216 | DCCex13.1 | GCCTCCTCCATCAGGAAC | 431 | TGCGGGTCGTCTTTCTGTG | 432 |
| | | AC | | | |
| 217 | DCCex14.2 | AAAGGAAGTCAGTACAGT | 433 | CTCTGCAGTATACCAGTTGG | 434 |
| | | TTCCAGGT | | AAGGT | |
| 218 | DCCex15.1 | TTCATGTGAGGCCCCAGA | 435 | CACCACGATGTTTGGGTTCA | 436 |
| | | CT | | | |
| 219 | DCCex16.1 | CAAGTTCCCATTATGTAA | 437 | ACCTGGTGGTGGCACTTTCA | 438 |
| | | TCTCCCTAA | | | |
| 220 | DCCex17.1 | TCCCACTGACCCAGTTGA | 439 | GGGTGGAGAGATCTGGGACC | 440 |
| | | TTATTAT | | | |
| 221 | DCCex19.1 | CACCTCTGCTCCCAAGGA | 441 | GAGGCTGCCAACTCACAATG | 442 |
| | | CTT | | A | |
| 222 | DCCex20.1 | CCAATTGATGACTGGATT | 443 | AGGTTGAGATCCATGATTTG | 444 |
| | | ATGGAA | | ATGA | |
| 223 | DCCex22.1 | GTCGTCATGGAGATGGAG | 445 | ATTTAGGGTGCTTCTATCAA | 446 |
| | | GTTATT | | TCAAATTAGTAT | |
| 224 | DCCex25.1 | ACTGAGGAAGCAGGGAGC | 447 | CATCCATGGGAATCATGAGC | 448 |
| | | TCTA | | TT | |
| 225 | DCCex26.2 | CGGTGCCAACGCTAGAAA | 449 | AGGCCGGAGAGTGAACTGC | 450 |
| | | G | | | |
| 226 | DCCex27.2 | CAGAACCATCCCCACAGC | 451 | CATTGGTGGAGGTAGCAAAG | 452 |
| | | TT | | G | |
| 227 | DCCex28.1 | ACCCATGTGAAAACAGCC | 453 | GGCACAGACACAGGAAGCAA | 454 |
| | | TCC | | A | |
| 228 | DCCex29.2 | GCACACCTGTGTCCAAGA | 455 | GCTTTTGTTTAGGGAACTCA | 456 |
| | | ACTCTA | | TAATCAT | |
| 229 | KRASex03.2 | ATTCCTACAGGAAGCAAG | 457 | GTACTGGTCCCTCATTGCAC | 458 |
| | | TAGTAATTGA | | TGTA | |
| 230 | KRASex04.2 | GGAAATAAATGTGATTTG | 459 | TGTCTTGTCTTTGCTGATGT | 460 |
| | | CCTTCTAGAA | | TTCAA | |
| 231 | KRASex05.1 | GTGGAGGATGCTTTTTAT | 461 | TCACACAGCCAGGAGTCTTT | 462 |
| | | ACATTGGT | | TCT | |
| 232 | KRASex06.1 | CACCCACCTTGGCCTCAT | 463 | TGGCATCTGGTAGGCACTCA | 464 |
| | | AA | | | |
| 233 | MLH1ex01.2 | CGTTCGTGGCAGGGGTTA | 465 | AGCTGGCCGCTGGATAACTT | 466 |
| | | T | | | |
| 234 | MLH1ex02.1 | GCAAAATCCACAAGTATT | 467 | GATCCCGGTGCCATTGTCTT | 468 |
| | | CAAGTGATT | | | |
| 235 | MLH1ex03.1 | GATCTGGATATTGTATGT | 469 | CCATAGGTAGAAATACTGGC | 470 1 |
| | | GAAAGGTTCA | | TAAATCCT | |
| 236 | MLH1ex04.1 | AGCATAAGCCATGTGGCT | 471 | ATGCACACTTTCCATCAGCT | 472 |
| | | CAT | | GTT | |
| 237 | MLH1ex05.1 | GCAAGTTACTCAGATGGA | 473 | GATCTGGGTCCCTTGATTGC | 474 |
| | | AAACTGAA | | | |
| 238 | MLH1ex06.1 | TTTTACAACATAGCCACG | 475 | CAACAACTTCCAAAATTTTC | 476 |
| | | AGGAGAA | | CCATA | |
| 239 | MLH1ex08.1 | AGAGACAGTAGCTGATGT | 477 | CATTTCCAAAGATGGAGCGA | 478 |
| | | TAGGACACTAC | | A | |
| 240 | MLH1ex09.1 | ACTGATAGAAATTGGATG | 479 | TCTTCACTGAGTAGTTTGCA | 480 |
| | | TGAGGATAAAA | | TTGGATA | |
| 241 | MLH1ex10.1 | TCGTCTGGTAGAATCAAC | 481 | GGCAAATAGGCTGCATACAC | 482 |
| | | TTCCTTG | | TGTT | |
| 242 | MLH1ex12.1 | CAGGGCTAGGCAGCAAGA | 483 | TCTGATTTTTGGCAGCCACT | 484 |
| | | TG | | T | |
| 243 | MLH1ex13.2 | GAAAGGAAATGACTGCAG | 485 | CTCATGTCCCTGCTCATTAA | 486 |
| | | CTTGT | | TTTCTT | |
| 244 | MLH1ex14.2 | CCTTCGTGGGCTGTGTGA | 487 | GCTTGGTGGTGTTGAGAAGG | 488 |
| | | A | | TATAA | |
| 245 | MLH1ex15.1 | TGAAGAACTGTTCTACCA | 489 | CGATAACCTGAGAACACCAA | 490 |
| | | GATACTCATTTA | | AATTG | |
| 246 | MLH1ex16.1 | AGCACCGCTCTTTGACCT | 491 | GGGACCATCTTCCTCTGTCC | 492 |
| | | TG | | A | |
| 247 | MLH1ex17.1 | GAAGGGAACCTGATTGGA | 493 | GAAGATAGGCAGTCCCTCCA | 494 |
| | | TTACC | | AA | |
| 248 | MLH1ex18.1 | TGAATTGGGACGAAGAAA | 495 | TGCTTCCGGATGGAATAGAA | 496 |
| | | AGGAAT | | CA | |
| 249 | MLH1ex19.2 | TAAAGCCTTGCGCTCACA | 497 | CAGGTTAGCAAGCTGCAGGA | 498 |
| | | CA | | T | |
| 250 | MSH2ex01.2 | GGAAACAGCTTAGTGGGT | 499 | ACCGCCATGTCGAAACCTC | 500 |
| | | GTGG | | | |
| 251 | MSH2ex02.1 | TCTTCTGGTTCGTCAGTA | 501 | CATTCTCCTTGGATGCCTTA | 502 |
| | | TAGAGTTGA | | TTTC | |
| 252 | MSH2ex01.2 | TCCTGGCAATCTCTCTCA | 503 | CAACACCAATGGAAGCTGAC | 504 |
| | | GTTTG | | AT | |
| 253 | MSH2ex04.1 | CAAAGAGGAGGAATTCTG | 505 | TTGAGGTCCTGATAAATGTC | 506 |
| | | ATCACA | | TTTTGT | |
| 254 | MSH2ex05.1 | CAGTTTCATCACTGTCTG | 507 | CAGTTCAAACTGTCCAAAGT | 508 |
| | | CGGTAA | | TGGAA | |
| 255 | MSH2ex06.2 | GCTGAATAAGTGTAAAAC | 509 | CTTATCCATGAGAGGCTGCT | 510 |
| | | CCCTCAAG | | TAATC | |
| 256 | MSH2ex07.1 | GGAAGCTTTTGTAGAAGA | 511 | GATCTGGGAATCGACGAAGT | 512 |
| | | TGCAGAA | | AAAT | |
| 257 | MSH2ex08.1 | ACACCAGAAATTATTGTT | 513 | TAAAGTTGTTTCTATCATTT | 514 |
| | | GGCAGTT | | CCTGAAACTT | |
| 258 | MSH2ex09.2 | AACCATGAATTCCTTGTA | 515 | AAGTCATTCATTATTTCTCT | 516 |
| | | AAACCTTC | | TAATTCACTGA | |
| 259 | MSH2ex10.2 | GCACAGTTTGGATATTAC | 517 | CAGTACTAAAGTTTTTATTG | 518 |
| | | TTTCGTGT | | TTACGAAGGACT | |
| 260 | MSH2ex11.1 | AAATTGACTTCTTTAAAT | 519 | TGAAGAAATATTGACAATTT | 520 |
| | | GAAGAGTATACCAAA | | CTTTAACAATG | |
| 261 | MSH2ex12.2 | TGTAGAACCAATGCAGAC | 521 | ACACGTGAGCAAAGCTGACA | 522 |
| | | ACTCAA | | A | |
| 262 | MSH2ex13.1 | GCCCCAATATGGGAGGTA | 523 | CCCAATTTGGGCCATGAGTA | 524 |
| | | AATC | | | |
| 263 | MSH2ex14.1 | GGAACTTCTACCTACGAT | 525 | GCACCAATCTTTGTTGCAAT | 526 |
| | | GGATTTG | | GT | |
| 264 | MSH2ex15.2 | GATTCATGTTGCAGAGCT | 527 | GTTCCAGGGCTTTCTGTTTA | 528 |
| | | TGCT | | GC | |
| 265 | MSH2ex16.2 | ACAAATGCCCTTTACTGA | 529 | ATTCTTTGCTATTACTTCAG | 530 |
| | | AATGTCA | | CTTTTAGCT | |
| 266 | MSH6ex01.2 | TGTACAGCTTCTTCCCCA | 531 | AGGCCTTGTTGGCATCACTC | 532 |
| | | AGTCT | | | |
| 267 | MSH6ex02.1 | TGGTGGCCTTGTCTGGTT | 533 | GCGGATGAATGTTCCATCAA | 534 |
| | | TAC | | A | |
| 268 | MSH6ex01.1 | GCTCTCAGTATTTCAGGC | 535 | AGCCCAGAAGGGAGGTCATT | 536 |
| | | TTTGC | | | |
| 269 | MSH6ex04.2 | CCCAGGTGCTTAAAGGTA | 537 | GGTGTCAACCCAATGGAATC | 538 |
| | | TGACTT | | A | |
| 270 | MSH6ex05.2 | GGAAGAGGAGCAGGAAAA | 539 | TTGGTCCAGTAACAAGCACA | 540 |
| | | TGG | | CAA | |
| 271 | MSH6ex062 | GTAAACACTCTATCAATT | 541 | GTTACGTCCCTGCTGAAGTG | 542 |
| | | GGTGTGAGC | | TG | |
| 272 | MSH6ex07.1 | TTGAATTAAGTGAAACTG | 543 | ATTCATCCACAAGCACCAGA | 544 |
| | | CCAGCATA | | GAAT | |
| 273 | MSH6ex08.1 | ACATTTGATGGGACGGCA | 545 | CTCAGCAAGTTCTTTAACAA | 546 |
| | | AT | | CTGCA | |
| 274 | MSH6ex09.2 | GGCTTGCTAATCTCCCAG | 547 | TTGCTTTTCTATGTCCCTTT | 548 |
| | | AGG | | TGAA | |
| 275 | MSH6ex10.2 | TGTTGT CTGAATTTACCA | 549 | CATTGGAAGCTTTGAGTTGA | 550 |
| | | CCTTTGTC | | CTTCT | |
| 276 | MTORex02 2 | GGGCAAGATGCTTGGAAC | 551 | CTTTAGGCCACTGGCAAACT | 552 |
| | | C | | G | |
| 277 | MTORex03.1 | CGCTTCTATGACCAACTG | 553 | GCCAAGATGCCACCTTTCCT | 554 |
| | | AACCAT | | | |
| 278 | MTORex04.1 | CAGATTTGCCAACTATCT | 555 | CCTTGGATGCCATTTCCATG | 556 |
| | | TCGGA | | | |
| 279 | MTORex05.1 | CCATCAGCGTCCCTACCT | 557 | CCACACGGCCACAAAAATG | 558 |
| | | TCT | | | |
| 280 | MTORex06.2 | GGATTTGATGAGACCTTG | 559 | CCAGCTCGTTAAGGATCAAC | 560 |
| | | GCC | | AA | |
| 281 | MTORex07.2 | TGAGAGAAGAAATGGAAG | 561 | AGCCCATGAGATCTTTGCAG | 562 |
| | | AAATCACA | | TACT | |
| 282 | MTORex08.2 | CAGTGGGTGCTGAAATGC | 563 | GGCAACAAATTAAGGATTGT | 564 |
| | | A | | CATTT | |
| 283 | MTORex09.2 | GTACAGCGGCCTTCCAAG | 565 | GCGAGGCAAATAGACCTTAA | 566 |
| | | C | | ACTC | |
| 284 | MTORex10.1 | CAGTCTTCACTTGCATCA | 567 | TCCAGCAGCTCCTTGATATC | 568 |
| | | GCATG | | CT | |
| 285 | MTORex11.1 | GCCGTCAGATTCCACAGC | 569 | CATAAGGA.CCAGGGACAGCA | 570 |
| | | TAA | | TT | |
| 286 | MTORex12.1 | CACCCTCCATCCACCTCA | 571 | ATCTGCCACCACTTGCACTG | 572 |
| | | TC | | | |
| 287 | MTORex13.2 | CCTGGACGAGCGCTTTGA | 573 | GGTCATTCAGAGCCACAAAC | 574 |
| | | T | | AA | |
| 288 | MTORex14.2 | AGAGTTGGAGCACAGTGG | 575 | CATTGGAGACCAGGTGCCC | 576 |
| | | GATT | | | |
| 289 | MTORex15.1 | CATTAATTTTGAAACTGA | 577 | TGTTGCCAGGACATTATTGA | 578 |
| | | AAGATCCAGA | | TCAC | |
| 290 | MTORex16.1 | TTAGTGGCCTGGAAATGA | 579 | GGAATCCTGGAGCATGTCCA | 580 |
| | | GGAA | | T | |
| 291 | MTORex17.2 | GACAGTTGGTGGCCAGCA | 581 | GGTTCTGCTCAGTCTTCAGA | 582 |
| | | CT | | AAATT | |
| 292 | MTORex18.2 | CCATCCGTGTGTTAGGGC | 583 | GTCTATCATGCCAATGTTCA | 584 |
| | | TT | | CTTTG | |
| 293 | MTORex19.1 | TCCCTGGGACTCAAATGT | 585 | CAGACTCGAATGACGTTAAG | 586 |
| | | GTG | | GAAC | |
| 294 | MTORex20.2 | CAGCAGCTGGGAATGTTG | 587 | TGACTATTTCATCCATATAA | 588 |
| | | GT | | GGTCTGATGT | |
| 295 | MTORex21.1 | CTGGGTCATGAACACCTC | 589 | CCCCAAGAGCTACCACAATT | 590 |
| | | AATTC | | TG | |
| 296 | MTORex22,2 | TGCAATCCAGCTGTTTGG | 591 | ACAACTTAACAATAGGAGGC | 592 |
| | | C | | AGCA | |
| 297 | MTORex23.1 | TGACTATGCCTCCCGGAT | 593 | CTGTGGAGCGCAGTTCTGG | 594 |
| | | CA | | | |
| 298 | MTORex24.1 | GGTGAATAAAGTTCTGGT | 595 | ACAATTCTGCAGATGAGCAC | 596 |
| | | GCGAC | | ATC | |
| 299 | MTORex25.2 | ACACTTGCTGATGAAGAG | 597 | CTGGTCCACTAGCCAATGCA | 598 |
| | | GAGGAT | | T | |
| 300 | MTORex26.2 | GCCAGGAGGGTCTCCAAA | 599 | GGGCGATGATGAGTCCTTCA | 600 |
| | | G | | | |
| 301 | MTORex27.2 | TCTCTTCAATGCTGCATT | 601 | TCGATGCTTCTGATGAGCTC | 602 |
| | | TGTGT | | A | |
| 302 | MTORex28.1 | GCATTGTTCTGCTGGGTG | 603 | TCCAGTTCTTTGTAGTGTAG | 604 |
| | | AGA | | TGCTTTG | |
| 303 | MTORex29.1 | TAATAATAAGCTACAGCA | 605 | CAGCTCTCCAAAGTGTTTCA | 606 |
| | | GCCGGA | | TGG | |
| 304 | MTORex30.1 | GATCCAGGCTACCTGGTA | 607 | CCATTTTCTTGTCATAGGCC | 608 |
| | | TGAGA | | ACA | |
| 305 | MTORex32.2 | GTCAGTGGGACAGCATGG | 609 | CAGCTCTATAAAATGCCCCA | 610 |
| | | AA | | TCAT | |
| 306 | MTORex33.1 | GGACCTGCTGGATGCTGA | 611 | ATATGCCCGACTGTAACTCT | 612 |
| | | ATT | | CTCCT | |
| 307 | MTORex34.2 | GCCATGGTTTCTTGCCAC | 613 | CGGATGATCTCTCGTCGCTC | 614 |
| | | AT | | | |
| 308 | MTORex35.2 | AGAGGACTGGCAGAAAAT | 615 | GAGCCAGGTTCTCATGTCTT | 616 |
| | | CCTTATG | | CAT | |
| 309 | MTORex36.2 | TCCTGGGAGTTGATCCGT | 617 | CACATGTTTTTCATGTAGGC | 618 |
| | | CT | | ATAGGT | |
| 310 | MTORex37.1 | ATGCCTTCCAGCACATGC | 619 | CTGCTGGTCCTCAGTAGCGA | 620 |
| | | A | | T | |
| 311 | MTORex38.2 | ATGCTTCCTGAAACTTGG | 621 | GCGGCGCTGTAGTACTGCA | 622 |
| | | AGAGTG | | | |
| 312 | MTORex39.1 | CTTCGAAGCTGTGCTACA | 623 | TGGCATGACGCAGTTTCTTC | 624 |
| | | CTACAAA | | T | |
| 313 | MTORex40.1 | TCCAAAACCCTCCTGATG | 625 | CCTCGTGACAAGGAGATGGA | 626 |
| | | TACA | | AC | |
| 314 | MTORex41.1 | GTTCTCACCTTATGGTTT | 627 | GGCTTTCACCCCCTCCACTA | 628 |
| | | GATTATGG | | | |
| 315 | MTORex42.1 | ACCTCAGCTCATTGCAAG | 629 | CTGTGAGAAGCTGGTGAATG | 630 |
| | | AATTG | | AGA | |
| 316 | MTORex43.2 | CCCTCATCTACCCACTGA | 631 | GAATCTTGTTGGCTGCATTG | 632 |
| | | CAGTG | | TG | |
| 317 | MTORex44.1 | GGCCTGGAAGAGGCATCT | 633 | GGCTCCAGCACCTCAAACAT | 634 |
| | | C | | | |
| 318 | MTORex45.1 | GCCTATGGTCGAGATTTA | 635 | TCCTTGACATTCCCTGATTT | 636 |
| | | ATGGA | | CAT | |
| 319 | MTORex46.2 | TCACATCCTTAGAGCTGC | 637 | CCTGGCACAGCCAATTCAA | 638 |
| | | AATATGT | | | |
| 320 | MTORex47.2 | CAGCAACGGACATGAGTT | 639 | CTGCATCACACGCTCATCCT | 640 |
| | | TGTT | | | |
| 321 | MTORex48.2 | GACCAACTCGGGCCTCAT | 641 | GCTCGATGTTGAGAAGGATC | 642 |
| | | T | | TTCT | |
| 322 | MTORex49.1 | CTCCGGACTATGACCACT | 643 | AGCTGTATTATTGACGGCAT | 644 |
| | | TGACT | | GCT | |
| 323 | MTORex50.1 | CGAAGAACCAATTATACC | 645 | CAGGCCTAAAATATACCCAA | 646 |
| | | CGTTCTT | | CCA | |
| 324 | MUTYHex01.2 | GTGGCTAGTTCAGGCGGA | 647 | GGCCTCGGGCTCATAGTTCT | 648 |
| | | AG | | A | |
| 325 | MUTYHex02.1 | GGCCTGACTGTTGTTCTT | 649 | GTCACAGGAAGCAGGCAGC | 650 |
| | | AGCAT | | | |
| 326 | MUTYHex03.2 | CCGGAAGAGGTGGTATTG | 651 | CAGCTACGTCTCTGAATAGA | 652 |
| | | CA | | TGGTATG | |
| 327 | MUTYHex05.1 | AGAGGTCATGCTGCAGCA | 653 | CTGCATCCATCCGGTATAGT | 654 |
| | | GA | | AGTTG | |
| 328 | MUTYHex08.1 | CCAAAGGCGATAGAGGCA | 655 | CACATGCCACGTACAGCAGA | 656 |
| | | ATG | | GA | |
| 329 | MUTYHex09.1 | TGTGGTGGATGGCAACGT | 657 | CTGGGATCAGCACCAATGG | 658 |
| | | AG | | | |
| 330 | MUTYHex10.2 | GTCTAGCCCAGCAGCTGG | 659 | TAGCTCCATGGCTGCTTGG | 660 |
| | | TG | | | |
| 331 | MUTYHex11.1 | CACACTCCTCCACGTCAG | 661 | GTGGAGCAGGAACAGCTCTT | 662 |
| | | GACT | | AGC | |
| 332 | MUTYHex12.2 | AGACCCTGGGAGTGGTCA | 663 | TCCAGAACACAGGTGGCAGA | 664 |
| | | ACTT | | | |
| 333 | MUTYHex13.1 | CTTGCGCTGAAGCTGCTC | 665 | CTGGCAGGACTGTGGGAGTT | 666 |
| | | T | | | |
| 334 | MUTYHex14.1 | AGACCCCAGTGACCACCG | 667 | GTGTGAAATTCCTCCTGCGT | 668 |
| | | TA | | C | |
| 335 | MUTYHex16.1 | TCGGTCTCACATCTCCAC | 669 | TCAGAGGTGTCACTGGGCTG | 670 |
| | | TGAT | | | |
| 336 | PMS2ex01.1 | AGCCAATGGGAGTTCAGG | 671 | TCGCTCCATGGATGCAACA | 672 |
| | | AG | | | |
| 337 | PMS2ex02.1 | CCTGCTAAGGCCATCAAA | 673 | GCAAATCTGATGGACTGACT | 674 |
| | | CC | | TCC | |
| 338 | PMS2ex03.1 | TTAAGGACTATGGAGTGG | 675 | CCCCACATCCATTGTCTGAA | 676 |
| | | ATCTTATTGA | | A | |
| 339 | PMS2ex04.1 | TGAAACATCACACATCTA | 677 | CAACCTGAGTTAGGTCGGCA | 678 |
| | | AGATTCAAGA | | A | |
| 340 | PMS2ex05.1 | CACAGTCAGCGTGCAGCA | 679 | TCCTTATGGCGCACAGGTAG | 680 |
| | | GT | | T | |
| 341 | PMS2ex06.2 | AAAATGGTCCAGGTCTTA | 681 | ACGGATGCCTGCTGAAATG | 682 |
| | | CATGC | | | |
| 342 | PMS2ex07.2 | CTCTTCACACACGGAGTC | 683 | AGCCTCATTCCTTTTGTTCA | 684 |
| | | ACTAGG | | GC | |
| 343 | PMS2ex08.1 | GCCGGTTGATAAAGAAAA | 685 | ATGGAGTTGGAAGGAGTTCA | 686 |
| | | ACTGTCT | | ACA | |
| 344 | PMS2ex09.2 | GTTAAGAACAACAAATGG | 687 | CTGCAGACTCGTGAATGAGG | 688 |
| | | ATACTGGTG | | TCTA | |
| 345 | PMS2ex10.2 | AAGCTTTTGTTGGCAGTT | 689 | ACTGACATTTAGCTTGTTGA | 690 |
| | | TTAAAGA | | CATCACTA | |
| 346 | PMS2ex11.1 | CGAGAGGCCTTTTCTCTT | 691 | TGGGCTGTGAGGCTTGTTCT | 692 |
| | | CGT | | | |
| 347 | PMS2ex12.2 | AAACGATGTTTGCAGAAA | 693 | TAAATCCCAGGTTAAACTGA | 694 |
| | | TGGA | | CCAAT | |
| 348 | PMS2ex13.1 | AGCTGTTCTGATAGAAAA | 695 | CAAAATCAAAGCCATTCTTT | 696 |
| | | TCTGGAAAT | | CTAAATATT | |
| 349 | PMS2ex14.2 | AAGGGCTAAACTGATTTC | 697 | GGTCCGAAGGTCCAGTTTTT | 698 |
| | | CTTGC | | ACT | |
| 350 | PMS2ex15.2 | TTGGGACTGCTCTTAACA | 699 | CCATGTGGGTGATCAGTTTC | 700 |
| | | CAAGC | | TTC | |
| 351 | PPP2R1AEx01.2 | CTTCCTTCTTCTCCCAGC | 701 | TCCGTCCCTTTCCTGTCAGA | 702 |
| | | ATTG | | | |
| 352 | PPP2R1AEx02.1 | CGCCTCAACAGCATCAAG | 703 | GCTCACTTCGGGTCCTTTCA | 704 |
| | | AA | | A | |
| 353 | PPP2R1AEx03.2 | ATCTATGATGAAGATGAG | 705 | CCTCCCACCAGGGTAGTGAA | 706 |
| | | GTCCTCCT | | G | |
| 354 | PPP2R1AEx04.1 | GGACAAGGCAGTGGAGTC | 707 | GCTTCACTAGCGGCACAAAG | 708 |
| | | CTTA | | T | |
| 355 | PPP2R1AEx05.2 | TCAGATGACACCCCCATG | 709 | ATGATCTCACTCTTGACGTT | 710 |
| | | GT | | GTCC | |
| 356 | PPP2R1AEx06.1 | CCAGGCCGCTGAAGACAA | 711 | GTGAACTTGTCAGCCACCAT | 712 |
| | | GT | | GTA | |
| 357 | PPP2R1AEx07.2 | GCAGTGGGGCCTGAGATC | 713 | GCCTCACAGTCTTTCATCAG | 714 |
| | | A | | GTT | |
| 358 | PPP2R1AEx08.2 | TGTGAAAACCTCTCAGCT | 715 | CAGGGCAAGATCTGGGACAT | 716 |
| | | GACTGT | | | |
| 359 | PPP2R1AEx09.2 | CTGCCCTGGCCTCAGTCA | 717 | CAAGAGGTGCTCGATGGTGT | 718 |
| | | T | | T | |
| 360 | PPP2R1AEx10.1 | TGGACTGTGTGAACGAGG | 719 | TCCTCAGCCAGCTCCACAAT | 720 |
| | | TGAT | | | |
| 361 | PPP2R1AEx11.1 | GAGTGGAGTTCTTTGATG | 721 | GATCCACAAGCCAGGCCAT | 722 |
| | | AGAAACTTAA | | | |
| 362 | PPP2R1AEx12.2 | AAGTTTGGGAAGGAGTGG | 723 | ATGCGGTGCAGGTAGTTGG | 724 |
| | | GC | | | |
| 363 | PPP2R1AEx13.2 | GCACATGCTACCCACGGT | 725 | CAGAGACTTGGCCACATTGA | 726 |
| | | T | | AG | |
| 364 | PPP2R1AEx14.2 | AAGCCCATCCTAGAGAAG | 727 | GAGCCTCCTGGGCAAAGTAT | 728 |
| | | CTGA | | TTT | |
| 365 | PPP2R1AEx15.1 | GGTTGGACAGGACAGTGA | 729 | TACAGCAGCAGGATCCAGTG | 730 |
| | | CCTT | | A | |
| 366 | TP53ex01.1 | GTTTTCCCCTCCCATGTG | 731 | GACGGTGGCTCTAGACTTTT | 732 |
| | | CT | | GAG | |
| 367 | TP53ex02,1 | AGACTGCCTTCCGGGTCA | 733 | ATAGGTCTGAAAATGTTTCC | 734 |
| | | CT | | TGACTCA | |
| 368 | TP53ex04.2 | TCCCCGGACGATATTGAA | 735 | GAGCAGCCTCTGGCATTCTG | 736 |
| | | CA | | | |
| 369 | TP53ex05.1 | CCCTGCCCTCAACAAGAT | 737 | GTGTGGAATCAACCCACAGC | 738 |
| | | GT | | T | |
| 370 | TP53ex06.1 | GCCCCTCCTCAGCATCTT | 739 | AAAGTGTTTCTGTCATCCAA | 740 |
| | | ATC | | ATACTCC | |
| 371 | TP53ex08.2 | TCTACTGGGACGGAACAG | 741 | GCGGAGATTCTCTTCCTCTG | 742 |
| | | CTTT | | TG | |
| 372 | TP53ex09.1 | CCCAACAACACCAGCTCC | 743 | GGTGAAATATTCTCCATCCA | 744 |
| | | TCT | | GTGGT | |
| 373 | TP53ex10.1 | CGTGAGCGCTTCGAGATG | 745 | TGGGCATCCTTGAGTTCCAA | 746 |
| | | TT | | | |

3. Validation of Non-Tumor Derived gDNA as a Reliable Source of ECNV Profiling

In this example, genomic DNA sample from non-cancerous cells from C57BL/6J mice were used to demonstrate the utility of using non-tumor derived gDNA as a reliable source of ECNV profiling.

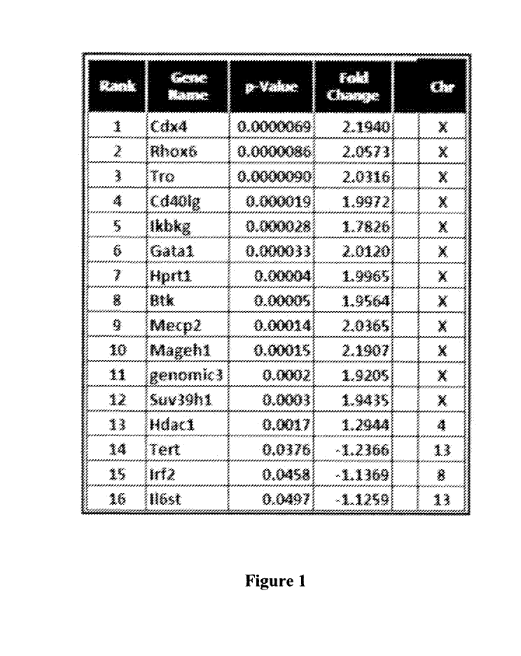

As shown in FIG. 1, individual genomic DNA (gDNA) samples (biological replicates) were analyzed from five male C57BL/6J and five female C57BL/6J mice using the 384-well Lymphoma and Leukemia StellARray™ (Lonza Prod. ID—00188203). This StellARray™ has a total of 12 targets on the mouse X chromosome, consisting of 11 genes and our intergenic genomic control (genomic3). For these 12 targets, the expected CNV is two-fold due to the females having 2 copies of the X chromosome and males having only one. Of the 384 targets queried, it was expected that GPR™ analysis would rank the twelve X-linked genes the highest (p≦0.05) with a fold-change of 2.0. Sixteen (16) genes were determined to be significantly different with the expected X-chromosome genes ranked as the top 12 having a fold-change value near 2.0 (Mean Fold Change X Chr.=2.01 and Standard Deviation=0.11). An additional 4 genes, ranked the lowest, are not located on the X-chromosome. Assuming there are no unknown sex-specific differences for Hdacl, Tert, Irf2, and I16st, then GPR™ identified 4 of 384 targets incorrectly thus generating only 1.0% as false positives. This result demonstrates the utility of GPR™ for the detection and quantification of CNV's.

4. ECNV Profiling for Colorectal Cancer Risk Assessment

To evaluate the utility of GPR™-based analysis with ECNV in humans, we chose to apply this approach to determine if there is an ECNV profile associated with individuals in families with members diagnosed with Colorectal Cancer (Polyp score=5 [P5-CRC]) and those with varying stages of polyps (P1-P4). It would be valuable to provide a precise metric that defines individuals' risk of developing CRC, a severity level index (metastatic vs. non-metastatic, predicted age of onset), and a predictor of the therapeutic interventions/outcomes. Additionally, a pre-diagnostic risk assessment test could provide rationale for proactive measures to prevent or minimize CRC onset and severity.

Two families (K5275 and K6694) were analyzed using qPCR on blood-derived genomic DNA (gDNA) and a target set of 373 exon-specific reactions representing 25 genes. Each individual's Cq values were collated into a single file as quadruplicates and analyzed via GPR™. Control samples were defined as those with a polyp score of P0, P1, and P2, in addition to samples with no data regarding polyp status thus yielding thirty-two (32) individuals as the control group for K5275 and the remaining eight (8) individuals have polyp scores of P3, P4, or P5 (CRC). K6694 samples were grouped similarly except that there were no known cases of P5 (CRC).

GPR™ results (raw data not shown) were utilized as input into a hierarchical cluster analysis algorithm (R-Project, http://www.r-project.org/) after filtering the data to include only those targets with a p-Value ≦0.05 in at least one sample and a fold change value ≧1.5. Shown in FIG. 3 is a heat-map for eight individuals from K5275 with patterned boxes representing decreased and increased fold change. Interestingly, the two individuals known to be P5 clustered to opposite sides of the group, with decreasing polyp scores toward the center. Sample P5.35 (far left) has an ECNV profile comprising seven exons (out of 43) that had a statistically significant decrease in copy numbers, as compared to control; sample P5.61 has an ECNV profile comprising twenty-five (out of 43) that had a statistically significant increase in copy numbers, as compared to control. Additionally, there was no overlap of the ECNV profiles between these two individuals. The samples with P3 or P4 scores appear to have unique profiles. It is also interesting that the clustering positioned the P4 (most severe polyp scores) next to the two P5 samples.

Subsequent to the GPR™/cluster analysis, we characterized the phenotypic information regarding the two P5 samples. Significantly, both P5.35 patient and P5.61 patient were confirmed CRC diagnoses, but with very different outcomes. Patient P5.35 was an early onset (age 35) patient with fatal metastatic CRC, while the P5.61 patient was a late onset patient (age 61) with non-metastatic CRC that was successfully treated, and was clear of CRC/polyps eleven years post-treatment. Thus these two different ECNV profiles demonstrate that ECNV profiles correlate with the onset, progression, severity, or treatment outcome of CRC. Additionally, the ECNVs were derived from “normal” gDNA samples, i.e. peripheral blood (not from tumor/affected tissues).

It should be noted that analysis of K6694 yielded no significantly different ECNV's when analyzed under the same parameters as was used for K5275 and that of the thirty-nine K6694 samples there were no P5 (CRC) samples included.

It has been suggested that there exists a possibility of detecting tumor-derived cells in the peripheral blood and thus these cells are the source the observed gDNA changes via GPR™ and reflect the unique genomic structure in the tumors. This is highly unlikely, and we have successfully identified ECNV's using buccal cell gDNA in the context of families with individuals having Systemic Lupus Erythematosus or Irritated Bowel Syndrome (see, Example 2).

With the generation of additional ECNV profiles associated with CRC (either blood derived or other) and other diseases, a comprehensive library of profiles can be developed providing a searchable database of patterns enabling the generation of disease risk/severity indices along with possible predictors of appropriate therapeutic intervention. As usual, risk assessment evaluations prior to the onset of overt disease could augment the rationale for increased vigilance serving as a means for early detection and maximizing positive therapeutic outcomes.

In summary, in this example, we successfully combined the analysis of exon-specific qPCR targets with GPR™ and hierarchical cluster analysis providing informative exon-by-exon CNV profiles (ECNV's) associated with Colorectal Cancer in human subjects using non-tumor genomic DNA. The detection of ECNV's contributes to the expansion of detectable genetic variability markers and results in an improvement in current disease association studies. ECNV profiles, as risk assessment evaluations prior to the onset of disease, can augment the rationale for increased vigilance serving as a means for early detection and maximizing positive therapeutic outcomes.

### Example 2

### ECNV Profiling for Autoimmune Disease Risk Assessment

1. ECNV Profiling of Systemic Lupus Erythematosus in Mouse Models

In this example, ECNV profiles were created for autoimmune disease risk assessment. ECNVs of exons of marker genes Mid1, Mid2, and PPP2R1A were studied using mouse models of systemic lupus erythematosus (SLE or lupus).

The StellARray™ qPCR array system (Lonza, Switzerland) was used to verify multi-gene copy number polymorphisms in two strains of mice, BXSB and MRL. Both strains are known to be susceptible to lupus, although the severity and the rapidity of onset of lupus are different between the two.

Mice of the BXSB strain develop spontaneous autoimmune disease, systemic lupus erythematosus (SLE), characterized by moderate lymph node and spleen enlargement, hemolytic anemia, hypergammaglobulinemia, and immune complex glomerulonephritis. The disease process in BXSB is strikingly accelerated in males, which live little more than a third as long as females. The acceleration is due to the presence of the Yaa transposon on the Y chromosome. However, C57BL/6J mice carrying the Yaa transposon do not demonstrate this autoimmune disease, and are indistinguishable from wild-type controls. This suggests that the Yaa transposon may not be sufficient to induce accelerated autoimmunity unless present on a susceptible genetic background.

The MRL mouse can development a disease recognized as Lupus but the defined mechanism is known as the lpr mutation of the Fas gene.

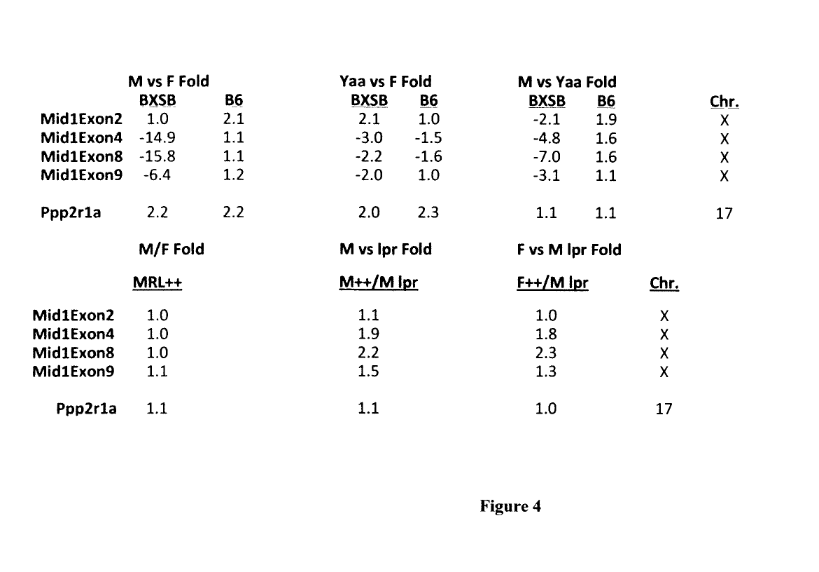

As shown in the FIG. 4, it was discovered that BXSB mice has significant copy number variations for Mid1 exons 2, 4, 8 and 9. Interestingly, it was found the MRL mouse also has Mid1 exon variations strongly suggesting the Mid1 and Fas were mutated in this mouse line which leads to Lupus.

Additional information about Mid1 function suggests that Mid1 regulates rapamycin sensitive signaling through alpha4 protein. Mid1 is also known to be signal transduction molecule which co-precipitates with the B-cell receptor and plays a role in the antigen induced signaling during B-cell activation.

Transposition of the X-linked genes on the Y chromosome in BXSB mice contributes to a Yaa Phenotype. The rapamycin resistance of Yaa B-cells, the known role of this pathway in B-cell receptor (BCR) stimulation, and the protective effects of rapamycin on SLE supports a significant role for Mid1 .

The C57BL/6J (B6) strain is typically identified as being “resistant” to SLE but there is data suggesting a very late onset of SLE when B6 has the Yaa mutation. B6 has a lower level of Mid1 exon variations.

This data indicated an association of Mid1 exon copy number variation not only to disease lupus, but also to severity/onset of lupus because the BXSB mice, with most severe symptoms of lupus, had the highest copy number variations for Mid1 exons.

This data strongly demonstrates that copy number variation of Mid1 Exons is associated with absence/presence and severity/onset of systemic lupus erythematosus (SLE).

2. ECNV Profiling of Systemic Lupus Erythematosus in Two Families

In this example, ECNV profiles were created for autoimmune disease risk assessment. The exon copy number variations of exons of marker genes Mid1, Mid2 and PPP2R1A were studied in two families that included persons who were diagnosed with systemic lupus erythematosus (SLE) and an unaffected person.

Systemic lupus erythematosus (SLE) is a chronic autoimmune disease that can affect any part of the body. As occurs in other autoimmune diseases, the immune system attacks the body's cells and tissue, resulting in inflammation and tissue damage. SLE most often harms the heart, joints, skin, lungs, blood vessels, liver, kidneys, and nervous system. The course of the disease is unpredictable, with periods of illness (called flares) alternating with remissions. SLE is estimated to occur in 30 million people worldwide.

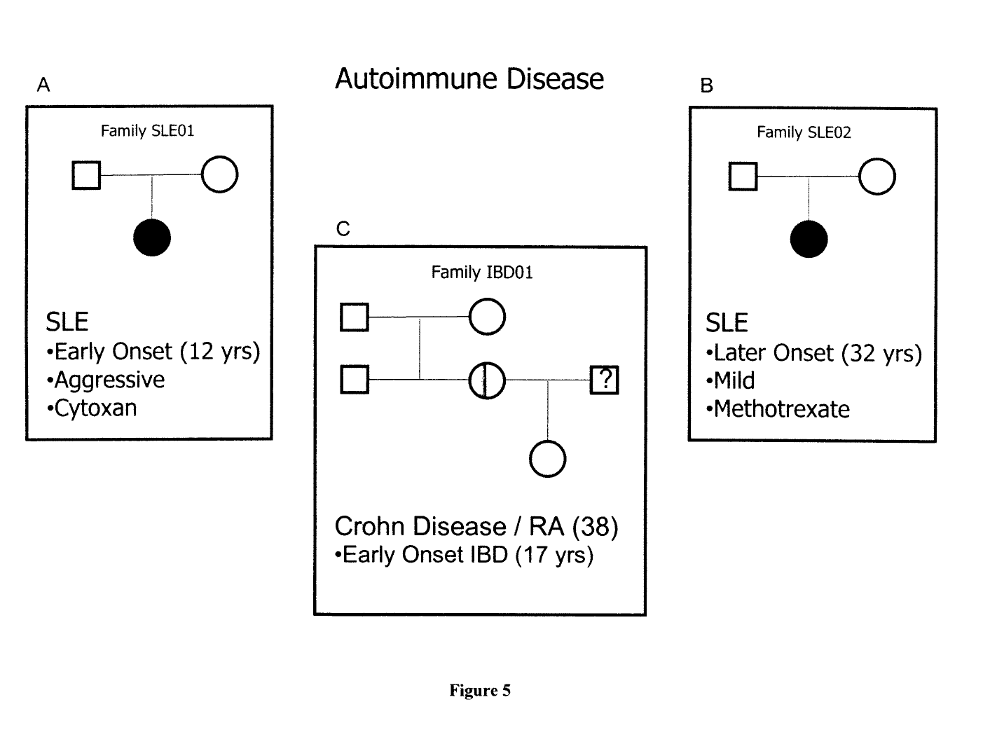

Two volunteer families (Family01 or SLE01 and Family02 or SLE02) participated in the study. Each family consisted of a Paternal Parent, Maternal Parent, and effected Daughter. See FIGS. 5A and 5B. All volunteers were informed of the nature of the study and had signed informed consent.

In a blind study setting, buccal cell samples were obtained from the family members and genomic DNAs were purified from the samples. Table 3 lists the primer pairs used for qPCR in this study.

TABLE 3
List of the primer pairs used in ECNV profling for SLE

| | | | SEQ | | SEQ |
|---|---|---|---|---|---|
| Exon | | | ID | | ID |
| No. | Target Exon | Forward Primer 5′-3′ | No. | Reverse Primer 5′-3′ | No. |
| 1 | MID1Ex01.2 | AGCTTCCCCATTTTTC | 747 | CCTACAGGTTTGTCTCTTC | 748 |
| | | CCA | | CAGATC | |
| 2 | MID1Ex02.2 | TAAACCACAGTGGAGA | 749 | TGACTCCAAGGCAAACAGC | 750 |
| | | CAAGCAGA | | C | |
| 3 | MID1Ex02A.1 | GAAATCTACGGGCAGC | 751 | AGCAGAGTGCGTGTAGCAA | 752 |
| | | AAAGAG | | CA | |
| 4 | MID1Ex02B.1 | AACGAATAAACCACAG | 753 | CAAGGCAAACAGCCCTCAT | 754 |
| | | TGGAGACA | | T | |
| 5 | MID1Ex03.1 | ACATGTTGACAGGTTT | 755 | ACCAACCTTATTAAGAGGA | 756 |
| | | GGATGAGT | | ACACAGAA | |
| 6 | MID1Ex04.1 | GTTCCAATAATCTGTC | 757 | GAAGCCAAATTGACAGAGG | 758 |
| | | GTCTTTGCT | | AGTGT | |
| 7 | MID1Ex05.1 | TGTAGGAAACGCGCAT | 759 | GAGCGGTCAGCATCACTCA | 760 |
| | | GATC | | TC | |
| 8 | MID1Ex06.2 | GTTTCTTCTCTCGGGA | 761 | TCTAATTCCTGAAATCAAC | 762 |
| | | AAAATCTAAG | | CTCAATG | |
| 9 | MID1Ex07.1 | TGGCTTGTCCGGTGAA | 763 | TTGGACCTCCGATGATGAG | 764 |
| | | TATG | | TT | |
| 10 | MID1Ex08.1 | GTCTTCAACTTCCCAG | 765 | GCGGCACCAAGTACATCTT | 766 |
| | | GCTCACT | | CAT | |
| 11 | MID1Ex09.2 | ATGCCGGCCACTATCA | 767 | GTCACACACCTGAACGCTT | 768 |
| | | ATAAA | | CA | |
| 12 | MID1Ex10.1 | CGTCCATGACCTCTAC | 769 | ATGCAATGGCAACTTTTGG | 770 |
| | | GCACTA | | TT | |
| 13 | MID2Ex02.1 | CCAGCCTCCGTGGTTC | 771 | AATTCAGACTCCAGTGTTT | 772 |
| | | TTAA | | CCATCT | |
| 14 | MID2Ex03.1 | AGATGAACCTCACCAA | 773 | GATCTGTATTAGTTTGGCC | 774 |
| | | CCTGGT | | ATTTGATT | |
| 15 | MID2Ex04.2 | CTATGCATGAGGCAAA | 775 | CATTTGCTTCCTCTGCTGG | 776 |
| | | ACTTATGG | | AT | |
| 16 | MID2Ex05.2 | GCCAGTGTCTTGAACG | 777 | GAAACCGTGCCTGGTCATT | 778 |
| | | GTCA | | T | |
| 17 | MID2Ex06.1 | CTATGGCAACTGCATC | 779 | AGCAAAGTTTTCAAAGGCA | 780 |
| | | TTCTCAA | | TCAT | |
| 18 | MID2Ex07.2 | GAGTTCAGCATCAGCT | 781 | CCAACTACACCATGACTTA | 782 |
| | | CCTATGAG | | CTGATGA | |
| 19 | MID2Ex08.1 | CCCAACATTAAACAGA | 783 | TGGTTTATGGCTTTAACGA | 784 |
| | | ACCATTACAC | | TGAAG | |
| 20 | MID2Ex09.1 | TGCAGATGGAGAAGGA | 785 | GCACCCTGTGCCACTAAAC | 786 |
| | | TGAAAG | | C | |
| 21 | MID2Ex10.1 | CCAGCTAACTCTCTCC | 787 | GATTGTAAATGTTGGACAA | 788 |
| | | ATCTTCATACTT | | ACTGGAA | |
| 22 | PPP2R1AEx01.2 | CTTCCTTCTTCTCCCA | 789 | TCCGTCCCTTTCCTGTCAG | 790 |
| | | GCATTG | | A | |
| 23 | PPP2R1AEx02.1 | CGCCTCAACAGCATCA | 791 | GCTCACTTCGGGTCCTTTC | 792 |
| | | AGAA | | AA | |
| 24 | PPP2R1AEx03.2 | ATCTATGATGAAGATG | 793 | CCTCCCACCAGGGTAGTGA | 794 |
| | | AGGTCCTCCT | | AG | |
| 25 | PPP2R1AEx04.1 | GGACAAGGCAGTGGAG | 795 | GCTTCACTAGCGGCACAAA | 796 |
| | | TCCTTA | | GT | |
| 26 | PPP2R1AEx05.2 | TCAGATGACACCCCCA | 797 | ATGATCTCACTCTTGACGT | 798 |
| | | TGGT | | TGTCC | |
| 27 | PPP2R1AEx06.1 | CCAGGCCGCTGAAGAC | 799 | GTGAACTTGTCAGCCACCA | 800 |
| | | AAGT | | TGTA | |
| 28 | PPP2R1AEx07.2 | GCAGTGGGGCCTGAGA | 801 | GCCTCACAGTCTTTCATCA | 802 |
| | | TCA | | GGTT | |
| 29 | PPP2R1AEx08.2 | TGTGAAAACCTCTCAG | 803 | CAGGGCAAGATCTGGGACA | 804 |
| | | CTGACTGT | | T | |
| 30 | PPP2R1AEx09.2 | CTGCCCTGGCCTCAGT | 805 | CAAGAGGTGCTCGATGGTG | 806 |
| | | CAT | | TT | |
| 31 | PPP2R1AEx10.1 | TGGACTGTGTGAACGA | 807 | TCCTCAGCCAGCTCCACAA | 808 |
| | | GGTGAT | | T | |
| 32 | PPP2R1AEx11.1 | GAGTGGAGTTCTTTGA | 809 | GATCCACAAGCCAGGCCAT | 810 |
| | | TGAGAAACTTAA | | | |
| 33 | PPP2R1AEx12.2 | AAGTTTGGGAAGGAGT | 811 | ATGCGGTGCAGGTAGTTGG | 812 |
| | | GGGC | | | |
| 34 | PPP2R1AEx13.2 | GCACATGCTACCCACG | 813 | CAGAGACTTGGCCACATTG | 814 |
| | | GTT | | AAG | |
| 35 | PPP2R1AEx14.2 | AAGCCCATCCTAGAGA | 815 | GAGCCTCCTGGGCAAAGTA | 816 |
| | | AGCTGA | | TTT | |
| 36 | PPP2R1AEx15.1 | GGTTGGACAGGACAGT | 817 | TACAGCAGCAGGATCCAGT | 818 |
| | | GACCTT | | GA | |

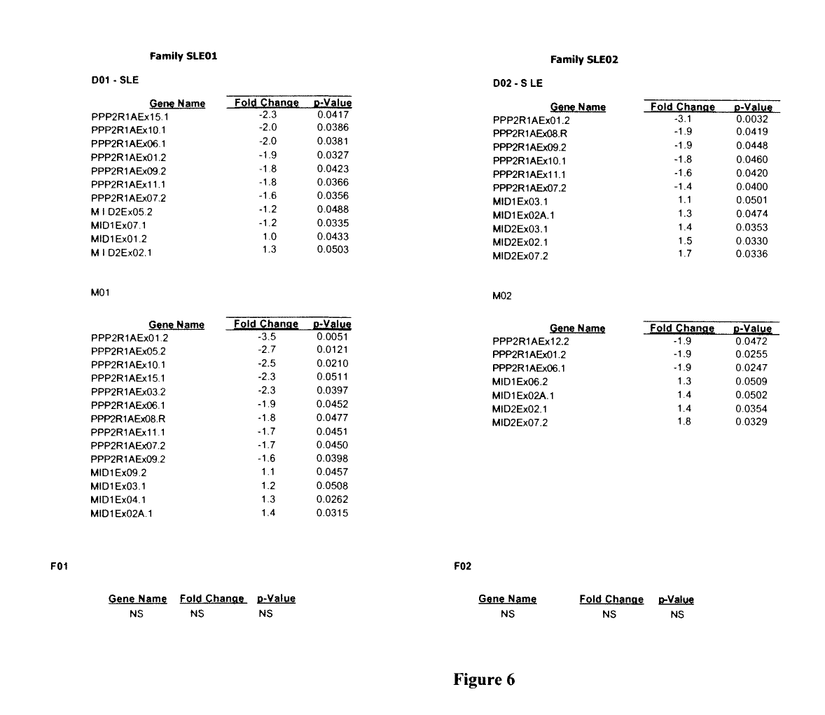

The data presented in FIG. 6 are the GPR™ results (p<−0.05, raw data not shown) derived from technical triplicates of qPCR data for Family SLE01 and SLE02. In FIG. 6, F01, M01, and D01 are father, mother, and daughter (respectively) from Family SLE01. F02, M02, and D02 are father, mother, and daughter (respectively) from Family SLE02. “Gene Name” refers to the gene and target (exon) descriptor. Fold Change represents the amount of copy number change relative to an anonymous male genomic DNA sample. There was a significant difference in ECNV profiles between D01 and D02, as well as a significant difference in ECNV profiles of the mothers (M01 and M02). The fathers (F01 and F02) do not show any statistically significant differences in ECNVs relative to the control. These exon ECNV profiles represent a disease state ‘barcode’ associated with SLE, and possibly associated with the specific form of the disease (i.e. onset and/or severity).

The profiles in FIG. 6 were generated and evaluated without prior knowledge of the severity of lupus in the daughters. Based on the above data, the two daughters were characterized as having drastically different symptoms. Upon completion of the study, the physician who had knowledge about the conditions of the daughters provided the following information about the symptoms and severity/onset of lupus in each of the daughters.

Daughter01 (from Family01) had an early onset, severe, multi-organ involved, diagnosed SLE. Age of diagnosis was 12 years (she was in her 20's at the time this study was conducted), and she was taking Cytoxan® for treatment. Daughter02 (from Family02) had a later onset disease with milder symptoms, generalize muscle soreness, epidermal discoloration (possibly bruising), and no defined organ involvement. Age of diagnosis was 32 years (she was 37 at the time this study was conducted), and she was taking methotrexate for treatment.

With respect to Mid1 copy number variation, Daughter01 (having a more severe SLE) displayed larger copy number fold changes in Mid1 exon as compared to Daughter02 who displayed a significantly different milder SLE. Daughter01 with very classical Lupus symptoms and multi-organ involvement had a 5× copy number difference relative to Mother01 in the Mid1 exon 10 region. Daughter02 with an atypical Lupus syndrome did not reveal the expected Mid1 exon variation relative to Mother02. Additionally, since Daughter02 did not reveal the Mid1 copy number variations and she was not displaying a typical Lupus syndrome, this indicates that the Mid1 copy number variations were a more accurate means to define Lupus.

With respect to Mid2 copy number variation, Daughter01 showed no differences in MID2 relative to her mother. However, Daughter02 showed some very significant differences relative to her mother. This was totally unexpected and may be a significant discovery.

With respect to PPP2R1A copy number variation, both daughters showed significant differences in PPP2R1A relative to their mothers.

This study provided strong evidence that MID1, MID2 and PPP2R1A exon copy number variations were associated with the severity/onset of Lupus in humans. Additional multi-dimensional statistical analyses of the data (using GPR™ and ANOVA) where the copy number of each of the biomarkers were compared to that of different references (i.e., genomic DNA sample from an unknown source as control and from other volunteers in this study) demonstrated that the copy number variations of these biomarkers were statistically significant and consistent (regardless of the magnitude of fold changes) across multiple references (data not shown).

These results demonstrated that ECNV profiling using exons of Mid1, Mid2 and PPP2R1A genes via can provide a “barcode” of autoimmune disease type, severity, rapidity of onset.

3. ECNV Profiling of Crohn's Disease

In this example, ECNV profiles were created for autoimmune disease risk assessment. The exon copy number variations of marker genes ATG16L1, CYLD, IL23R, NOD2, and SNX20 genes were studied in a family that include a person who was diagnosed with Crohn' disease and unaffected persons.

Crohn's disease (also known as granulomatous colitis and regional enteritis) is an inflammatory disease of the intestines that may affect any part of the gastrointestinal tract from anus to mouth, causing a wide variety of symptoms. It primarily causes abdominal pain, diarrhea (which may be bloody), vomiting, or weight loss, but may also cause complications outside of the gastrointestinal tract such as skin rashes, arthritis and inflammation of the eye.

Crohn's disease is an autoimmune disease, caused by the immune system's attacking the gastrointestinal tract and producing inflammation in the gastrointestinal tract; it is classified as a type of inflammatory bowel disease (IBD). There has been very little evidence of a genetic link to Crohn's disease, though individuals with siblings who have the disease are at higher risk.

The volunteer family (Family IBD0101, FIG. 5C) included the unaffected father, mother, son and a daughter who was diagnosed with the Crohn's disease and grand daughter. All volunteers were informed of the nature of the study and had signed informed consent.

In a blind study setting, buccal cell samples were obtained from the volunteers and genomic DNAs were purified from the samples. Table 5 lists the primer pairs used for qPCR in this study.

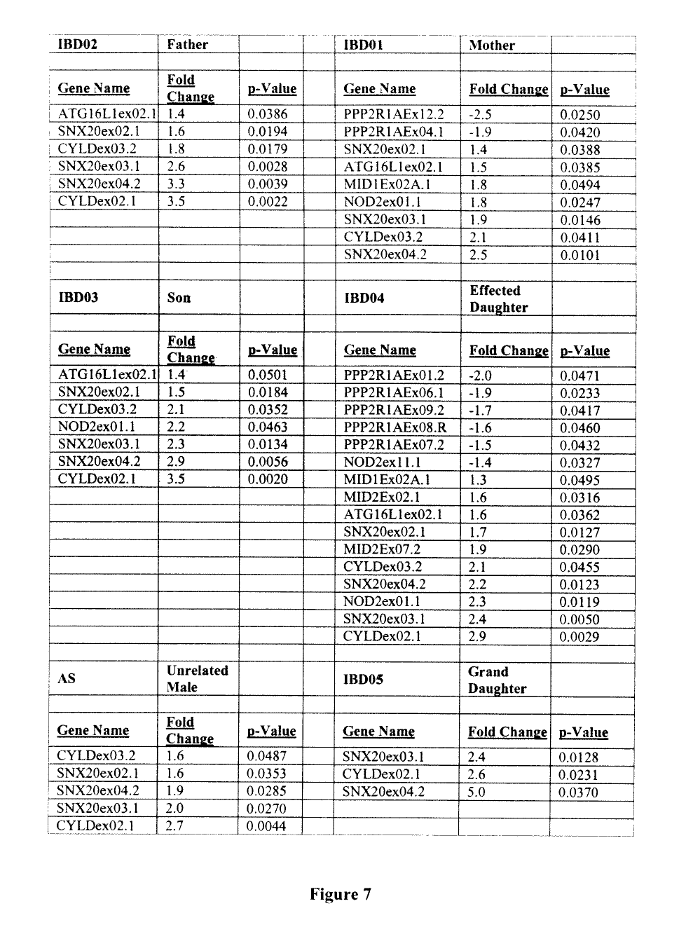

The information provided in FIG. 7 are the GPR™ results (p<−0.05, data not shown) derived from technical triplicates of qPCR data for Family IBDO1 and an unrelated male (AS). IBD02, IBD01, IBD03, IBD04, and IBDOS are father, mother, son, daughter (Effected) and grand-daughter, respectively, from Family IBD0101. “Gene Name” refers to the gene and target (exon) descriptor. Fold Change represents the amount of copy number change relative to an anonymous male genomic DNA sample. IBD04 was diagnosed as having Crohn's Disease and Rheumatoid Arthritis. There is a significant difference in ECNV profiles between IBD04 (Effected Daughter) and the unrelated male (AS), as well as a significant difference in Family IBD01 members and the unrelated male (AS). The marker genes and marker exons used in this study included both the SLE biomarkers as well as the Crohn's Disease biomarkers, demonstrating that there is an overlap of exon copy number variations between the two diseases. This suggests a common mechanism for these two (or more) autoimmune disease states.

TABLE 4
List of the primer pairs used in ECNV profiling for Crohn′s Disease.

| | | | SEQ | | SEQ |
|---|---|---|---|---|---|
| Exon | | | ID | | ID |
| No. | Target Exon | Forward Primer 5′-3′ | No. | Reverse Primer 5′-3′ | No. |
| 1 | ATG16L1ex01.2 | GGGACTGCCAGTGTGT | 819 | CAGCATGAAGCAACCAGCA | 820 |
| | | GGA | | | |
| 2 | ATG16L1ex02.1 | AACAAATTGCTGGAAA | 821 | ACGTCATGCTTTTCAGCCTG | 822 |
| | | AGTCAGATC | | TA | |
| 3 | ATG16L1ex03.2 | GGAATGACAATCAGCT | 823 | CCCACGTTTCTTGTGTAATT | 824 |
| | | ACAAGAAATG | | CAGT | |
| 4 | ATG16L1ex04.1 | GCTCAACTGGTGATTG | 825 | TCATCTGCATCTCCCTGTCC | 826 |
| | | ACCTGAA | | TT | |
| 5 | ATG16L1ex05.2 | TGCAGACTATCTCTGA | 827 | GGCTCTTTCAAGGTCACAAA | 828 |
| | | CCTGGAGA | | GCT | |
| 6 | ATG16L1ex06.1 | CCGGCTGCAGAAAGAG | 829 | TGTTCGACTGGTAGAGGTTC | 830 |
| | | CTT | | CTTT | |
| 7 | ATG16L1ex07.1 | GATGACATTGAGGTCA | 831 | GCTCGCACAGGAGAGGTCTC | 832 |
| | | TTGTGGAT | | T | |
| 8 | ATG16L1ex09.2 | TGTCTCTTCCTTCCCA | 833 | CAGTAGCTGGTACCCTCACT | 834 |
| | | GTCCC | | TCTTTAC | |
| 9 | ATG16L1ex10.1 | AAATGTGAGTTCAAGG | 835 | GCACTATCAAATTCAATGCT | 836 |
| | | GTTCCCTAT | | TGTAATTC | |
| 10 | ATG16L1ex11.1 | ATCTTACCTCTTAGCA | 837 | CGTAATCGATAATCATCCAC | 838 |
| | | GCTTCAAATGAT | | AGT | |
| 11 | ATG16L1ex12.2 | CACACACTCACGGGAC | 839 | CTGAGACAATCCGCGCATT | 840 |
| | | ACAGT | | | |
| 12 | ATG16L1ex13.2 | GTTTGCAGGATCCAGT | 841 | GTCCCAGAAACGAATTTTCT | 842 |
| | | TGCAA | | TGTC | |
| 13 | ATG16L1ex14.1 | GGACTTAAACCCAGAA | 843 | GGAGATCAATAACTTTTAGC | 844 |
| | | AGGACTGA | | AAGTCATC | |
| 14 | ATG16L1ex16.1 | GCTCTGCTGAGGGCTC | 845 | CTGCTTTGAAAGAACCTTTT | 846 |
| | | TCTGTA | | CCA | |
| 15 | ATG16L1ex17.1 | CCTGATCACCGCTTTC | 847 | CCCTGGCCTGTGAATTTCAA | 848 |
| | | CAAT | | | |
| 16 | CYLDex02.1 | CCCTTTCTAGGGTGAG | 849 | GGCGCACCTTTCAACTAAGG | 850 |
| | | GATGGTT | | | |
| 17 | CYLDex03.2 | TTCATGTAAAACATAT | 851 | AGACGAGAGTTGGAAGGCAC | 852 |
| | | TTCCTGATCATCT | | A | |
| 18 | CYLDex04.2 | ATATCACAATGAGTTC | 853 | AAAAAATCCGCTCTTCCCAG | 854 |
| | | AGGCTTATGG | | TAG | |
| 19 | CYLDex05.1 | GAAGAAGGTCGTGGTC | 855 | ACGCCACAATCTTCATCACA | 856 |
| | | AAGGTT | | CT | |
| 20 | CYLDex06.2 | GCAACTGGGATGGAAG | 857 | GATGTGCAATAGAATTGTAC | 858 |
| | | ATTTG | | TTTCAACA | |
| 21 | CYLDex08.2 | GGAAAGGAGGCCTCCC | 859 | CCTTTGGTTTATTATGACTG | 860 |
| | | AAA | | GATGAA | |
| 22 | CYLDex09.2 | CAGACCCTGGAAATAG | 861 | TTGTGGTTGTGAGTCAACAG | 862 |
| | | AAACAGATC | | AAGA | |
| 23 | CYLDex10.1 | AACTCACTGACCACCG | 863 | CCATTGGTATTGGGCATCTT | 864 |
| | | AGAACA | | G | |
| 24 | CYLDex11.1 | CAGGCTGTACGGATGG | 865 | CACAAACAGCGCCTTCTTCA | 866 |
| | | AACCT | | G | |
| 25 | CYLDex12.1 | AGAAGAAAATACTCCA | 867 | GGATGCCTTTCTTCTTCCCA | 868 |
| | | CCAAAAATGG | | AT | |
| 26 | CYLDex13.1 | CTGTGTTACTTAGACC | 869 | TGTCCTCAGTAGCTCTTGGG | 870 |
| | | CAAAGAAAAGAA | | TTT | |
| 27 | CYLDex14.1 | GGATATGTGTGTGCCA | 871 | TCTTCAGAGGTAAATCCTGA | 872 |
| | | CAAAAATTAT | | TGCA | |
| 28 | CYLDex15 1 | ATCCTGAGGAATTCTT | 873 | CTTATTTTTAGCAAAGGTTC | 874 |
| | | GAATATTCTGTT | | TACCCTTAA | |
| 29 | CYLDex16.2 | CAAGATTGTTACTTCT | 875 | AACTGCTGAATTGTGGGAAC | 876 |
| | | ATCAAATTTTTATGG | | G | |
| 30 | CYLDex17.1 | CCTCGATTTGGAAAAG | 877 | GTAAATCTGTTATATTTAAT | 878 |
| | | ACTTTAAACT | | TCCAGAGAAGGA | |
| 31 | CYLDex18.2 | TGGAGGGCTTGCAATG | 879 | GCTTGATTTTTCCAGCTGAG | 880 |
| | | TATG | | ATGT | |
| 32 | CYLDex19.1 | TCATCCGAAGAGGCTG | 881 | TCCAGTCCCAGTCGGGTAAG | 882 |
| | | AATCA | | T | |
| 33 | CYLDex20.2 | AACGTCTTCTTCAGGT | 883 | GCCCTGGCATCCCTTAATG | 884 |
| | | GGAGCTT | | | |
| 34 | IL23Rex01.1 | GTGGCAGCCTGGCTCT | 885 | CTTTCAACCTGTTTGAAGCA | 886 |
| | | GAA | | CATAA | |
| 35 | IL23Rex02.1 | CTTTTCCTGCTTCCAG | 887 | CCATGACACCAGCTGAAGAG | 888 |
| | | ACATGAAT | | TATG | |
| 36 | IL23Rex03.1 | TCTGGAACCACATGCT | 889 | GTCTTTTCCACATATCAGTG | 890 |
| | | TCTATGTACT | | TCTCTTG | |
| 37 | IL23Rex04.1 | CGCCAGATATTCCTGA | 891 | CATTCCAGGTGCAAGTCATG | 892 |
| | | TGAAGTAA | | TT | |
| 38 | IL23Rex05.1 | GAGACAGAAGAAGAGC | 893 | ACCAAGTACTTCTTGCCACC | 894 |
| | | AACAGTATCTCA | | TTGTA | |
| 39 | IL23Rex06.1 | TGATACCTTCTGCAGC | 895 | AATAAATTATGGTCTTGGGC | 896 |
| | | CGTCA | | ACTGTA | |
| 40 | IL23Rex07.1 | AGTCAGAATTCTACTT | 897 | GTGAACTCCAAGGCTGCCAG | 898 |
| | | GGAGCCAAAC | | TA | |
| 41 | IL23Rex08.1 | CAAAAGCATTCCAACA | 899 | CAGAAGTAAGGTGCCCTGTA | 900 |
| | | TGACACAT | | GAGAT | |
| 42 | IL23Rex09.1 | GGGAATGATCGTCTTT | 901 | CAGTTCGGAATGATCTGTTA | 902 |
| | | GCTGTT | | AATATCC | |
| 43 | IL23Rex10.1 | GATCTTATTGTTAATA | 903 | CACAACATTGCTGTTTTTCA | 904 |
| | | CCAAAGTGGCTTTAT | | TATTAGG | |
| 44 | IL23Rex11.2 | ATAATTCCAGTGAGCA | 905 | TAGGCTTGTGTTCTGGGATG | 906 |
| | | GGTCCTATATG | | AAG | |
| 45 | NOD2ex01.1 | CTGCTCCCCCAGCCTA | 907 | GCTCTTTCCTCCTCATCGTG | 908 |
| | | ATG | | A | |
| 46 | NO02ex02.2 | CAGCCATGTGGAGAAC | 909 | GCAACCTGATTTCATCACAT | 910 |
| | | ATGCT | | TCAT | |
| 47 | NOD2ex03.1 | CTTGATCTTGCCACGG | 911 | ACTGGTAATTCCTGAACATG | 912 |
| | | TGAA | | TTGTAGAA | |
| 48 | NOD2ex04.1 | GGGCAAGACTTCCAGG | 913 | TCCGCACAGAGAGTGGTTTG | 914 |
| | | AATTT | | | |
| 49 | NOD2ex05.1 | TTTGCGCGATAACAAT | 915 | CTGCAATTGCTCGCAGTGAA | 916 |
| | | ATCTCAGA | | | |
| 50 | NOD2ex06.1 | ACAACAAATTGACTGA | 917 | AGAAGTTCTGCCTGCATGCA | 918 |
| | | CGGCTGT | | A | |
| 51 | NOD2ex08.1 | CTGGGGCAACAGAGTG | 919 | CCACCTCAAGCTCTGGTGAT | 920 |
| | | GGT | | C | |
| 52 | NOD2ex10.1 | GGAGGAGAACCATCTC | 921 | GGATTTTCAAACTTGAATTT | 922 |
| | | CAGGAT | | TTCTTCA | |
| 53 | NOD2ex11.1 | TTGTCCAATAACTGCA | 923 | CAGGATGGTGTCATTCCTTT | 924 |
| | | TCACCTACC | | CAA | |
| 54 | NOD2ex12.1 | TGCAGGGACACCAGAC | 925 | AGCCTGCTCACAAACAAACT | 926 |
| | | TCTTG | | GA | |
| 55 | SNX20ex01.1 | CTCGAAGGGGCCATAT | 927 | CCAGGGCTGTGTGTGTCCA | 928 |
| | | GACA | | | |
| 56 | SNX20ex02.1 | CTTGGAGCATGGCAAG | 929 | CTTGCCGTGCACTGGGTTAT | 930 |
| | | TCCA | | | |
| 57 | SNX20ex03.1 | AGTACTGGCAGAACCA | 931 | GATGCGAGCTGAAGCGATCT | 932 |
| | | GAAATGC | | | |
| 58 | SNX20ex04.2 | CCAGACTGGGAGCTTT | 933 | GCAGCGCTTTCTGGAGCTT | 934 |
| | | GACAAC | | | |

These ECN profiles represent a disease state “barcode” associated with not only Crohn's Disease but possibly with the specific form of the disease (e.g., onset and/or severity) as well as Rheumatoid Arthritis.

### Example 3

### ECNV Profiling for Neurological Disease Risk Assessment

In this example, ECNV profiles were created for neurological disease risk assessment. ECNVs of exons of marker genes APOE, APP, PSEN1, PSEN2 and PSENEN in subjects with Alzheimer's disease were studied.

Alzheimer's disease (AD) is a complex multigenic neurological disorder characterized by progressive impairments in memory, behavior, language, and visuo-spatial skills, ending ultimately in death. Hallmark pathologies of Alzheimer's disease include granulovascular neuronal degeneration, extracellular neuritic plaques with β-amyloid deposits, intracellular neurofibrillary tangles and neurofibrillary degeneration, synaptic loss, and extensive neuronal cell death. It is now known that these histopathologic lesions of Alzheimer's disease correlate with the dementia observed in many elderly people.

Alzheimer's disease is commonly diagnosed using clinical evaluation including, physical and psychological assessment, an electroencephalography (EEG) scan, a computerized tomography (CT) scan and/or an electrocardiogram. These forms of testing are performed to eliminate some possible causes of dementia other than Alzheimer's disease, such as, for example, a stroke. Following elimination of other possible causes of dementia, Alzheimer's disease is diagnosed. Accordingly, current diagnostic approaches for Alzheimer's disease are not only unreliable and subjective, they do not predict the onset of the disease. Rather, these methods merely diagnose the onset of dementia of unknown cause, following onset. The present invention provides means to overcome these deficiencies.

In this study, genomic DNAs from four sex- and age-matched individuals (both male and female, two diagnosed with AD and two not) were analyzed using QPCR and targets/biomarkers related to AD. Table 5 provides the list of the primer pairs used in this study.

TABLE 5
List of the primer pairs used in ECNV profiling for Alzheimer′s disease

| | | | SEQ | | SEQ |
|---|---|---|---|---|---|
| Exon | | | ID | | ID |
| No. | Target Exon | Forward Primer 5′-3′ | No. | Reverse Primer 5′-3′ | No. |
| 1 | APOEex02.1 | GCCAATCACAGGCAGG | 935 | GCCAGGAATGTGACCAGCA | 936 |
| | | AAGA | | A | |
| 2 | APOEex03.2 | GGGTCGCTTTTGGGAT | 937 | TCCTGCACCTGCTCAGACA | 938 |
| | | TACCT | | GT | |
| 3 | APOEex04.1 | GACGAGACCATGAAGG | 939 | GGGGTCAGTTGTTCCTCCA | 940 |
| | | AGTTGAA | | GTT | |
| 4 | APPex01.1 | CTGACTCGCCTGGCTC | 941 | TACCGCTGCCGAGGAAACT | 942 |
| | | TGA | | | |
| 5 | APPex02.2 | TCTGTGGCAGACTGAA | 943 | GGTTTTGGTCCCTGATGGA | 944 |
| | | CATGC | | TC | |
| 6 | APPex03.1 | CCCTGAACTGCAGATC | 945 | GGATGGGTCTTGCACTGCT | 946 |
| | | ACCAA | | T | |
| 7 | APPex04.1 | GTGAGTTTGTAAGTGA | 947 | AACATCCATCCTCTCCTGG | 948 |
| | | TGCCCTTCT | | TGTAA | |
| 8 | APPex05.2 | TGCCCACTGGCTGAAG | 949 | CCACCAGACATCCGAGTCA | 950 |
| | | AAAG | | TC | |
| 9 | APPex06.1 | GCAGAGGAGGAAGAAG | 951 | TCATCACCATCCTCATCGT | 952 |
| | | TGGCT | | CC | |
| 10 | APPex07.1 | CGTGCCGAGCAATGAT | 953 | CACATCCGCCGTAAAAGAA | 954 |
| | | CTC | | TG | |
| 11 | APPex08.1 | TGTCCCAAAGTTTACT | 955 | GTTTAACAGGATCTCGGGC | 956 |
| | | CAAGACTACC | | AAGA | |
| 12 | APPex09.2 | GATGCCGTTGACAAGT | 957 | GCCTCTCTTTGGCTTTCTG | 958 |
| | | ATCTCG | | GA | |
| 13 | APPex10.1 | GAGAGAATGGGAAGAG | 959 | GCCTTCTTATCAGCTTTAG | 960 |
| | | GCAGAA | | GCAAG | |
| 14 | APPex11.2 | CAGGAAGCAGCCAACG | 961 | GTCATTGAGCATGGCTTCC | 962 |
| | | AGA | | A | |
| 15 | APPex12.1 | CGTCACGTGTTCAATA | 963 | TGCTTTAGGGTGTGCTGTC | 964 |
| | | TGCTAAAGA | | TGT | |
| 16 | APPex13.2 | AATCAGTCTCTCTCCC | 965 | CAACTTCATCCTGAATCTC | 966 |
| | | TGCTCTACAA | | CTCG | |
| 17 | APPex14.2 | CGATGCTCTCATGCCA | 967 | CCAGGCTGAACTCTCCATT | 968 |
| | | TCTTT | | CA | |
| 18 | APPex15.1 | TTGAGCCTGTTGATGC | 969 | CTGGTCGAGTGGTCAGTCC | 970 |
| | | CCG | | TC | |
| 19 | APPex16.2 | GACAAATATCAAGACG | 971 | TCATATCCTGAGTCATGTC | 972 |
| | | GAGGAGATCT | | GGAAT | |
| 20 | APPex17.1 | CTTTGCAGAAGATGTG | 973 | GACGATCACTGTCGCTATG | 974 |
| | | GGTTCA | | ACAAC | |
| 21 | APPex18.2 | AGATTCTCTCCTGATT | 975 | TGGGTCACAAACCACAAGA | 976 |
| | | ATTTATCACATAGC | | ATAATATAC | |
| 22 | PSEN1ex01.1 | CGGTTTCACATCGGAA | 977 | CGTAGCTCAGGTTCCTTCC | 978 |
| | | ACAAA | | AGA | |
| 23 | PSEN1ex02.2 | GGAGCCTGCAAGTGAC | 979 | CTTTCTTTCATGTGTTCTC | 980 |
| | | AACA | | CTCCA | |
| 24 | PSEN1ex03.1 | TCAAGAGGCTTTGTTT | 981 | ACGGTGCAGGTAACTCTGT | 982 |
| | | TCTGTGAA | | CATT | |
| 25 | PSEN1ex04.2 | ATGAGGAGCTGACATT | 983 | CATGCAGAGAGTCACAGGG | 984 |
| | | GAAATATGG | | ACA | |
| 26 | PSEN1ex05.2 | CAATTCTGAATGCTGC | 985 | TTTATACAGAACCACCAGG | 986 |
| | | CATCA | | AGGATAGT | |
| 27 | PSEN1ex06.1 | GTCATCCATGCCTGGC | 987 | TGAATGAAAAAAAGAACAG | 988 |
| | | TTATTATATC | | CAACAATAG | |
| 28 | PSEN1ex07.1 | CACTCCTGATCTGGAA | 989 | CTGGAGTCGAAGTGGACCT | 990 |
| | | TTTTGGT | | TTC | |
| 29 | PSEN1ex08.2 | GTCCACTTCGTATGCT | 991 | GGAGTAAATGAGAGCTGGA | 992 |
| | | GGTTGAA | | AAAAGC | |
| 30 | PSEN1ex09.1 | AACAATGGTGTGGTTG | 993 | GCATTATACTTGGAATTTT | 994 |
| | | GTGAATAT | | TGGATACTCT | |
| 31 | PSEN1ex10.1 | AGAAAGGGAGTCACAA | 995 | GGCTTCCCATTCCTCACTG | 996 |
| | | GACACTGTT | | AA | |
| 32 | PSEN1ex11.2 | TCATTTTCTACAGTGT | 997 | GGCTACGAAACAGGCTATG | 998 |
| | | TCTGGTTGGT | | GTT | |
| 33 | PSEN1ex12 2 | CAGATGCCTCCTCTGT | 999 | TACCACGACAGAGCTGCCT | 1000 |
| | | CCTCAT | | TACT | |
| 34 | PSEN2ex02.1 | CATTTCCAGCAGTGAG | 1001 | GGGGGACTAGCTTCTGTCT | 1002 |
| | | GAGACA | | CAG | |
| 35 | PSEN2ex03.2 | GTGTGACCATAGAAAG | 1003 | CTTCTCAGCAGGCTAAATG | 1004 |
| | | TGACGTGTT | | AATGA | |
| 36 | PSEN2ex04.1 | GAGGCAGGGCTATGCT | 1005 | ACATTAGGGACGTCCGCTC | 1006 |
| | | CACAT | | AT | |
| 37 | PSEN2ex05.1 | GACCCTGACCGCTATG | 1007 | CCGTATTTGAGGGTCAGCT | 1008 |
| | | TCTGTAGT | | CTT | |
| 38 | PSEN2ex06.2 | TCCGTGCTGAACACCC | 1009 | GGTACTTGTAGAGCACCAC | 1010 |
| | | TCAT | | CAAGAA | |
| 39 | PSEN2ex07.1 | TTCATCCATGGCTGGT | 1011 | CCAAGGTAGATATAGGTGA | 1012 |
| | | TGATC | | AGAGGAACA | |
| 40 | PSEN2ex08.1 | TGGACTACCCCACCCT | 1013 | CTTCCAGTGGATGCACACC | 1014 |
| | | CTTG | | A | |
| 41 | PSEN2ex09.1 | GGCTGTGCTGTGTCCC | 1015 | TGAGTATATCAGGGCAGGG | 1016 |
| | | AAA | | AATATG | |
| 42 | PSEN2ex10.1 | TGCCATGGTGTGGACG | 1017 | TGAGAGGAGGGGTCCAGCT | 1018 |
| | | GTT | | T | |
| 43 | PSEN2ex11.1 | CTATGACAGTTTTGGG | 1019 | CCTCCTCTTCCTCCAGCTC | 1020 |
| | | GAGCCTT | | CT | |
| 44 | PSEN2ex12.1 | CGGGGACTTCATCTTC | 1021 | AAGCAGGCCAGCGTGGTAT | 1022 |
| | | TACAGTGT | | | |
| 45 | PSEN2ex13.1 | GACCCTCCTGCTGCTT | 1023 | AAGATGAGCCCGAACGTGA | 1024 |
| | | GCT | | T | |
| 46 | PSENENex01.1 | CGCCCAAAGAAGACTA | 1025 | GCTACTTTCAGTTATGGAC | 1026 |
| | | CAATCTC | | GTTTGC | |
| 47 | PSENENex02.2 | CCTTGCATCTGTTACT | 1027 | CACTCGCTCCAGGTTCATA | 1028 |
| | | TAGGGT CAA | | GCT | |
| 48 | PSENENex03.1 | GTTTGCTTTCCTGCCT | 1029 | CTTTGATTTGGCTCTGTTC | 1030 |
| | | TTTCTCT | | TGTGTA | |
| 49 | PSENENexQ4.1 | GCTCAGCTGTGGGCTT | 1031 | GGCCGGTAGATCTGGAAGA | 1032 |
| | | CCT | | TG | |

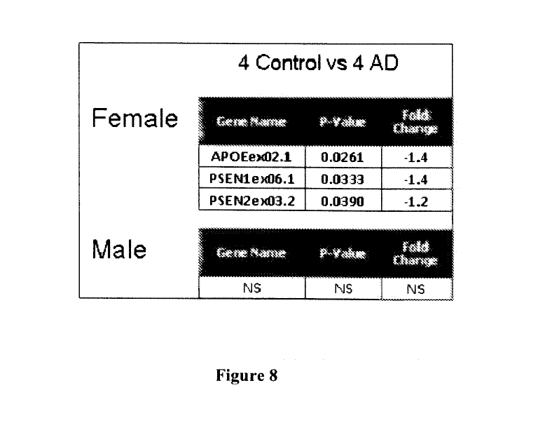

As shown below in FIG. 8, non-sex segregated analysis yielded no significant ECNV. However, sex-segregated data revealed three statistically significant ECN variants in females with AD.

This study suggests that even without familial relatedness it is still possible to use ECNV analysis to detect potential genetic markers associated with disease

In another study, genomic DNAs from four sex- and age-matched individuals (females only, one diagnosed with AD and one not) were analyzed using qPCR and targets/biomarkers related to SLE. The GPR™ results (data not shown) for data were derived from the survey of the SLE-related biomarkers in female samples from subjects known to have Alzheimer's disease and age-matched control (no disease) samples. No statistically significant changes in exon copy numbers were observed in the experimental sample as compared to the control sample.

This study serves as an example of the reliability of the analysis of Alzheimer's related marker genes and marker exons. In this study, gDNA samples derived from female subjects revealed significant exon copy number variations.

### Materials and Methods

The following materials and methods were used in the Examples 2 and 3.

Sample Collection

Human volunteers, after signing an informed consent document self-collected buccal cells using a sterile Buccal Cell® Collection Brush (Puregene Buccal Collection Brush, Qiagene, Inc.) by scraping the inside of the mouth 10 times.

DNA Purification

Genomic DNA contained within the cells on the brushes was purified using the Gentra Puregene Buccal Cell Core Kit A (Qiagen, Inc. CA) and the manufacturers recommendations as follows:

1. Dispense 300 μl Cell Lysis Solution into a 1.5 ml microcentrifuge tube. Remove the collection brush from its handle using sterile scissors or a razor blade, and place the detached head in the tube.

2. Add 1.5 μl Puregene Proteinase K (cat. no. 158918), mix by inverting 25 times, and incubate at 55° C. overnight.

3. Remove the collection brush head from the Cell Lysis Solution, scraping it on the sides of the tube to recover as much liquid as possible.

4. Add 1.5 μl RNase A Solution, and mix by inverting 25 times. Incubate for 15 min at 37° C. Incubate for 1 min on ice to quickly cool the sample.

5, Add 100 μl Protein Precipitation Solution, and vortex vigorously for 20 s at high speed.

6. Incubate for 5 min on ice.

7. Centrifuge for 3 min at 13,000-16,000×g. The precipitated proteins should form a tight pellet. If the protein pellet is not tight, incubate on ice for 5 min and repeat the centrifugation.

8. Pipet 300 μl isopropanol and 0.5 μl Glycogen Solution (cat. no. 158930) into a clean 1.5 ml microcentrifuge tube, and add the supernatant from the previous step by pouring carefully. Be sure the protein pellet is not dislodged during pouring.

9. Mix by inverting gently 50 times.

10. Centrifuge for 5 min at 13,000-16,000×g.

11. Carefully discard the supernatant, and drain the tube by inverting on a clean piece of absorbent paper, taking care that the pellet remains in the tube.

12. Add 300 μl of 70% ethanol and invert several times to wash the DNA pellet.

13. Centrifuge for 1 min at 13,000-16,000×g.

14. Carefully discard the supernatant. Drain the tube on a clean piece of absorbent paper, taking care that the pellet remains in the tube. Allow to air dry for up to 15 min. The pellet might be loose and easily dislodged.

15. Add 20 μl DNA Hydration Solution and vortex for 5 s at medium speed to mix.

16. Incubate at 65° C. for 1 h to dissolve the DNA.

17. Incubate at room temperature overnight with gentle shaking. Ensure tube cap is tightly closed to avoid leakage. Samples can then be centrifuged briefly and transferred to a storage tube.

18. DNA concentrations were determined via UV/Vis spectrophotometry using the Nanoprop Spectrophotometer (Thermo-Fisher, Inc.).

Gene Selection

Disease-related genes were chosen based on information related to inclusion in quantitative trait loci (QTL) and/or biochemical pathway associations. Exon sequences were downloaded from the NCBI Entrez Gene Tables (www.ncbi.nlm.nih.gov/sites/entrez?db=gene).

Primer Design and Validation

Exon-specific primers were designed using the Primer Express (PX) Software tool (Applied Biosystems/Life Technologies, Inc.) using the DNA PCR document type and default parameters with two exceptions (19 base minimum primer length and 70 bp minimum/110 bp maximum amplicon length). In cases where PX was unable to select appropriate primer sets, a manual design was performed using the PX Primer Test Document enabling selection of Tm-matched primers. Typically, two primer sets per exon were determined to be suitable for purchase and subsequent validation experiments. Primers were purchased (Integrated DNA Technologies, Inc.) as either lyophilized single primers or in solution as mixtures of forward and reverse exon-specific sets at 50 uM (each) in 10 mM Tris (pH8.5).

Primer validation data was acquired by real-time PCR. Briefly, primers were diluted and dispensed into quadruplicate wells in a 384-well PCR plate with one primer set per well. Primers were lyophilized into the wells and the plates were either used immediately for data acquisition or sealed and stored at −20° C. for future use.

Real-time PCR

Each well was loaded with 10 microliters of sample-specific, SYBR Green master mix containing 1.4 ng of a commercially available human genomic DNA (Roche, Inc.), a chemically modified hot-start Taq polymerase (Applied Biosystems, Inc.). The array was heat sealed, and run on a 7900HT Sequence Detection System (Applied Biosystems, Inc.) using cycling parameters consisting of:
1 cycle of 50° C. for 2 minutes,
1 cycle of 95° C. for 10 minutes,
40 cycles of 95° C. for 15 seconds and 60° C. for 40 seconds,
A dissociation curve function (default parameters) was added to the end of the run.

Fluorescence data was acquired during the 60° C. anneal/extension plateau. Post-run data collection involved the setting of a common threshold across all arrays within an experiment, exportation and collation of the Ct values, visual evaluation of the dissociation curve, and determination of the primer set performance based on a maximum allowable Ct (30.5), classical amplification curve structure, and the presence of a single peak dissociation curve. Primer sets that passed validations were re-arrayed for use in future experiments in the previously described stabilized 384-well format.

Sample Data Collection and Analysis

Each genomic DNA (1.4 ng per 10 ul reaction) was analyzed as described above using real-time PCR. The raw Ct data was collected, collated and analyzed using a modified Global Pattern Recognition (GPR™) application enabling a multi-sample process which includes an Analysis of Variance (ANOVA) module and subsequent standard GPR™-based analysis of all possible pair-wise combinations. Typically, at least one ‘control’ genomic DNA is included in the data set which is derived from a commercially available, anonymous, unaffected, and unrelated donor. GPR™ results are presented showing both the p-value based on the one-way ANOVA and the pair-wise GPR™ ranked output.

The specification is most thoroughly understood in light of the teachings of the references cited within the specification. The embodiments within the specification provide an illustration of embodiments of the invention and should not be construed to limit the scope of the invention. The skilled artisan readily recognizes that many other embodiments are encompassed by the invention. All publications and patents and NCBI Entrez gene ID sequences cited in this disclosure are incorporated by reference in their entirety. To the extent the material incorporated by reference contradicts or is inconsistent with this specification, the specification will supersede any such material. The citation of any references herein is not an admission that such references are prior art to the present invention.

Those skilled in the art will recognize, or be able to ascertain using no more than routine experimentation, many equivalents to the specific embodiments of the invention described herein. Such equivalents are intended to be encompassed by the following embodiments.

1. A method of generating an exon copy number variation (ECNV) profile of a subject that is informative of colorectal cancer risk, comprising:
(a) providing a genomic DNA sample obtained from said subject;
(b) determining the copy number variations of a set of marker exons in the genomic DNA sample by comparing the copy number of each of the marker exons in said genomic DNA sample with the copy number of the corresponding exon in a control, wherein the set of marker exons comprise at least one exon from each of the marker genes listed in Table 1; and
(c) creating an ECNV profile based on the copy number variations of the set of marker exons;
wherein said ECNV profile is informative of the onset, progression, severity, or treatment outcome of colorectal cancer in said subject.

2. A method of determining colorectal cancer risk in a subject, comprising:
(i) creating an ECNV profile of said subject using the method of claim 1;
(ii) determining the degree of similarity between the ECNV profile of (i) and one or more reference profiles, wherein each reference profile is an ECNV profile comprising ECNV information of one or more exons of said marker genes, and wherein each reference profile correlates with the presence or the absence of colorectal cancer, a particular classification of colorectal cancer, or a treatment outcome of colorectal cancer;
wherein said degree of similarity is indicative of the onset, progression, severity, or treatment outcome of colorectal cancer in said subject.

3. The method of claim 2, wherein step (ii) comprises comparing said ECNV profile of (i) to a profile database, wherein said database comprises a plurality of reference profiles.

4. The method of claim 3, further comprising identifying one or more reference profiles from the database that are most similar to said ECNV profile of (i).

5.-7. (canceled)

8. The method of claim 1, wherein the set of marker exons comprise CTNNB1 exon01.1, SCEL exon 01, SLAIN1 exon01, MSH2 ex13.1, SMAD4 ex09, MTOR ex15.1, and MUTYH ex09.1.

9. (canceled)

10. The method of claim 1, wherein the set of marker exons comprise PPP2R1A exon 06.1, PMS2 exon 13.1, PPP2R1A exon 04.1, CTNNB1 exon 13.1, MSH6 exon 08.1, MTOR exon 10.1, PPP2R1A exon 07.2, PMS2 exon 14.2, MLH1 exon 08.1, DCC exon 09.1, MLH1 exon 01.2, IRG1 exon 05, KRAS exon 04.2, MUTYH exon 03.2, STK11 exon 02, APC exon 04.2, MSH2 exon 12.2, PPP2R1A exon 05.2, APC exon 10.2, MTOR exon 48.2, MTOR exon 50.1, MLH1 exon 15.1, PMS2 exon 04.1, PMS2 exon 06.2, and MTOR exon 06.2.

11. (canceled)

12. The method of claim 1, wherein the set of marker exons comprise: CTNNB1 exon 01.1, SCEL exon 01, SLAIN1 exon 01, MSH2 exon 13.1, MUTYHexon 10.2, SMAD4 exon 09, MTOR exon 15.1, MUTYH exon 09.1, PPP2R1A exon 06.1, PMS2 exon 13.1, PPP2R1A exon 04.1, CTNNB1 exon 13.1, MSH6 exon 08.1, MTOR exon 10.1, PPP2R1A exon 07.2, PMS2 exon 14.2, MLH1 exon 08.1, DCC exon 09.1, MLH1 exon 01.2, IRG1 exon 05, KRAS exon 04.2, MUTYH exon 03.2, STK11 exon 02, APC exon 04.2, MSH2 exon 12.2, PPP2R1A exon 05.2, APC exon 10.2, MTOR exon 48.2, MTOR exon 50.1, MLH1 exon 15.1, PMS2 exon 04.1, PMS2 exon 06.2, MTOR exon 06.2., PPP2R1A exon 08.2, PIK3CA exon 04, SMAD4 exon 10, FBXL3 exon 02, BMPR1A exon 04, PMS2 exon 15.2, MTOR exon 03.1, TP53 exon 04.2, SMAD4 exon 02, and MYCBP2 exon 84.

13. The method of claim 1, wherein the set of marker exons comprise the exons listed in Table 2.

14.-17. (canceled)

18. A kit for generating an ECNV profile of a subject that is informative of colorectal cancer risk, comprising:
(a) a set of polynucleotide primers for detecting the copy numbers of a set of marker exons in the genomic DNA of said subject, wherein said set of marker exons comprise at least one exon from each of the genes listed in Table 1, and wherein for each marker exon, at least one primer selectively hybridizes to said exon;
(b) instructions for creating an ECNV profile of the genomic DNA of said subject according to method of claim 1.

19.-20. (canceled)

21. A method of generating an ECNV profile of a subject that is informative of disease risk, comprising:
(a) providing a genomic DNA sample obtained from said subject, wherein said genomic DNA is the genomic DNA from a normal cell or normal tissue;
(b) determining the copy number variations of a set of marker exons by comparing the copy number of each of the marker exons in said genomic DNA sample with the copy number of the corresponding exon in a control, wherein the set of marker exons comprise at least one exon from each gene of a set of marker genes, and wherein said set of marker genes comprise one or more genes that have been associated with said disease;
(c) creating an ECNV profile based on the copy number variations of marker exons;
wherein said ECNV profile is informative of the onset, progression, severity, or treatment outcome of said disease in said subject.

22. A method of determining disease risk in a subject, comprising:
(i) creating an ECNV profile of said subject using the method of claim 21;
(ii) determining the degree of similarity between the ECNV profile of (i) and one or more reference profiles, wherein each reference profile is an ECNV profile comprising ECNV information of one or more exons of said marker genes, and wherein each reference profile correlates with the presence or the absence of said disease, or with the onset, progression, severity, or treatment outcome of said disease;
wherein said degree of similarity is indicative of the onset, progression, severity, or treatment outcome of said disease in said subject.

23.-27. (canceled)

28. A method of generating an ECNV profile of a subject that is informative of autoimmune disease risk, comprising:
(a) providing a genomic DNA sample obtained from said subject;
(b) determining the copy number variations of a set of marker exons by comparing the copy number of each of the marker exons in said genomic DNA sample with the copy number of the corresponding exon in a control, wherein the set of marker exons comprise at least one exon from each of the following marker genes: Mid1, Mid2, and PPP2R1A;
(c) creating an ECNV profile based on the copy number variations of marker exons;
wherein said ECNV profile is informative of the onset, progression, severity, or treatment outcome of said autoimmune disease in said subject.

29. A method of determining autoimmune disease risk in a subject, comprising:
(i) creating an ECNV profile of said subject using the method of claim 28;
(ii) determining the degree of similarity between the ECNV profile of (i) and one or more reference profiles, wherein each reference profile is an ECNV profile comprising ECNV information of one or more exons of said marker genes, and wherein each reference profile correlates with the presence or the absence of said autoimmune disease, or with the onset, progression, severity, or treatment outcome of said autoimmune disease;
wherein said degree of similarity is indicative of the onset, progression, severity, or treatment outcome of said autoimmune disease in said subject.

30.-39. (canceled)

40. A kit for generating an ECNV profile of a subject that is informative of an autoimmune disease risk, comprising:
(a) a set of polynucleotide primers for detecting the copy numbers of a set of marker exons in the genomic DNA of said subject, wherein said set of marker exons comprise at least one exon from each of the following marker genes: Mid1, Mid2, and PPP2R1A, and wherein for each marker exon, at least one primer selectively hybridizes to said exon;
(b) instructions for creating an ECNV profile of the genomic DNA of said subject according to method of claim 28.

41. The kit of claim 40, wherein said set of marker exons comprise the exons listed in Table 3.

42. A method of generating an ECNV profile of a subject that is informative of autoimmune disease risk, comprising:
(a) providing a genomic DNA sample obtained from said subject;
(b) determining the copy number variations of a set of marker exons by comparing the copy number of each of the marker exons in said genomic DNA sample with the copy number of the corresponding exon in a control, wherein the set of marker exons comprise at least one exon from each of the following marker genes: ATG16L1, CYLD, IL23R, NOD2, and SNX20;
(c) creating an ECNV profile based on the copy number variations of marker exons;
wherein said ECNV profile is informative of the onset, progression, severity, or treatment outcome of said autoimmune disease in said subject.

43. A method of determining autoimmune disease risk in a subject, comprising:
(i) creating an ECNV profile of said subject using the method of claim 42;
(ii) determining the degree of similarity between the ECNV profile of (c) and one or more reference profiles, wherein each reference profile is an ECNV profile comprising ECNV information of one or more exons of said marker gene, and wherein each reference profile correlates with the presence or the absence of said autoimmune disease, or with the onset, progression, severity, or treatment outcome of said autoimmune disease;
wherein said degree of similarity is indicative of the onset, progression, severity, or treatment outcome of said autoimmune disease in said subject.

44.-54. (canceled)

55. A kit for generating an ECNV profile of a subject that is informative of an autoimmune disease risk, comprising:
(a) a set of polynucleotide primers for detecting the copy numbers of a set of marker exons in the genomic DNA of said subject, wherein said set of marker exons comprise at least one exon from each of the following marker genes: ATG16L1, CYLD, IL23R, NOD2, and SNX20, and wherein for each marker exon, at least one primer selectively hybridizes to said exon;
(b) instructions for creating an ECNV profile of the genomic DNA of said subject according to method of claim 42.

56. The kit of claim 55, wherein said set of marker exons comprise the exons listed in Table 4.

57. A method of generating an ECNV profile of a subject that is informative of neurological disease risk, comprising:
(a) providing a genomic DNA sample obtained from said subject;
(b) determining the copy number variations of a set of marker exons by comparing the copy number of each of the marker exons in said genomic DNA sample with the copy number of the corresponding exon in a control, wherein the set of marker exons comprise at least one exon from each of the following marker genes: APOE, APP, PSEN1, PSEN2, and PSENEN;
(c) creating an ECNV profile based on the copy number variations of marker exons;
wherein said ECNV profile is informative of the onset, progression, severity, or treatment outcome of said neurological disease in said subject.

58. A method of determining neurological disease risk in a subject, comprising:
(i) creating an ECNV profile of said subject using the method of claim 57;
(ii) determining the degree of similarity between the ECNV profile of (c) and one or more reference profiles, wherein each reference profile is an ECNV profile comprising ECNV information of one or more exons of said marker genes, and wherein each reference profile correlates with the presence or the absence of said neurological disease, or with the onset, progression, severity, or treatment outcome of said neurological disease;
wherein said degree of similarity is indicative of the onset, progression, severity, or treatment outcome of said neurological disease in said subject.

59.-68. (canceled)

69. A kit for generating an ECNV profile of a subject that is informative of an neurological disease risk, comprising:
(a) a set of polynucleotide primers for detecting the copy numbers of a set of marker exons in the genomic DNA of said subject, wherein said set of marker exons comprise at least one exon from each of the following marker genes: APOE, APP, PSEN1, PSEN2, and PSENEN, and wherein for each marker exon, at least one primer selectively hybridizes to said exon;
(b) instructions for creating an ECNV profile of the genomic DNA of said subject according to method of claim 57.

70. The kit of claim 69, wherein said set of marker exons comprise the exons listed in Table 5.
